(19) United States
(12) Patent Application Publication
(10) Pub. No.: US 2003/0232295 A1
(43) Pub. Date: Dec. 18, 2003

(54) Heat developing photosensitive material

(75) Inventors: Kouta Fukui, Kanagawa (JP); Yasuhiro Yoshioka, Kanagawa (JP); Eiichi Okutsu, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/212,039

(22) Filed: Aug. 6, 2002

(30) Foreign Application Priority Data
Aug. 6, 2001 (JP) 2001-237598

(51) Int. Cl. G03C 1/498

(52) U.S. Cl. 430/620; 430/350

(57) ABSTRACT

The present invention relates to a heat developing photosensitive material comprising, on one side of a support, a photosensitive silver halide, a non-photosensitive organic silver salt, a reducing agent for a silver ion, and a binder; and further comprising an aromatic carboxylic acid compound represented by a general formula (2), which is on the same side as the photosensitive silver halide, and a development promoter; which reducing agent includes a compound represented by a general formula (1) below.

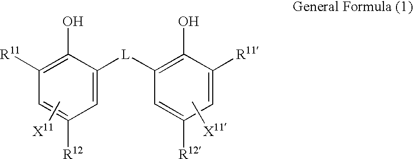

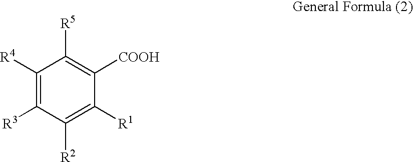

### BACKGROUND OF THE INVENTION

1. Field of the Invention

The present invention relates to a photosensitive heat developing photosensitive material (also referred to hereinafter as “heat developing photosensitive material”) and in particular to a heat developing photosensitive material capable of being rapidly developed, having high image density and sensitivity, having a high thermal development activity and having little fogging in a non-image region.

2. Description of the Related Art

In recent years, a reduction in waste liquid is strongly desired from the viewpoint of environmental protection and space reduction in the fields of film for medical diagnosis and film for photographic plate-making. Hence, there is a need for techniques for a heat developing photosensitive material as film for medical diagnosis and as film for photographic plate-making, which can be effectively exposed to light by a laser image setter or a laser imager and can form vivid black images having high resolution and sharpness. These heat developing photosensitive materials do not require treatment chemicals of a solution system and can provide the customer with a simpler thermal development treatment system, which does not deteriorate the environment.

In the field of general image forming materials, there is also the same need, but particularly images for medical diagnosis necessitate high image qualities having excellent sharpness and graininess, because of the need for fine delineation and blackness is preferable from the viewpoint of easier diagnosis. At present, various hard copy systems utilizing pigments and dyes, such as in ink jet printers and electrophotographic systems, are distributed as the general image forming system, but are unsatisfactory as a system for outputting images for medical purposes.

Thermal image forming systems utilizing an organic silver salt are described in e.g. U.S. Pat. Nos. 3,152,904 and 3,457,075 and in Klosterboer, “Thermally Processed Silver Systems” (Imaging Processes and Materials), edited by J. Sturge, V. Walworth, and A. Shepp, Neblette 8th edition, chap. 9, p.279, 1989.

In particular, the heat developing photosensitive material generally contains a photosensitive layer into a binder matrix of which a catalytically active amount of a photocatalyst (for example, silver halide), a reducing agent, a reducible silver salt (for example, an organic silver salt), and if necessary a coloring agent for regulating a silver hue according to necessity have been dispersed.

The heat developing photosensitive material is exposed to light for an image and then heated at a high temperature (for example 80° C. or more) to form a black silver image by the oxidoreduction reaction between the reducible silver salt (functioning as an oxidant) and the reducing agent. The oxidoreduction reaction is promoted by the catalytic action of a latent image of silver halide generated by exposure to light. Accordingly, the black silver image is formed on the region exposed to light. This is disclosed in many references including U.S. Pat. No. 2,910,377 and Japanese Patent Application Publication (JP-B) No. 43-4924.

In the heat developing photosensitive material, the oxidoreduction reaction between the reducible silver salt and the reducing agent proceeds preferably at a practical reaction temperature for a practical reaction time, to achieve sufficient image density, and under the present circumstances, there is demand for further development of a rapidly reacting, heat developing photosensitive material having higher sensitivity and development activity with less fogging.

Because fixation of the organic silver salt, etc. is not conducted, the heat developing photosensitive material using an organic silver salt can develop an additional silver image by light/heat even after the silver image is formed by heat. Of course, this does not occur under usual conditions of use, but when the heat developing photosensitive material is stored under very severe conditions, for example when the treated film is placed in a car in summer time for the purpose of transportation, fogging, that is, discoloration of the whole film or transfer of letters from the film-storing bag to the film, may occur.

### SUMMARY OF THE INVENTION

Accordingly, the object of the present invention is to solve the problems in the prior art to achieve the object described below. That is, the object of the invention is to provide a heat developing photosensitive material capable of being rapidly developed, having high image density and sensitivity, having a high thermal development activity and having little fogging in a non-image region.

The object described above is achieved by the following means.

A first aspect of the invention provides a heat developing photosensitive material comprising, on one side of a support, a photosensitive silver halide, a non-photosensitive organic silver salt, a reducing agent for a silver ion, and a binder; and further comprising an aromatic carboxylic acid compound represented by a general formula (2), which is on the same side as the photosensitive silver halide, and a development promoter; which reducing agent includes a compound represented by a general formula (1) below

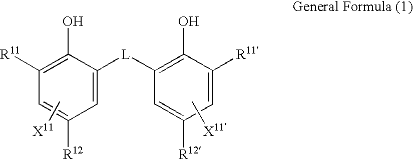

wherein each of R¹¹ and R^{11′} independently represents an alkyl group, each of R¹² and R^{12′} independently represents any one of a hydrogen atom and a group can substitute a benzene ring, each of X¹¹ and X^{11′} independently represents any one of a hydrogen atom and a group which can substitute the benzene ring, and at least one of R¹¹ and X¹¹, R^{11′} and X^{11′}, R¹² and X¹¹, and R^{12′} and X^{11′} may be bound to each other to form a ring, L represents a —S— group or —CHR¹³— group, and R¹³ represents any one of a hydrogen atom and an alkyl group,

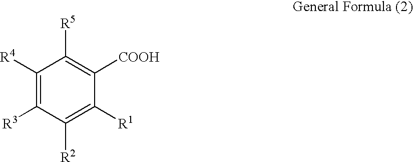

wherein each of R¹, R², R³, R⁴ and R⁵ independently represents any one of a hydrogen atom and a group can substitute a benzene ring, and at least one of R¹, R², R³, R⁴ and R⁵ represents a non-dissociable substituent group bound to the benzene ring via one of a carbon atom, a nitrogen atom, an oxygen atom, a sulfur atom and a phosphorus atom.

A second aspect of the invention provides the heat developing photosensitive material, according to the first aspect, wherein an amount of the compound, which is the reducing agent represented by the general formula (1), is in a range of from 0.01 to 5.0 g/m².

A third aspect of the invention provides the heat developing photosensitive material, according to the first aspect, wherein an amount of the aromatic carboxylic acid compound, which is represented by the general formula (2), is in a range of from 0.1 to 100 mol % relative to the reducing agent.

A fourth aspect of the invention provides the heat developing photosensitive material, according to the first aspect, wherein the development promoter comprises at least one selected from a phenol derivative and a hydrazine derivative.

A fifth aspect of the invention provides the heat developing photosensitive material, according to the fourth aspect, wherein the hydrazine derivative is a compound represented by a general formula (3):

Q¹—NHNH—R¹ General Formula (3)

wherein Q¹ represents a 5- to 7-membered unsaturated ring bound to NHNH—R¹, and R¹ represents any one of a carbamoyl group, an acyl group, an alkoxy carbonyl group, an aryloxy carbonyl group, a sulfonyl group and a sulfamoyl group.

A sixth aspect of the invention provides the heat developing photosensitive material, according to the fourth aspect, wherein the phenol derivative is a compound represented by at least one of a general formula (P) and a general formula (Q):

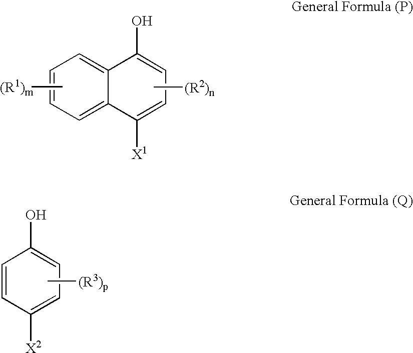

wherein each of X¹ and X² independently represents any one of a hydrogen atom and a substituent group, each of R¹ to R³ independently represents any one of a hydrogen atom and a substituent group, each of m and p independently represents an integer of from 0 to 4, and n represents an integer of from 0 to 2.

A seventh aspect of the invention provides a heat developing photosensitive material, according to the sixth aspect, wherein the compound represented by general formula (P) or (Q) is at least one of the compounds represented by general formulae (4) to (6):

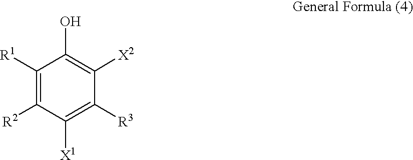

wherein each of R¹, R², R³, X¹ and X² independently represents any one of a hydrogen atom; a halogen atom; and a substituent group bound to the benzene ring via at least one of a carbon atom, an oxygen atom, a nitrogen atom, a sulfur atom and a phosphorus atom, provided that at least one of X¹ and X² is a group represented by —NR⁴R⁵; each of R⁴ and R⁵ independently represents any one of a hydrogen atom, an alkyl group, an alkenyl group, an alkynyl group, an aryl group, a heterocyclic group and —C(═O)—R, —C(═O)—C(═O)—R, —SO₂—R, —SO—R, —P(═O)(R)₂, and —C(═NR′)—R; each of R and R′ is a group independently selected from a hydrogen atom, an alkyl group, an aryl group, a heterocyclic group, an amino group, an alkoxy group and an aryloxy group, and these substituent groups may bound to their adjacent group to form a ring,

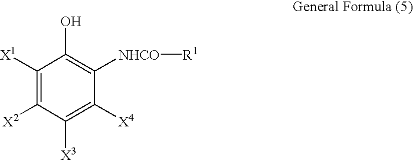

wherein X¹ represents a substituent group, each of X² to X⁴ independently represents any one of a hydrogen atom and a substituent group, provided that each of X¹ to X⁴ is not a hydroxyl group, and X³ is not a sulfonamide group; substituent groups represented by X¹ to X⁴ may be bound to each other to form a ring; and R¹ represents any one of a hydrogen atom, an alkyl group, an aryl group, a heterocyclic group, an amino group and an alkoxy group,

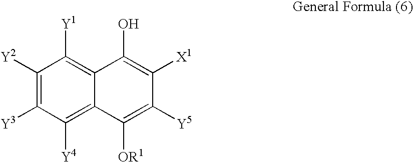

wherein R¹ represents any one of an alkyl group, an aryl group, an alkenyl group and an alkynyl group, X¹ represents an acyl group, an alkoxy carbonyl group, a carbamoyl group, a sulfonyl group and a sulfamoyl group, and each of Y¹ to Y⁵ independently represents any one of a hydrogen atom and a substituent group.

An eighth aspect of the invention provides a heat developing photosensitive material, according to the first aspect, wherein an amount of the development accelerator is from 0.2 to 200 mmol per mol of silver.

A ninth aspect of the invention provides a heat developing photosensitive material, according to the first aspect, wherein the non-photosensitive organic silver salt comprises at least one selected from the group consisting of silver behenate, silver stearate, silver oleate, silver laurate, silver caproate, silver myristate, silver palmitate, silver maleate, silver fumarate, silver tartrate, silver linoleate, silver butyrate and camphoric acid tablets.

A tenth aspect of the invention provides a heat developing photosensitive material, according to the first aspect, wherein the non-photosensitive organic silver salt comprises at least 40 mol % of silver behenate.

An eleventh aspect of the invention provides a heat developing photosensitive material, according to the first aspect, wherein an amount of the non-photosensitive organic silver salt applied is from 0.1 to 5 g/m².

A twelfth aspect of the invention provides a heat developing photosensitive material, according to the first aspect, wherein the photosensitive silver halide is any one of cubic fine particles and plate particles.

A thirteenth aspect of the invention provides a heat developing photosensitive material, according to the first aspect, wherein a particle size of the photosensitive silver halide is from 0.0001 to 0.15 μm.

A fourteenth aspect of the invention provides a heat developing photosensitive material, according to the first aspect, wherein the photosensitive silver halide comprises at least one selected from the group consisting of silver chloride, silver chlobromide, silver bromide, silver iodobromide, silver iodochlobromide, and silver iodide.

A fifteenth aspect of the invention provides a heat developing photosensitive material, according to the first aspect, wherein the photosensitive silver halide comprises from 0.1 to 40 mol % silver iodide.

A sixteenth aspect of the invention provides a heat developing photosensitive material, according to the first aspect, wherein an amount of the photosensitive silver halide added is from 0.01 to 0.5 mol per mol of the non-photosensitive organic silver salt.

A seventeenth aspect of the invention provides a heat developing photosensitive material, according to the first aspect, wherein the binder comprises from 50 to 100% by weight polyvinyl butyral relative to all of the components of the binder.

An eighteenth aspect of the invention provides a heat developing photosensitive material, according to the first aspect, wherein a Tg of the binder is from 40 to 90° C.

A nineteenth aspect of the invention provides a heat developing photosensitive material, according to the first aspect, further comprising a hydrogen-bonding compound, wherein the hydrogen-bonding compound is a compound represented by a general formula (7):

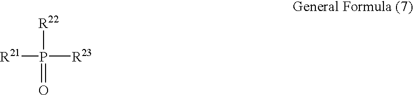

wherein each of R²¹, R²² and R²³ independently represents any one of an alkyl group, an aryl group, an alkoxy group, an aryloxy group, an amino group and a heterocyclic group, and these groups may be substituted or may not, and a desired pair of R²¹, R²² and R²³ may form a ring.

A twentieth aspect of the invention relates to the heat developing photosensitive material according to the seventeenth aspect, wherein an amount of the hydrogen-bonding compound is from 1 to 200 mol % relative to the reducing agent.

### DESCRIPTION OF THE PREFERRED EMBODIMENTS

Hereinafter, the heat developing photosensitive material of the present invention will be described in detail.

The heat developing photosensitive material of the invention comprising, on one side of a support, a photosensitive silver halide, a non-photosensitive organic silver salt, a reducing agent for a silver ion, and a binder; and further comprising an aromatic carboxylic acid compound represented by a general formula (2), which is on the same side as the photosensitive silver halide, and a development promoter; which reducing agent includes a compound represented by a general formula (1) below. The heat developing photosensitive material having these characteristics is to be rapidly developed with high image density and sensitivity, with a high thermal development activity, and with little fogging in a non-image region.

Now, the compounds represented by the general formula (1) are described.

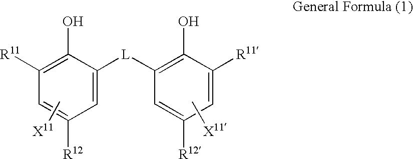

In the general formula (1), each of R¹¹ and R^{11′} independently represents an alkyl group. Specifically, the alkyl group is a substituted or unsubstituted linear, branched or cyclic alkyl group, and preferably a C₁₋₂₀ alkyl group (“C₁₋₂₀” indicates “a number of carbon atoms is from 1 to 20”). Substituent groups on the alkyl group are not particularly limited, and preferable examples thereof include an aryl group, hydroxy group, alkoxy group, aryloxy group, alkyl thio group, aryl thio group, acyl amino group, sulfonamide group, sulfonyl group, phosphoryl group, acyl group, carbamoyl group, ester group and halogen atom.

Each of R¹¹ and R^{11′} is more preferably a C₃₋₁₅ secondary or tertiary alkyl group such as an isopropyl group, isobutyl group, t-butyl group, t-amyl group, t-octyl group, cyclohexyl group, cyclopentyl group, 1-methyl cyclohexyl group and 1-methyl cyclopropyl group. Further preferable examples include C₄₋₁₂ tertiary alkyl groups, among which a t-butyl group, t-amyl group and 1-methyl cyclohexyl group are particularly preferable, and a t-butyl group is most preferable.

In the general formula (1), each of R¹² and R^{12′} independently represents a hydrogen atom or a group with which the benzene ring can be substituted. X¹¹ and X^{11′} independently represent a hydrogen atom or a group with which the benzene ring can be substituted. Preferable examples of the group with which the benzene ring can be substituted include an alkyl group, aryl group, halogen atom, alkoxy group and acyl amino group.

Each of R¹² and R^{12′} is preferably a C₁₋₂₀ alkyl group such as a methyl group, ethyl group, propyl group, butyl group, isopropyl group, t-butyl group, t-amyl group, cyclohexyl group, 1-methyl cyclohexyl group, benzyl group, methoxy methyl group and methoxy ethyl group. Each of R¹² and R^{12′} is more preferably a methyl group, ethyl group, propyl group, isopropyl group or t-butyl group.

Each of X¹¹ and X^{11′} is preferably a hydrogen atom, halogen atom or alkyl group, and particularly preferably a hydrogen atom.

In the general formula (1), R¹¹ and X¹¹, R^{11′} and X^{11′}, R¹² and X¹¹, or R^{12′} and X^{11′} may be bound to each other to form a ring. This ring is preferably a 5- to 7-membered ring, and more preferably a saturated 6-membered ring.

In the general formula (1), L represents a —S— group or —CHR¹³— group in which R¹³ represents a hydrogen atom or alkyl group. R¹³ is specifically a substituted or unsubstituted linear, branched or cyclic alkyl group, preferably a C₁₋₂₀ alkyl group. Examples of the unsubstituted alkyl group represented by R¹³ include a methyl group, ethyl group, propyl group, butyl group, heptyl group, undecyl group, isopropyl group, 1-ethyl pentyl group and 2,4,4-trimethyl pentyl group. Substituent groups on the substituted alkyl group represented by R¹³ include those exemplified as the substituent groups on the alkyl groups represented by R¹¹ and R^{11′}.

In the general formula (1), L is preferably a —CHR¹³— group.

Here, R¹³ is preferably a hydrogen atom or a C₁₋₁₅ alkyl group. The alkyl group is preferably a C₁₋₈ primary or secondary alkyl group, more preferably a methyl group, ethyl group, n-propyl group, isopropyl group or 2,4,4-trimethyl pentyl group, still more preferably a methyl group, ethyl group, n-propyl group or isopropyl group, and most preferably a methyl group, ethyl group or n-propyl group.

When R¹³ is a hydrogen atom, each of R¹² and R^{12′} is preferably an alkyl group containing 2 or more carbon atoms, more preferably an alkyl group containing 2 to 5 carbon atoms, further more preferably an ethyl group or propyl group, and most preferably an ethyl group.

When R¹³ is an alkyl group, each of R¹² and R^{12′} is preferably an alkyl group, and particularly preferably a methyl group.

When all R¹¹, R^{11′}, R¹² and R^{12′} in the general formula (1) are methyl groups, R¹³ is preferably a secondary alkyl group, more preferably an isopropyl group, sec-butyl group, 1-ethyl pentyl group, and particularly preferably an isopropyl group.

Examples of the compounds represented by the general formula (1) are shown below, but these examples are not intended to limit the compounds which can be used in the invention.

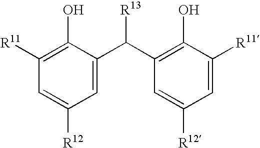

| | R¹¹ | R^{11′} | R¹² | R^{12′} | R¹³ |
|---|---|---|---|---|---|
| 1-1 | CH₃ | CH₃ | CH₃ | CH₃ | H |
| 1-2 | CH₃ | CH₃ | CH₃ | CH₃ | CH₃ |
| 1-3 | CH₃ | CH₃ | CH₃ | CH₃ | C₃H₇ |
| 1-4 | CH₃ | CH₃ | CH₃ | CH₃ | i-C₃H₇ |
| 1-5 | CH₃ | CH₃ | CH₃ | CH₃ | CH(C₂H₅)C₄H₉ |
| 1-6 | CH₃ | CH₃ | CH₃ | CH₃ | CH₂CH(CH₃)CH₂C(CH₃)₃ |
| 1-7 | CH₃ | CH₃ | C₂H₅ | C₂H₅ | H |
| 1-8 | CH₃ | CH₃ | C₂H₅ | C₂H₅ | i-C₃H₇ |
| 1-9 | C₂H₅ | C₂H₅ | CH₃ | CH₃ | H |
| 1-10 | C₂H₅ | C₂H₅ | CH₃ | CH₃ | i-C₃H₇ |
| 1-11 | t-C₄H₉ | t-C₄H₉ | CH₃ | CH₃ | H |
| 1-12 | t-C₄H₉ | t-C₄H₉ | CH₃ | CH₃ | CH₃ |
| 1-13 | t-C₄H₉ | t-C₄H₉ | CH₃ | CH₃ | C₂H₅ |
| 1-14 | t-C₄H₉ | t-C₄H₉ | CH₃ | CH₃ | n-C₃H₇ |
| 1-15 | t-C₄H₉ | t-C₄H₉ | CH₃ | CH₃ | n-C₄H₉ |
| 1-16 | t-C₄H₉ | t-C₄H₉ | CH₃ | CH₃ | n-C₇H₁₅ |
| 1-17 | t-C₄H₉ | t-C₄H₉ | CH₃ | CH₃ | n-C₁₁H₂₃ |
| 1-18 | t-C₄H₉ | t-C₄H₉ | CH₃ | CH₃ | i-C₃H₇ |
| 1-19 | t-C₄H₉ | t-C₄H₉ | CH₃ | CH₃ | CH(C₂H₅)C₄H₉ |
| 1-20 | t-C₄H₉ | t-C₄H₉ | CH₃ | CH₃ | CH₂CH(CH₃)₂ |
| 1-21 | t-C₄H₉ | t-C₄H₉ | CH₃ | CH₃ | CH₂CH(CH₃)CH₂C(CH₃)₃ |
| 1-22 | t-C₄H₉ | t-C₄H₉ | CH₃ | CH₃ | CH₂OCH₃ |
| 1-23 | t-C₄H₉ | t-C₄H₉ | CH₃ | CH₃ | (CH₂)₂OCH₃ |
| 1-24 | t-C₄H₉ | t-C₄H₉ | CH₃ | CH₃ | (CH₂)₂OC₄H₉ |
| 1-25 | t-C₄H₉ | t-C₄H₉ | CH₃ | CH₃ | (CH₂)₂SC₁₂H₂₅ |
| 1-26 | t-C₄H₉ | t-C₄H₉ | C₂H₅ | C₂H₅ | H |
| 1-27 | t-C₄H₉ | t-C₄H₉ | C₂H₅ | C₂H₅ | CH₃ |
| 1-28 | t-C₄H₉ | t-C₄H₉ | C₂H₅ | C₂H₅ | n-C₃H₇ |
| 1-29 | t-C₄H₉ | t-C₄H₉ | C₂H₅ | C₂H₅ | i-C₃H₇ |
| 1-30 | t-C₄H₉ | t-C₄H₉ | C₂H₅ | C₂H₅ | (CH₂)₂OCH₃ |
| 1-31 | t-C₄H₉ | t-C₄H₉ | n-C₃H₇ | n-C₃H₇ | H |
| 1-32 | t-C₄H₉ | t-C₄H₉ | n-C₃H₇ | n-C₃H₇ | CH₃ |
| 1-33 | t-C₄H₉ | t-C₄H₉ | n-C₃H₇ | n-C₃H₇ | n-C₃H₇ |
| 1-34 | t-C₄H₉ | t-C₄H₉ | n-C₄H₉ | n-C₄H₉ | H |
| 1-35 | t-C₄H₉ | t-C₄H₉ | n-C₄H₉ | n-C₄H₉ | CH₃ |
| 1-36 | t-C₅H₁₁ | t-C₅H₁₁ | CH₃ | CH₃ | H |
| 1-37 | t-C₅H₁₁ | t-C₅H₁₁ | CH₃ | CH₃ | CH₃ |
| 1-38 | t-C₅H₁₁ | t-C₅H₁₁ | C₂H₅ | C₂H₅ | H |
| 1-39 | t-C₅H₁₁ | t-C₅H₁₁ | C₂H₅ | C₂H₅ | CH₃ |
| 1-40 | i-C₃H₇ | i-C₃H₇ | CH₃ | CH₃ | H |
| 1-41 | i-C₃H₇ | i-C₃H₇ | CH₃ | CH₃ | n-C₃H₇ |
| 1-42 | i-C₃H₇ | i-C₃H₇ | C₂H₅ | C₂H₅ | H |
| 1-43 | i-C₃H₇ | i-C₃H₇ | C₂H₅ | C₂H₅ | n-C₃H₇ |
| 1-44 | i-C₃H₇ | i-C₃H₇ | i-C₃H₇ | i-C₃H₇ | H |
| 1-45 | i-C₃H₇ | i-C₃H₇ | i-C₃H₇ | i-C₃H₇ | CH₃ |
| 1-46 | t-C₄H₉ | CH₃ | CH₃ | CH₃ | H |
| 1-47 | t-C₄H₉ | CH₃ | CH₃ | CH₃ | CH₃ |
| 1-48 | t-C₄H₉ | CH₃ | CH₃ | CH₃ | n-C₃H₇ |
| 1-49 | t-C₄H₉ | CH₃ | t-C₄H₉ | CH₃ | CH₃ |
| 1-50 | i-C₃H₇ | CH₃ | CH₃ | CH₃ | CH₃ |

| | |
|---|---|
| 1-51 | 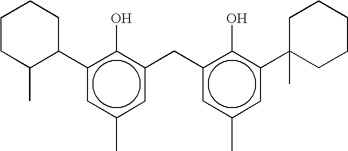 |
| 1-52 | 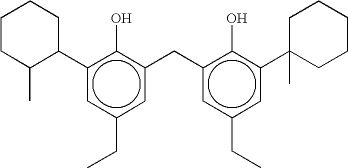 |
| 1-53 | 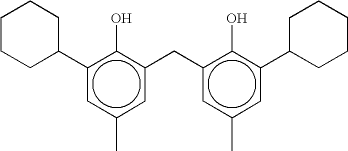 |
| 1-54 | 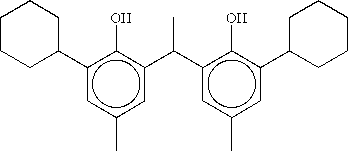 |
| 1-55 | 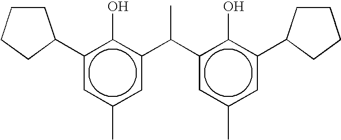 |
| 1-56 | 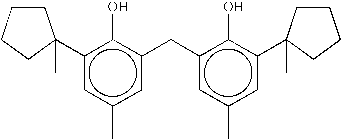 |
| 1-57 | 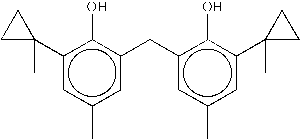 |
| 1-58 | 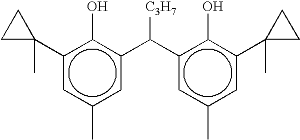 |
| 1-59 | 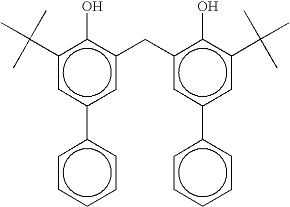 |
| 1-60 | 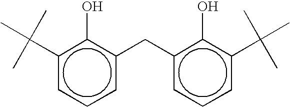 |
| 1-61 | 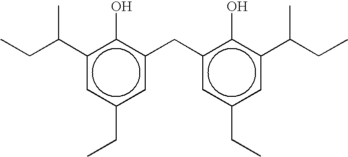 |
| 1-62 | 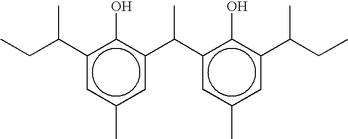 |
| 1-63 | 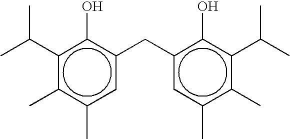 |
| 1-64 | 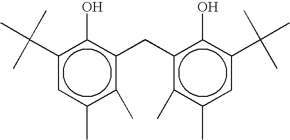 |
| 1-65 | 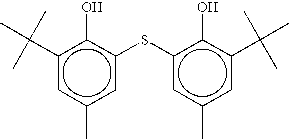 |
| 1-66 | 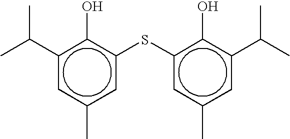 |
| 1-67 | 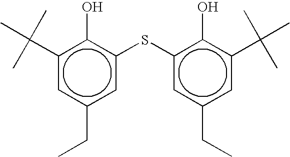 |
| 1-68 | 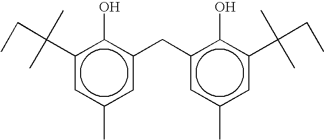 |
| 1-69 | 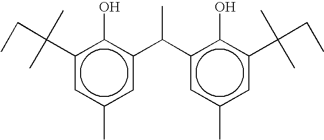 |
| 1-70 | 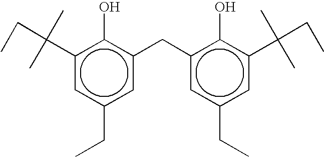 |
| 1-71 | 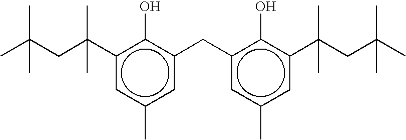 |
| 1-72 | 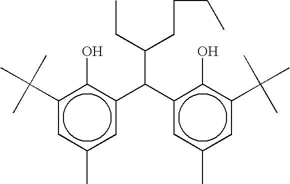 |
| 1-73 | 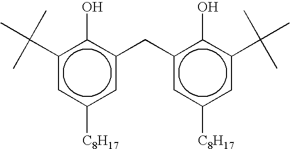 |
| 1-74 | 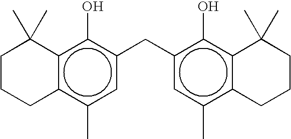 |
| 1-75 | 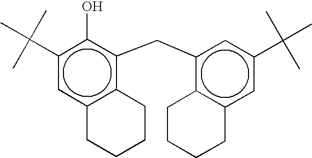 |
| 1-76 | 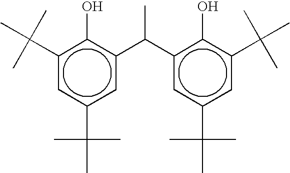 |

The amount of the compound (reducing agent) represented by the general formula (1) is preferably 0.01 to 5.0 g/m², more preferably 0.1 to 3.0 g/m², and the compound is contained in an amount of 5 to 50 mol %, more preferably 10 to 40 mol %, per mol of silver on the face containing photosensitive silver halide. The reducing agent is disposed preferably in the image forming layer.

The compound (reducing agent) represented by the general formula (1) may be contained in the coating solution and the photosensitive material by any method and any form such as a solution, an emulsified dispersion, or a dispersion of solid fine particles.

A well-known emulsification dispersion method includes a method of preparing an emulsified dispersion mechanically by dissolution in oil such as dibutyl phthalate, tricresyl phosphate, glyceryl triacetate or diethyl phthalate or a co-solvent such as ethyl acetate or cyclohexanone.

The method of dispersing solid fine particles includes a method of preparing a dispersion by dispersing powders of the reducing agent in a suitable solvent, such as water, by a ball mill, a colloid mill, a vibration ball mill, a sand mill, a jet mill, a roller mill or sonication. In this process, protective colloids (for example, a polyvinyl alcohol) and a surfactant (for example an anionic surfactant such as a sodium triisopropylnaphthalene sulfonate (a mixture of isomers substituted at different positions with 3 isopropyl groups)) may be used. The aqueous dispersion may contain a preservative (for example a benzaisothiazolinone sodium salt).

Now, the aromatic carboxylic acid compounds represented by the general formula (2) are described.

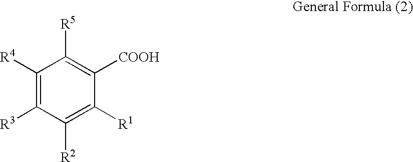

In the general formula (2), each of R¹, R², R³, R⁴ and R⁵ independently represents a hydrogen atom or a group with which the benzene ring can be substituted. At least one of R¹, R², R³, R⁴ and R⁵ represents a non-dissociable substituent group bound to the benzene ring via a carbon atom, a nitrogen atom, an oxygen atom, a sulfur atom or a phosphorus atom.

Examples of the substituent group bound via a carbon atom to the benzene ring include a linear, branched or cyclic alkyl group, an alkenyl group, an alkynyl group, an aryl group, an acyl group, an alkoxy carbonyl group, an aryloxy carbonyl group, a carbamoyl group, a cyano group, a heterocyclic group, a sulfonyl carbamoyl group, an acyl carbamoyl group, a sulfamoyl carbamoyl group, a carbazoyl group, an oxalyl group, an oxamoyl group and a thiocarbamoyl group.

Examples of the substituent group bound via an oxygen atom to the benzene ring include an alkoxy group, an aryloxy group, a heterocyclic oxy group, an acyl oxy group, an (alkoxy or aryloxy) carbonyl oxy group, a carbamoyl oxy group, a sulfonyl oxy group and a phosphonyl oxy group.

Examples of the substituent group bound via a nitrogen atom to the benzene ring include an amino group, a nitro group, a hydrazino group, a heterocyclic group, an acyl amino group, an (alkoxy or aryloxy) carbonyl amino group, a sulfonyl amino group, a sulfamoyl amino group, a semicarbazide group, a thiosemicarbazide group, an oxamoyl amino group, an ureido group, a thioureido group, a sulfonyl ureido group, an acyl ureido group, an acyl sulfamoyl amino group, a phosphoryl group and an imide group.

Examples of the substituent group bound via a sulfur atom to the benzene ring include an alkyl thio group, an aryl thio group, a disulfide group, a sulfonyl group, a sulfinyl group, a sulfamoyl group, an acyl sulfamoyl group and a heterocyclic thio group.

Examples of the substituent group bound via a phosphorus atom to the benzene ring include a phosphonyl group and a phosphinyl group.

In the general formula (2), other groups represented by R¹, R², R³, R⁴ or R⁵, with which the benzene ring can be substituted, include e.g. halogen atoms.

In the general formula (2), the group represented by R¹, R², R³, R⁴ or R⁵ may further be substituted with the substituent groups described above.

The aromatic carboxylic acid compound represented by the general formula (2) is characterized by having only one carboxyl group in the molecule thereof to confer suitable acidity and hydrophilicity. The aromatic carboxylic acid compound is not substituted with a strong dissociable group, except for this carboxyl group, by which the pKa value of the compound is reduced to 6 or less.

In the general formula (2), at least one of a group represented by R¹, R², R³, R⁴ and R⁵ is preferably a group selected from a C₁₋₃₀ alkyl group (for example a methyl group, ethyl group, isopropyl group, butyl group, cyclohexyl group, n-octyl group, 3,5,5-trimethyl hexyl group, n-dodecyl group, etc.), a C₆₋₃₀ aryl group (for example a phenyl group, naphthyl group, tolyl group, xylyl group, 3,5-dichlorophenyl group, etc.), a C₅₋₃₀ heterocyclic group (for example, a pyridyl group, quinolyl group, piperidyl group, pyrimidyl group, etc.), a C₁₋₃₀ alkoxy group (for example, a methoxy group, propoxy group, butoxy group, methoxy ethoxy group, dodecyloxy group, 2-ethylhexyloxy group, etc.), a C₆₋₃₀ aryloxy group (for example, a phenoxy group, 1-naphthoxy group, cresyl group, 3-chlorophenoxy group, 4-tert-octyl phenoxy group, etc.), a C₁₋₃₀ sulfonyloxy group (for example, a methane sulfonyloxy group, butane sulfonyloxy group, benzene sulfonyloxy group, 4-methyl benzene sulfonyloxy group, etc.), a C₂₋₃₀ acyl group (for example, an acetyl group, pivaloyl group, benzoyl group, 4-chlorobenzoyl group, 3,5-dimethyl benzoyl group, etc.), a C₂₋₃₀ acyloxy group (for example, an acetyloxy group, benzoyloxy group, pivaloyloxy group, 3-methyl benzoyloxy group, 4-methoxy benzoyloxy group, 2-chlorobenzoyloxy group, etc.), a C₂₋₃₀ alkoxy carbonyl group (for example, a methoxy carbonyl group, ethoxy carbonyl group, hexyloxy carbonyl group, dodecyloxy carbonyl group, etc.), a C₂₋₃₀ aryloxy carbonyl group (for example, a phenoxy carbonyl group, benzoyloxy carbonyl group, 3,4-dichlorophenyloxy carbonyl group, etc.), a C₁₋₃₀ acyl amino group (for example, an acetyl amino group, benzoyl amino group, N,N-dimethyl carbamoyl amino group, etc.), a C₁₋₃₀ sulfonyl amino group (for example, a methane sulfonyl amino group, benzene sulfonyl amino group, p-toluene sulfonyl amino group, etc.), a C₁₋₃₀ carbamoyl group (dimethyl carbamoyl group, diethyl carbamoyl group, dibutyl carbamoyl group, octyl carbamoyl group, phenyl carbamoyl group, N-methyl phenyl carbamoyl group, etc.), a C₁₋₃₀ sulfamoyl group (for example a dimethyl sulfamoyl group, octyl sulfamoyl group, phenyl sulfamoyl group, etc.) and a C₁₋₃₀ sulfonyl group (methane sulfonyl group, octane sulfonyl group, dodecane sulfonyl group, benzene sulfonyl group, toluene sulfonyl group, xylene sulfonyl group, etc.).

At least one of R¹, R², R³, R⁴ and R⁵ is particularly preferably an alkoxy group, an aryloxy group, an acyloxy group, an alkyl a sulfonyloxy group, an aryl sulfonyloxy group, an acyl group, an alkoxy carbonyl group or an aryloxy carbonyl group, out of the groups described above. It is more preferably an aryl sulfonyloxy group.

The position of the substituent group may be an ortho-, meta- or para-position, is preferably an ortho- or para-position and is more preferably an ortho-position relative to the carboxyl group.

In the general formula (2), other substituent groups represented by R¹, R², R³, R⁴ and R⁵ are preferably a halogen atom and an alkyl group, and particularly preferably a chlorine atom and a methyl group.

Examples of the compounds represented by the general formula (2) are shown below, but these examples are not intended to limit the compounds usable in the invention.

| | |
|---|---|
| 2-1 | 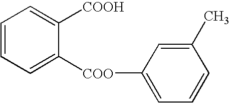 |
| 2-2 | 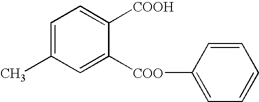 |
| 2-3 | 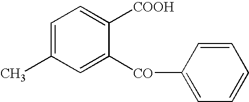 |
| 2-4 | 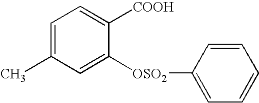 |
| 2-5 | 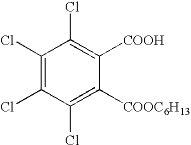 |
| 2-6 | 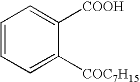 |
| 2-7 | 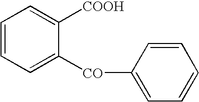 |
| 2-8 | 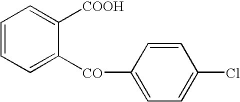 |
| 2-9 | 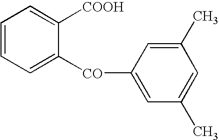 |
| 2-10 | 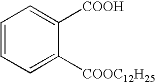 |
| 2-11 | 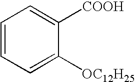 |
| 2-12 | 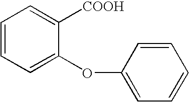 |
| 2-13 | 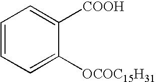 |
| 2-14 | 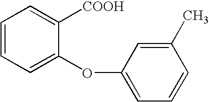 |
| 2-15 | 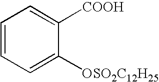 |
| 2-16 | 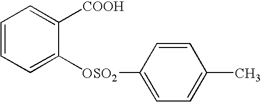 |
| 2-17 | 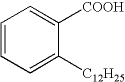 |
| 2-18 | 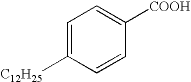 |
| 2-19 | 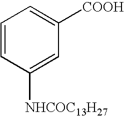 |
| 2-20 | 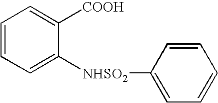 |
| 2-21 | 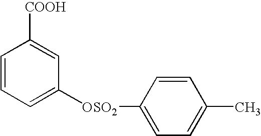 |
| 2-22 | 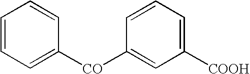 |
| 2-23 | 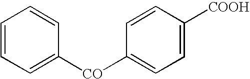 |
| 2-24 | 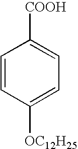 |
| 2-25 | 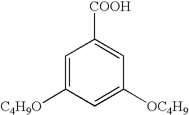 |
| 2-26 | 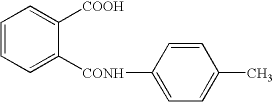 |
| 2-27 | 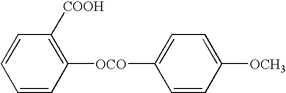 |

The aromatic carboxylic acid compounds represented by the general formula (2) can be easily synthesized by a method known in the art. Further, the compounds represented by the general formula (2) may be added to any layers at the side of the image forming layer on the support, that is, to the image forming layer itself or any layers at this side, preferably to the image forming layer or its adjacent layers.

Like the reducing agent, the aromatic carboxylic acid compounds represented by the general formula (2) may be added in any forms such as a solution, an emulsified dispersion or a dispersion of solids to the heat developing photosensitive material. The compound represented by the general formula (2) is used preferably in the range of 0.1 to 100 mol % relative to the reducing agent. The amount thereof is more preferably in the range of 0.5 to 50 mol %, and still more preferably in the range of 1 to 30 mol %, relative to the reducing agent.

Now, the development accelerator will be described.

The development accelerator used may be any compound promoting development in thermal development. The so-called reducing agent can also be used. Specifically, compounds such as p-aminophenols, p-phenylene diamines, sulfonamide phenols, phenidones, ascorbic acid, hydrazines, phenols and naphthols can be used. In particular, sulfonamide phenols (for example, compounds represented by the general formula (1) in Japanese Patent Application Laid-Open (JP-A) No. 10-221806 and compounds represented by general formula (A) in JP-A No. 2000-267222), hydrazines and naphthols are preferable.

The development accelerator is preferably a compound which when added in a molar ratio of 10% to the major reducing agent, requires 90% or less of light exposure necessary for achieving a darkness of 1.0 in the absence of the development accelerator, more preferably a compound which when added in a molar ratio of 5%, more preferably 2%, to the major reducing agent, requires 90% or less of light exposure necessary for achieving a darkness of 1.0 in the absence of the development accelerator.

The development accelerator is selected particularly preferably from phenol derivatives and hydrazine derivatives. The hydrazine derivatives are selected particularly preferably from the compounds represented by the general formula (3). The phenol derivatives are selected particularly preferably from the compounds represented by the general formula (P) or (Q). The compounds represented by the general formula (P) or (Q) are selected particularly preferably from the compounds represented by the general formulae (4) to (6). Now, these compounds will be described in more detail.

The compound represented by the general formula (3) is described. The compound represented by the general formula (3) is a reducing compound, which is a development accelerator generically named a hydrazine type developing agent.

Q¹—NHNH—R¹ General Formula (3)

In the general formula (3), Q¹ represents a 5- to 7-membered unsaturated ring bound to NHNH—R¹. Preferable examples of the 5- to 7-membered unsaturated ring represented by Q¹ include a benzene ring, pyridine ring, pyrazine ring, pyrimidine ring, pyridazine ring, 1,2,4-triazine ring, 1,3,5-triazine ring, pyrrole ring, imidazole ring, pyrazol ring, 1,2,3-triazole ring, 1,2,4-triazole ring, tetrazole ring, 1,3,4-thiadiazole ring, 1,2,4-thiadiazole ring, 1,2,5-thiadiazole, 1,3,4-oxadiazole ring, 1,2,4-oxadiazole ring, 1,2,5-oxadiazole ring, thiazole ring, oxazole ring, isothiazole ring, isoxazole ring and thiophene ring, and a condensed ring having these rings condensed with one another is also preferable.

These rings may have substituent groups, and when the ring has two or more substituent groups, the substituent groups may be the same or different. Examples of such substituent groups include a halogen atom, alkyl group, aryl group, carbonamide group, alkyl sulfonamide group, aryl sulfonamide group, alkoxy group, aryloxy group, alkyl thio group, aryl thio group, carbamoyl group, sulfamoyl group, cyano group, alkyl sulfonyl group, aryl sulfonyl group, alkoxy carbonyl group, aryloxy carbonyl group, and acyl group. When these substituent groups are substitutable groups, these groups may further have substituent groups, and preferable examples of such substituent groups include a halogen atom, alkyl group, aryl group, carbonamide group, alkyl sulfonamide group, aryl sulfonamide group, alkoxy group, aryloxy group, alkyl thio group, aryl thio group, acyl group, alkoxy carbonyl group, aryloxy carbonyl group, carbamoyl group, cyano group, sulfamoyl group, alkyl sulfonyl group, aryl sulfonyl group and acyloxy group, provided that Q¹ is not a 4-cyano-2,3,5,6-tetrachloro-phenyl group.

In the general formula (3), R¹ represents a carbamoyl group, an acyl group, an alkoxy a carbonyl group, an aryloxy a carbonyl group, a sulfonyl group or a sulfamoyl group.

In the general formula (3), the carbamoyl group represented by R¹ contains preferably 1 to 50 carbon atoms, and more preferably 6 to 40 carbon atoms. Specifically, examples of the carbamoyl group includes an unsaturated carbamoyl group, methyl carbamoyl group, N-ethyl carbamoyl group, N-propyl carbamoyl group, N-sec-butyl carbamoyl group, N-octyl carbamoyl group, N-cyclohexyl carbamoyl group, N-tert-butyl carbamoyl group, N-dodecyl carbamoyl group, N-(3-dodecyloxypropyl) carbamoyl group, N-octadecyl carbamoyl group, N-{3-(2,4-tert-pentylphenoxy)propyl} carbamoyl group, N-(2-hexyldecyl) carbamoyl group, N-phenyl carbamoyl group, N-(4-dodecyloxyphenyl) carbamoyl group, N-(2-chloro-5-dodecyloxy carbonyl phenyl) carbamoyl group, N-naphthyl carbamoyl group, N-3-pyridyl carbamoyl group and N-benzyl carbamoyl group.

The acyl group represented by R¹ in the general formula (3) contains preferably 1 to 50 carbon atoms, and more preferably 6 to 40 carbon atoms. Specific examples include formyl group, acetyl group, 2-methyl propanoyl group, cyclohexyl carbonyl group, octanoyl group, 2-hexyl decanoyl group, dodecanoyl group, chloroacetyl group, trifluoroacetyl group, benzoyl group, 4-dodecyloxy benzoyl group and 2-hydroxymethyl benzoyl group.

The alkoxy carbonyl group represented by R¹ in the general formula (3) contains preferably 2 to 50 carbon atoms, and more preferably 6 to 40 carbon atoms. Specific examples include methoxy carbonyl group, ethoxy carbonyl group, isobutyloxy carbonyl group, cyclohexyloxy carbonyl group, dodecyloxy carbonyl group and benzyloxy carbonyl group.

The aryloxy carbonyl group represented by R¹ in the general formula (3) contains preferably 7 to 50 carbon atoms, and more preferably 7 to 40 carbon atoms. Specifically, mention is made of a phenoxy carbonyl group, 4-octyloxy phenoxy carbonyl group, 2-hydroxy methyl phenoxy carbonyl group and 4-dodecyloxy phenoxy carbonyl group.

The sulfonyl group represented by R¹ in the general formula (3) contains preferably 1 to 50 carbon atoms, and more preferably 6 to 40 carbon atoms. Specific examples include methyl sulfonyl group, butyl sulfonyl group, octyl sulfonyl group, 2-hexadecyl sulfonyl group, 3-dodecyloxy propyl sulfonyl group, 2-octyloxy-5-tert-octyl phenyl sulfonyl group and 4-dodecyloxy phenyl sulfonyl group.

The sulfamoyl group represented by R¹ in the general formula (3) contains preferably 0 to 50 carbon atoms, and more preferably 6 to 40 carbon atoms. Specific examples include unsaturated sulfamoyl group, N-ethyl sulfamoyl group, N-(2-ethylhexyl) sulfamoyl group, N-decyl sulfamoyl group, N-hexadecyl sulfamoyl group, N-{3-(2-ethylhexyloxy) propyl} sulfamoyl group, N-(2-chloro-5-dodecyloxy carbonylphenyl) sulfamoyl group and N-(2-tetradecyloxyphenyl) sulfamoyl group.

The group represented by R¹ may further have, at replaceable positions, groups exemplified above as the substituent groups on the 5- to 7-membered unsaturated ring represented by Q¹, and when two or more substituent groups are present, the substituent groups may be the same or different.

In the general formula (3), Q¹ is preferably a 5- or 6-membered unsaturated ring, and Q¹ is preferably a benzene ring, a pyrimidine ring, a 1,2,3-triazole ring, a 1,2,4-triazole ring, a tetrazole ring, a 1,3,4-thiazole ring, a 1,2,4-thiadiazole ring, a 1,3,4-oxadiazole ring, a 1,2,4-oxadiazole ring, a thiazole ring, an oxazole ring, an isothiazole ring, an isoxazole ring or a ring having these rings condensed with a benzene ring or with a unsaturated heterocyclic ring, and Q¹ is particularly preferably a quinazoline ring. Further, Q¹ preferably has at least one electron attracting substituent group. Preferable examples of the substituent groups include a fluoroalkyl group (for example, a trifluoromethyl group, pentafluoroethyl group, 1,1-difluoroethyl group, difluoromethyl group, fluoromethyl group, heptafluoropropyl group, pentafluorophenyl group), a cyano group, a halogen atom (fluoro, chloro, bromo, iodo), an acyl group, an alkoxy carbonyl group, a carbamoyl group, an alkyl sulfonyl group and an aryl sulfonyl group, among which a trifluoromethyl group is particularly preferable.

In the general formula (3), R¹ is preferably a carbamoyl group, and particularly preferably R¹ is a substituted carbamoyl group represented by —CO—NH—R^{1′} while R^{1′} represents a C₁₋₁₀ alkyl group or an aryl group.

Examples of the compounds (reducing compounds) represented by the general formula (3) are shown below, but these examples are not intended to limit the compounds used in the invention.

| | |
|---|---|
| 3-1 | 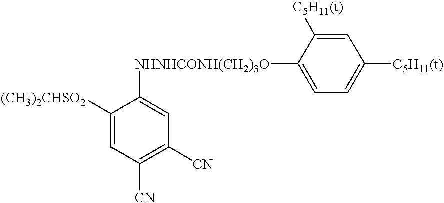 |
| 3-2 | 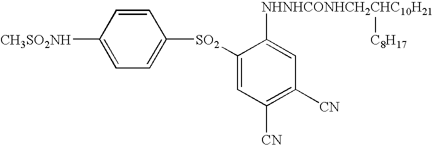 |
| 3-3 | 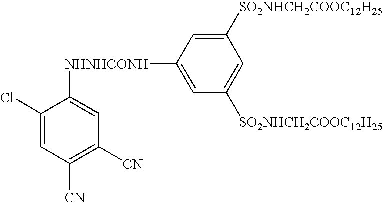 |
| 3-4 | 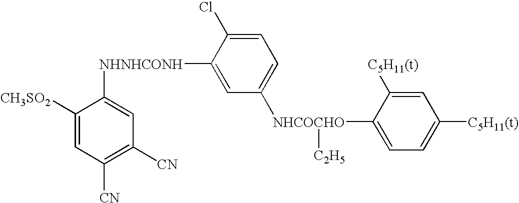 |
| 3-5 | 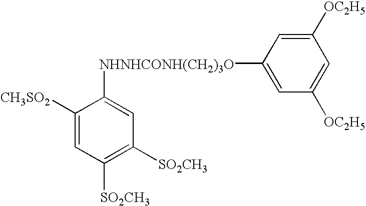 |
| 3-6 | 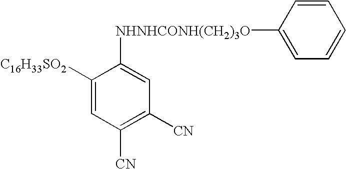 |
| 3-7 | 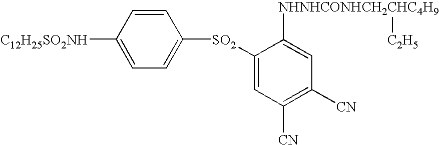 |
| 3-8 | 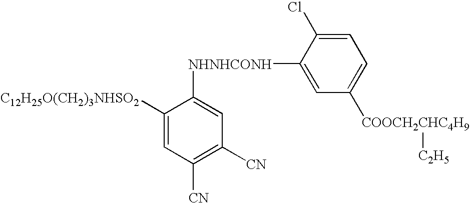 |
| 3-9 | 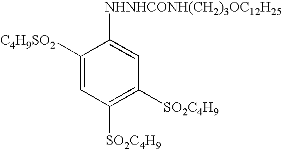 |
| 3-10 | 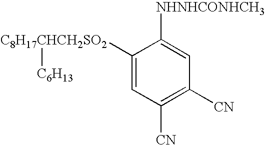 |
| 3-11 | 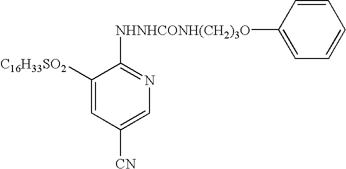 |
| 3-12 | 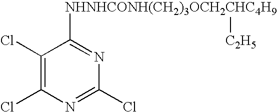 |
| 3-13 | 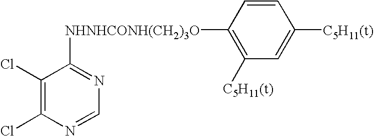 |
| 3-14 | 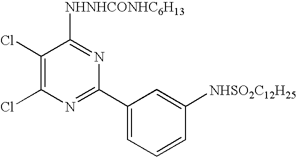 |
| 3-15 | 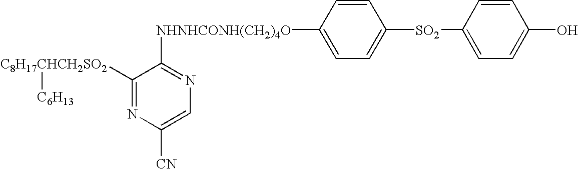 |
| 3-16 | 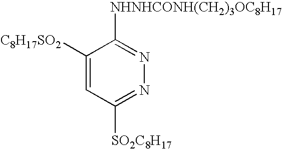 |
| 3-17 | 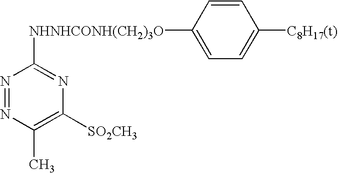 |
| 3-18 | 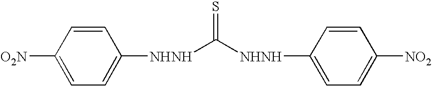 |
| 3-19 | 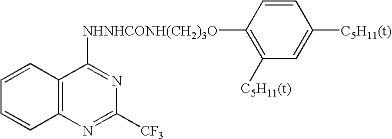 |
| 3-20 | 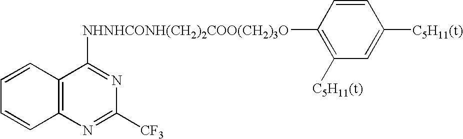 |
| 3-21 | 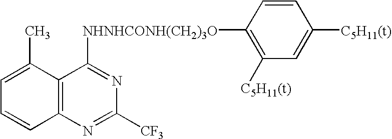 |
| 3-22 | 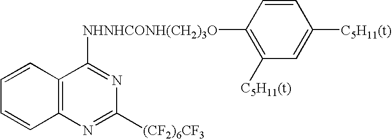 |
| 3-23 | 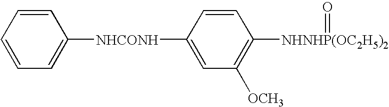 |
| 3-24 | 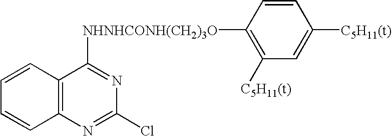 |
| 3-25 | 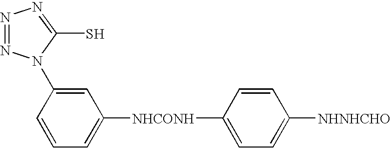 |
| 3-26 | 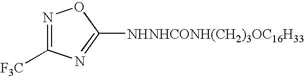 |
| 3-27 | 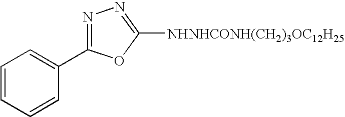 |
| 3-28 | 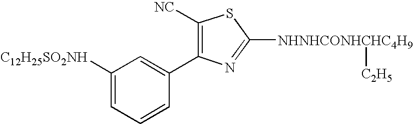 |
| 3-29 | 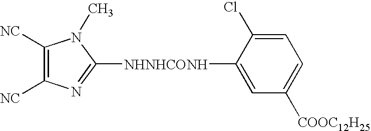 |
| 3-30 | 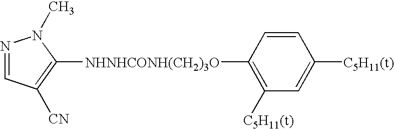 |
| 3-31 | 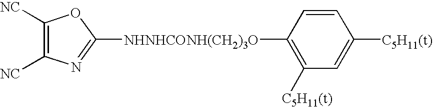 |
| 3-32 | 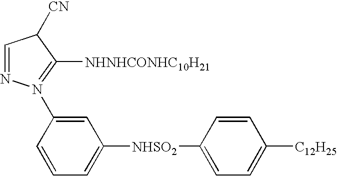 |
| 3-33 | 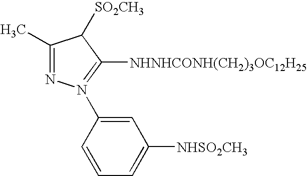 |
| 3-34 | 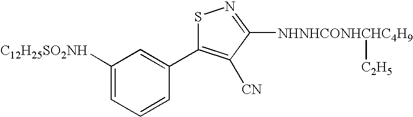 |
| 3-35 | 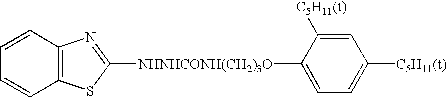 |
| 3-36 | 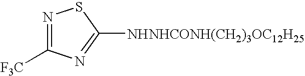 |
| 3-37 | 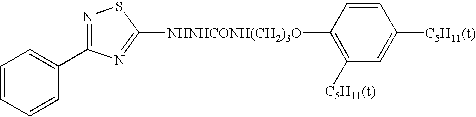 |
| 3-38 | 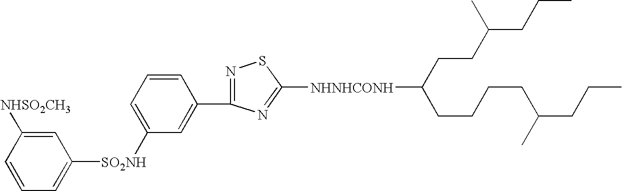 |
| 3-39 | 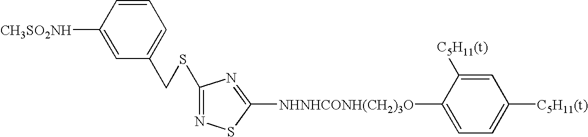 |
| 3-40 | 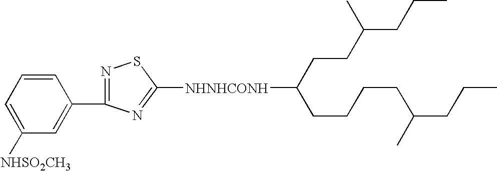 |
| 3-41 | 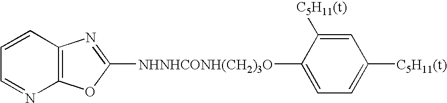 |
| 3-42 | 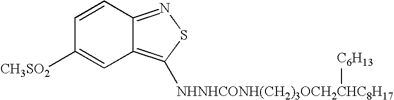 |
| 3-43 | 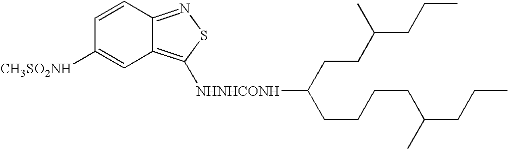 |
| 3-44 | 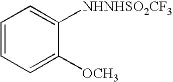 |
| 3-45 | 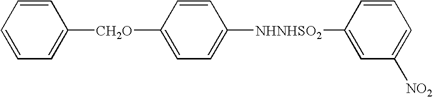 |
| 3-46 | 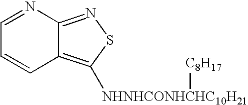 |
| 3-47 | 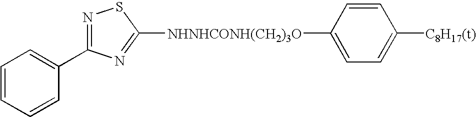 |
| 3-48 | 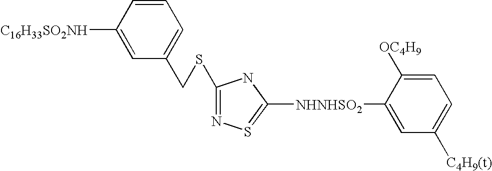 |
| 3-49 | 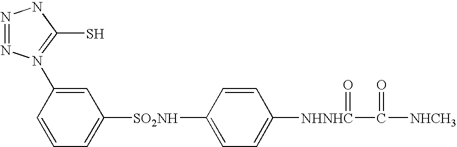 |
| 3-50 | 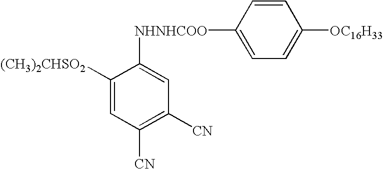 |
| 3-51 | 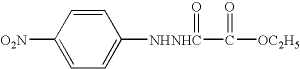 |
| 3-52 | 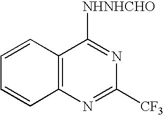 |
| 3-53 | 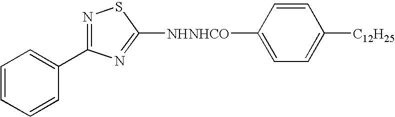 |
| 3-54 | 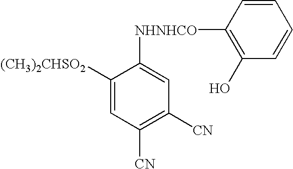 |

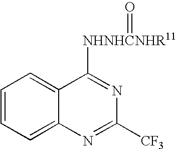

| Compound No. | R¹¹ |
|---|---|
| 3-55 | CH₃ |
| 3-56 | C₂H₅ |
| 3-57 | (n)C₃H₇ |
| 3-58 | (i)C₃H₇ |
| 3-59 | (n)C₄H₉ |
| 3-60 | (i)C₄H₉ |
| 3-61 | sec-C₄H₉ |
| 3-62 | (t)C₄H₉ |
| 3-63 | (n)C₅H₁₁ |
| 3-64 | (t)C₅H₁₁ |
| 3-65 | (n)C₆H₁₃ |
| 3-66 | 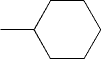 |
| 3-67 | (n)C₈H₁₇ |
| 3-68 | (t)C₈H₁₇ |
| 3-69 | 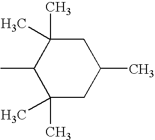 |
| 3-70 | 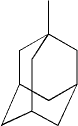 |
| 3-71 | 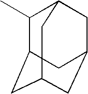 |
| 3-72 | 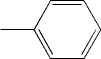 |
| 3-73 | 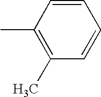 |
| 3-74 | 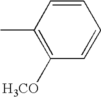 |
| 3-75 | 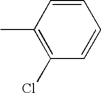 |
| 3-76 | 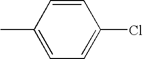 |
| 3-77 | 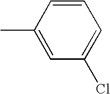 |
| 3-78 | 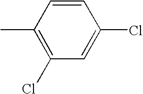 |
| 3-79 | 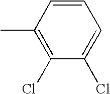 |
| 3-80 | 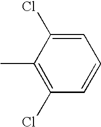 |
| 3-81 | 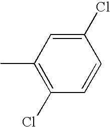 |
| 3-82 | 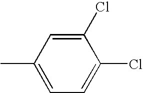 |
| 3-83 | 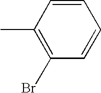 |
| 3-84 | 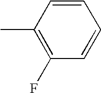 |
| 3-85 | 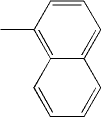 |
| 3-86 | 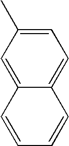 |
| 3-87 | 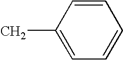 |
| 3-88 | 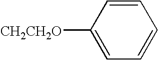 |
| 3-89 | CH₂CH₂OCH₂CH₃ |
| 3-90 | CH₂CH₂OCH₃ |
| 3-91 | 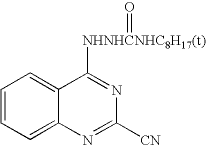 |
| 3-92 | 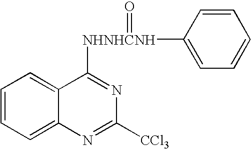 |
| 3-93 | 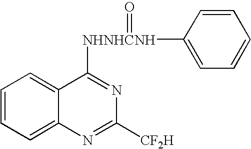 |
| 3-94 | 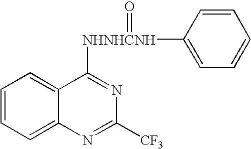 |
| 3-95 | 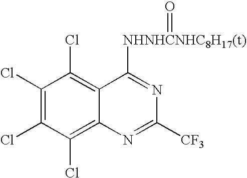 |
| 3-96 | 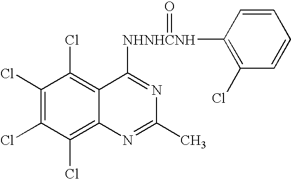 |
| 3-97 | 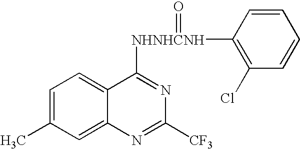 |
| 3-98 | 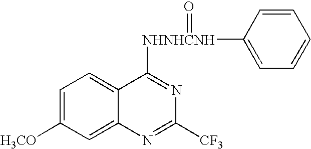 |
| 3-99 | 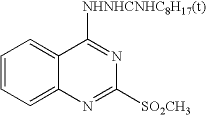 |
| 3-100 | 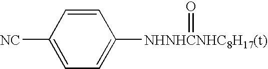 |
| 3-101 | 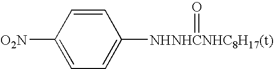 |
| 3-102 | 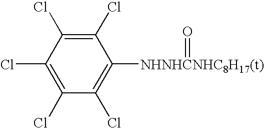 |
| 3-103 | 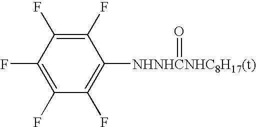 |
| 3-104 | 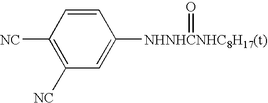 |
| 3-105 | 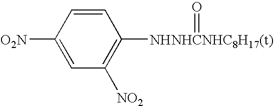 |
| 3-106 | 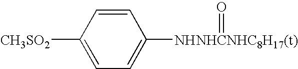 |

Now, the compounds represented by the general formula (P) or (Q) are described.

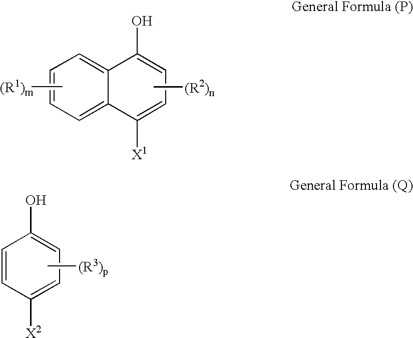

In the general formulae (P) and (Q), X¹ and X² independently represent a hydrogen atom or a substituent group. Examples of the substituent groups represented by X¹ and X² include e.g. a halogen atom (for example, a fluorine atom, chlorine atom, bromine atom, iodine atom), an aryl group (containing preferably 6 to 30, more preferably 6 to 20 and most preferably 6 to 12 carbon atoms, for example phenyl, p-methyl phenyl, naphthyl, etc.), an alkoxy group (containing preferably 1 to 20, more preferably 1 to 12 and most preferably 1 to 8 carbon atoms, for example methoxy, ethoxy, butoxy, etc.), an aryloxy group (containing preferably 6 to 20, more preferably 6 to 16 and most preferably 6 to 12 carbon atoms, for example phenyloxy, 2-naphthyloxy, etc.), an alkyl thio group (containing preferably 1 to 20, more preferably 1 to 16 and most preferably 1 to 12 carbon atoms, for example methyl thio, ethyl thio, butyl thio, etc.), an aryl thio group (containing preferably 6 to 20, more preferably 6 to 16 and most preferably 6 to 12 carbon atoms, for example phenyl thio, naphthyl thio, etc.), an acyloxy group (containing preferably 1 to 20, more preferably 2 to 16 and most preferably 2 to 10 carbon atoms, for example acetoxy, benzoyloxy, etc.), an acyl amino group (containing preferably 2 to 20, more preferably 2 to 16 and most preferably 2 to 10 carbon atoms, for example N-methyl acetyl amino, benzoyl amino, etc.), a sulfonyl amino group (containing preferably 1 to 20, more preferably 1 to 16 and most preferably 1 to 12 carbon atoms, for example methane sulfonyl amino, benzene sulfonyl amino, etc.), a carbamoyl group (containing preferably 1 to 20, more preferably 1 to 16 and most preferably 1 to 12 carbon atoms, for example carbamoyl, N,N-diethyl carbamoyl, N-phenyl carbamoyl, etc.), an acyl group (containing preferably 2 to 20, more preferably 2 to 16 and most preferably 2 to 12 carbon atoms, for example acetyl, benzoyl, formyl, pivaloyl, etc.), an alkoxy carbonyl group (containing preferably 2 to 20, more preferably 2 to 16 and most preferably 2 to 12 carbon atoms, for example methoxy carbonyl, etc.), a sulfo group, a sulfonyl group (containing preferably 1 to 20, more preferably 1 to 16 and most preferably 1 to 12 carbon atoms, for example mesyl, tosyl, etc.), a sulfonyloxy group (containing preferably 1 to 20, more preferably 1 to 16 and most preferably 1 to 12 carbon atoms, for example methanesulfonyloxy, benzenesulfonyloxy, etc.), an azo group, a heterocyclic group, a heterocyclic mercapto group and a cyano group. As used herein, the heterocyclic group represents a saturated or unsaturated heterocyclic group, such as a pyridyl group, quinolyl group, quinoxalinyl group, pyrazinyl group, benzotriazolyl group, pyrazolyl group, imidazolyl group, benzoimidazolyl group, tetrazolyl group, hydantoin-1-yl group, succinimde group and phthalimide group.

The substituent groups represented by X¹ and X² in the general formulae (P) and (Q) are more preferably an alkoxy group or an aryloxy group. The substituent groups represented by X¹ and X² may be further substituted with other substituent groups which may be any generally known substituent groups not deteriorating photographic performance.

In the general formulae (P) and (Q), each of R¹ to R³ independently represents a hydrogen atom or a substituent group. Each of m and p independently represents an integer of 0 to 4, and n represents an integer of 0 to 2. The substituent groups represented by R¹ to R³ may be any substituent groups not adversely affecting photographic performance. Examples of these substituent groups include a halogen atom (for example, a fluorine atom, chlorine atom, bromine atom, iodine atom), a linear, branched and/or cyclic alkyl group, or combination thereof (containing preferably 1 to 20, more preferably 1 to 16 and most preferably 1 to 13 carbon atoms, for example methyl, ethyl, n-propyl, isopropyl, sec-butyl, tert-butyl, tert-octyl, n-amyl, tert-amyl, n-dodecyl, n-tridecyl, cyclohexyl, etc.), an alkenyl group (containing preferably 2 to 20, more preferably 2 to 16 and most preferably 2 to 12 carbon atoms, for example vinyl, allyl, 2-butenyl, 3-pentenyl, etc.), an aryl group (containing preferably 6 to 30, more preferably 6 to 20 and most preferably 6 to 12 carbon atoms, for example phenyl, p-methyl phenyl, naphthyl, etc.), an alkoxy group (containing preferably 1 to 20, more preferably 1 to 16 and most preferably 1 to 12 carbon atoms, for example methoxy, ethoxy, propoxy, butoxy, etc.), an aryloxy group (containing preferably 6 to 30, more preferably 6 to 20 and most preferably 6 to 12 carbon atoms, for example phenyloxy, 2-naphthyloxy, etc.), an acyloxy group (containing preferably 2 to 20, more preferably 2 to 16 and most preferably 2 to 12 carbon atoms, for example acetoxy, benzoyloxy, etc.), an amino group (containing preferably 0 to 20, more preferably 1 to 16 and most preferably 1 to 12 carbon atoms, for example, a dimethyl amino group, diethyl amino group, dibutyl amino group, anilino group, etc.), an acyl amino group (containing preferably 2 to 20, more preferably 2 to 16 and most preferably 2 to 13 carbon atoms, for example acetyl amino, tridecanoyl amino, benzoyl amino, etc.), a sulfonyl amino group (containing preferably 1 to 20, more preferably 1 to 16 and most preferably 1 to 12 carbon atoms, for example methane sulfonyl amino, butane sulfonyl amino, benzene sulfonyl amino, etc.), an ureido group (containing preferably 1 to 20, more preferably 1 to 16 and most preferably 1 to 12 carbon atoms, for example ureido, methyl ureido, phenyl ureido, etc.), a carbamate group (containing preferably 2 to 20, more preferably 2 to 16 and most preferably 2 to 12 carbon atoms, for example methoxy carbonyl amino, phenyloxy carbonyl amino, etc.), a carboxyl group, a carbamoyl group (containing preferably 1 to 20, more preferably 1 to 16 and most preferably 1 to 12 carbon atoms, for example carbamoyl, N,N-diethyl carbamoyl, N-dodecyl carbamoyl, N-phenyl carbamoyl, etc.), an alkoxy carbonyl group (containing preferably 2 to 20, more preferably 2 to 16 and most preferably 2 to 12 carbon atoms, for example methoxy carbonyl, ethoxy carbonyl, butoxy carbonyl, etc.), an acyl group (containing preferably 2 to 20, more preferably 2 to 16 and most preferably 2 to 12 carbon atoms, for example acetyl, benzoyl, formyl, pivaloyl, etc.), a sulfo group, a sulfonyl group (containing preferably 1 to 20, more preferably 1 to 16 and most preferably 1 to 12 carbon atoms, for example mesyl, tosyl, etc.), a sulfamoyl group (containing preferably 0 to 20, more preferably 0 to 16 and most preferably 0 to 12 carbon atoms, for example sulfamoyl, methyl sulfamoyl, dimethyl sulfamoyl, phenyl sulfamoyl, etc.), a cyano group, a nitro group, a hydroxyl group, a mercapto group, an alkyl thio group (containing preferably 1 to 20, more preferably 1 to 16 and most preferably 1 to 12 carbon atoms, for example methyl thio, butyl thio, etc.), and a heterocyclic group (containing preferably 2 to 20, more preferably 2 to 16 and most preferably 2 to 12 carbon atoms, for example pyridyl, imidazolyl, pyrrolidyl, etc.). These substituent groups may further be substituted with other substituent groups.

Among the groups enumerated above, preferable examples of the substituent groups represented by R¹ to R³ in the general formulae (P) and (Q) include a halogen atom, alkyl group, aryl group, alkoxy group, aryloxy group, acyloxy group, anilino group, acyl amino group, sulfonyl amino group, carboxyl group, carbamoyl group, acyl group, sulfo group, sulfonyl group, sulfamoyl group, cyano group, hydroxyl group, mercapto group, alkyl thio group, and heterocyclic group.

More preferably, the compound represented by the general formula (P) has a carbamoyl group at the 2-position (containing preferably 1 to 20, more preferably 1 to 16 and most preferably 1 to 12 carbon atoms. Examples include carbamoyl, N,N-diethyl carbamoyl, N-dodecyl carbamoyl, N-phenyl carbamoyl, N-(2-chlorophenyl) carbamoyl, N-(4-chlorophenyl) carbamoyl, N-(2,4-dichlorophenyl) carbamoyl, N-(3,4-dichlorophenyl) carbamoyl, etc.), particularly preferably an aryl carbamoyl group at the 2-position (containing preferably 7 to 20, more preferably 7 to 16 and most preferably 7 to 12 carbon atoms, for example N-phenyl carbamoyl, N-(2-chlorophenyl) carbamoyl, N-(4-chlorophenyl) carbamoyl N-(2,4-dichlorophenyl) carbamoyl, N-(3,4-dichlorophenyl) carbamoyl, etc.).

Now, the compounds represented by the general formula (4) are described.

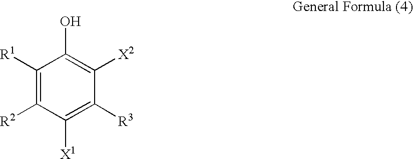

In the general formula (4), each of R¹, R² and R³ independently represents a hydrogen atom; a halogen atom; or a substituent group bound to the benzene ring via a carbon atom, an oxygen atom, a nitrogen atom, a sulfur atom or a phosphorus atom.

Non-restrictive examples of the substituent group bound via a carbon atom to the benzene ring include a linear, branched or cyclic alkyl group (for example, methyl, ethyl, iso-propyl, tert-butyl, n-octyl, tert-amyl, 1,3-tetramethyl butyl, cyclohexyl, etc.), an alkenyl group (for example, vinyl, allyl, 2-butenyl, 3-pentenyl, etc.), an alkynyl group (for example, propargyl group, 3-pentynyl group, etc.), an aryl group (for example, phenyl, p-methyl phenyl, naphthyl, etc.), an acyl group (for example, acetyl, benzoyl, formyl, pivaloyl, etc.), an alkoxy carbonyl group (for example, methoxy carbonyl, ethoxy carbonyl, etc.), an aryloxy carbonyl group (for example, phenoxy carbonyl, etc.), a carbamoyl group (carbamoyl, diethyl carbamoyl, phenyl carbamoyl, etc.), a cyano group, a carboxyl group and a heterocyclic group (for example, 3-pyrazolyl group, etc.).

Non-restrictive examples of the substituent group bound via an oxygen atom to the benzene ring include a hydroxyl group, an alkoxy group (for example, methoxy, ethoxy, butoxy, etc.), an aryloxy group (for example, phenyloxy, 2-naphthyloxy, etc.), a heterocyclic oxy group (for example, a 4-pyridyl oxy group, etc.) and an acyl oxy group (for example, acetoxy, benzoyloxy, etc.).

Non-restrictive examples of the substituent group bound via a nitrogen atom to the benzene ring include an amino group (for example, amino, methyl amino, dimethyl amino, diethyl amino, dibenzyl amino, etc.), a nitro group, a hydrazino group, a heterocyclic group (for example, 1-imidazolyl, morpholyl, etc.), an acyl amino group (for example, acetyl amino, benzoyl amino, etc.), an alkoxy carbonyl amino group (for example, methoxy carbonyl amino, etc.), an aryloxy carbonyl amino group (for example, phenyloxy carbonyl amino, etc.), a sulfonyl amino group (for example, methane sulfonyl amino, benzene sulfonyl amino, etc.), a sulfamoyl group (for example, sulfamoyl, methyl sulfamoyl, dimethyl sulfamoyl, phenyl sulfamoyl, etc.), an ureido group (for example, ureido, methyl ureido, phenyl ureido, etc.), a phosphoryl amino group (for example, diethyl phosphoryl amino, etc.) and an imide group (for example, succinimide, phthalimide, trifluoromethane sulfonimide, etc.).

Non-restrictive examples of the substituent group bound via a sulfur atom to the benzene ring include a mercapto group, a disulfide group, a sulfo group, a sulfino group, a sulfonyl thio group, a thiosulfonyl group, an alkyl thio group (for example, methyl thio, ethyl thio, etc.), an aryl thio group (for example, phenyl thio, etc.), a sulfonyl group (for example, mesyl, tosyl, phenyl sulfonyl, etc.), a sulfino group (for example, methane sulfinyl, benzene sulfinyl, etc.) and a heterocyclic thio group (for example, a 2-imidazolyl thio group, etc.).

Non-restrictive examples of the substituent group bound via a phosphorus atom to the benzene ring include a phosphate group (for example, diethyl phosphate, diphenyl phosphate, etc.).

Preferable examples of R¹, R² and R³ in the general formula (4) include a hydrogen atom, halogen atom, linear, branched or cyclic alkyl group, aryl group, acyl group, alkoxy carbonyl group, aryloxy carbonyl group, cyano group, carboxyl group, heterocyclic group, hydroxyl group, alkoxy group, aryloxy group, heterocyclic oxy group, acyloxy group, amino group, nitro group, heterocyclic group, acylamino group, alkoxy carbonyl amino group, aryloxy carbonyl amino group, sulfonyl amino group, imide group, sulfamoyl group, carbamoyl group, ureido group, mercapto group, disulfide group, sulfo group, sulfino group, alkyl thio group, aryl thio group, sulfonyl group, sulfinyl group, and heterocyclic thio group. More preferable examples of R¹, R² and R³ include a hydrogen atom, halogen atom, linear, branched or cyclic alkyl group, aryl group, acyl group, alkoxy carbonyl group, aryloxy carbonyl group, cyano group, carboxyl group, heterocyclic group, hydroxyl group, alkoxy group, aryloxy group, acyloxy group, amino group, nitro group, heterocyclic group, acylamino group, alkoxy carbonyl amino group, aryloxy carbonyl amino group, sulfonyl amino group, imide group, carbamoyl group, mercapto group, sulfo group, alkyl thio group, aryl thio group and sulfonyl group.

Particularly preferable examples of R¹, R² and R³ in the general formula (4) include a hydrogen atom, halogen atom, linear, branched or cyclic alkyl group, aryl group, acyl group, alkoxy carbonyl group, aryloxy carbonyl group, cyano group, carboxyl group, acyloxy group, acylamino group, alkoxy carbonyl amino group, aryloxy carbonyl amino group, sulfonyl amino group, carbamoyl group, sulfo group, alkyl sulfonyl group and aryl sulfonyl group.

In the general formula (4), each of X¹ and X² independently represents a hydrogen atom; a halogen atom; or a substituent group bound to the benzene ring via a carbon atom, oxygen atom, nitrogen atom, sulfur atom or phosphorus atom.

Non-restrictive examples of the substituent group bound via a carbon atom to the benzene ring include a linear, branched or cyclic alkyl group (for example, methyl, ethyl, iso-propyl, tert-butyl, n-octyl, tert-amyl, 1,3-tetramethyl butyl, cyclohexyl, etc.), an alkenyl group (for example, vinyl, allyl, 2-butenyl, 3-pentenyl, etc.), an alkynyl group (for example, a propargyl group, 3-pentynyl group, etc.), an aryl group (for example, phenyl, p-methyl phenyl, naphthyl, etc.), an acyl group (for example, acetyl, benzoyl, formyl, pivaloyl, , etc.), an alkoxy carbonyl group (for example, methoxy carbonyl, ethoxy carbonyl, , etc.), an aryloxy carbonyl group (for example, phenoxy carbonyl, , etc.), a cyano group, a carboxyl group, a heterocyclic group (for example, a 3-pyrazolyl group, etc.) and a carbamoyl group (carbamoyl, diethyl carbamoyl, phenyl carbamoyl, etc.). Non-restrictive examples of the substituent group bound via an oxygen atom to the benzene ring include a hydroxyl group, an alkoxy group (for example, methoxy, ethoxy, butoxy, etc.), an aryloxy group (for example, phenyloxy, 2-naphthyloxy, etc.), a heterocyclic oxy group (for example, a 4-pyridyl oxy group, etc.) and an acyl oxy group (for example, acetoxy, benzoyloxy, etc.).

Non-restrictive examples of the substituent group bound via a nitrogen atom to the benzene ring include an amino group (for example, amino, methyl amino, dimethyl amino, diethyl amino, dibenzyl amino, etc.), a nitro group, a hydroxame group, a hydrazino group, a heterocyclic group (for example, 1-imidazolyl, morpholyl, etc.), an acyl amino group (for example, acetyl amino, benzoyl amino, etc.), an alkoxy carbonyl amino group (for example, methoxy carbonyl amino, etc.), an aryloxy carbonyl amino group (for example, phenyloxy carbonyl amino, etc.), a sulfonyl amino group (for example, methane sulfonyl amino, benzene sulfonyl amino, etc.), a sulfamoyl group (for example, sulfamoyl, methyl sulfamoyl, dimethyl sulfamoyl, phenyl sulfamoyl, etc.) and a phosphoryl amino group (for example, diethyl phosphoryl amino, etc.).

Non-restrictive examples of the substituent group bound via a sulfur atom to the benzene ring include a mercapto group, a disulfide group, a sulfo group, a sulfino group, a sulfonyl thio group, a thiosulfonyl group, an alkyl thio group (for example, methyl thio, ethyl thio, etc.), an aryl thio group (for example, phenyl thio, etc.), a sulfonyl group (for example, mesyl, tosyl, phenyl sulfonyl, etc.), a sulfinyl group (for example, methane sulfinyl, benzene sulfinyl, etc.) and a heterocyclic thio group (for example, a 2-imidazolyl thio group, etc.).

Non-restrictive examples of the substituent group bound via a phosphorus atom to the benzene ring include a phosphate group (for example, diethyl phosphate, diphenyl phosphate, etc.).

Preferable examples of X¹ and X² in the general formula (4) include a hydrogen atom, halogen atom, linear, branched or cyclic alkyl group, aryl group, acyl group, alkoxy carbonyl group, aryloxy carbonyl group, cyano group, carboxyl group, heterocyclic group, hydroxyl group, alkoxy group, aryloxy group, heterocyclic oxy group, acyloxy group, amino group, nitro group, heterocyclic group, acylamino group, alkoxy carbonyl amino group, aryloxy carbonyl amino group, sulfonyl amino group, imide group, sulfamoyl group, carbamoyl group, ureido group, mercapto group, disulfide group, sulfo group, alkyl thio group, aryl thio group, sulfonyl group, and heterocyclic thio group. More preferable examples of X¹ and X² include a hydrogen atom, halogen atom, linear, branched or cyclic alkyl group, aryl group, acyl group, alkoxy carbonyl group, aryloxy carbonyl group, cyano group, carboxyl group, hydroxyl group, alkoxy group, aryloxy group, acyloxy group, amino group, acylamino group, alkoxy carbonyl amino group, aryloxy carbonyl amino group, sulfonyl amino group, imide group, carbamoyl group, sulfo group, and aryl sulfonyl group.

Particularly preferable examples of X¹ and X² in the general formula (4) include a hydrogen atom, halogen atom, linear, branched or cyclic alkyl group, aryl group, acyl group, alkoxy carbonyl group, aryloxy carbonyl group, cyano group, carboxyl group, alkoxy group, aryloxy group, acyloxy group, acylamino group, alkoxy carbonyl amino group, aryloxy carbonyl amino group, sulfonyl amino group, carbamoyl group, mercapto group and alkyl thio group.

In the general formula (4), at least one of X¹ and X² is a group represented by —NR⁴R⁵. Each of R⁴ and R⁵ independently represents a hydrogen atom, an alkyl group, an alkenyl group, an alkynyl group, an aryl group, a heterocyclic group, or a group represented by —C(═O)—R, —C(═O)—C(═O)—R, —SO₂—R, —SO—R, —P(═O)(R)₂ or —C(═NR′)—R. Each of R and R′ independently represents a group selected from a hydrogen atom, alkyl group, aryl group, heterocyclic group, amino group, alkoxy group and aryloxy group. When R⁴ and R⁵ represent a hydrogen atom, an alkyl group, an alkenyl group, an alkynyl group, an aryl group, and a heterocyclic group, these groups represent, for example, a linear, branched or cyclic alkyl group (for example, methyl, ethyl, iso-propyl, tert-butyl, n-octyl, tert-amyl, 1,3-tetramethyl butyl, cyclohexyl, etc.), an alkenyl group (for example, vinyl, allyl, 2-butenyl, 3-pentenyl, etc.), an alkynyl group (for example, a propargyl group, 3-pentynyl group, etc.), an aryl group (for example, phenyl, p-methyl phenyl, naphthyl, etc.), or a heterocyclic group (for example, 2-imidazoly, 1-pyrazolyl group, etc.).

When each of R⁴ and R⁵ in the general formula (4) is a group represented by —C(═O)—R, —C(═O)—C(═O)—R, —SO₂—R, —SO—R, —P(═O)(R)₂ and —C(═NR′)—R, each of R and R′ independently represents a hydrogen atom, an alkyl group (for example, methyl, ethyl, iso-propyl, tert-butyl, n-octyl, tert-amyl, 1,3-tetramethyl butyl, cyclohexyl, etc.), an aryl group (for example, phenyl, p-methyl phenyl, naphthyl, etc.), a heterocyclic group (for example, 4-pyridyl, 2-thienyl, 1-methyl-2-pyrrolyl, etc.), an amino group (for example, amino, dimethyl amino, diphenyl amino, phenyl amino, 2-pyridyl amino, etc.), an alkoxy group (for example, methoxy, ethoxy, cyclohexyloxy, etc.) and an aryloxy group (for example, phenoxy, 2-naphthoxy, etc.).

Preferable examples of R⁴ and R⁵ in the general formula (4) include a hydrogen atom, linear, branched or cyclic alkyl group, aryl group, acyl group, alkoxy carbonyl group, aryloxy carbonyl group, sulfamoyl group, carbamoyl group, sulfonyl group and sulfinyl group. More preferable examples of R⁴ and R⁵ include a hydrogen atom, linear, branched or cyclic alkyl group, aryl group, acyl group and sulfonyl group. In a particularly preferable combination, one of R⁴ and R⁵ is a hydrogen atom and the other is an alkyl sulfonyl group or aryl sulfonyl group. These substituent groups may further be substituted with substituent groups described above. When these substituent groups have a hydrogen atom having a high acidity, its proton may be dissociated to form a salt. As its counter cation, a metal ion, ammonium ion or phosphonium ion is used. The state of such compound from which active hydrogen was dissociated can be effective against the problem of volatility during development. R¹, R², R³, X¹ or X² may be bound to its adjacent group to form a ring.

Specific examples of the compounds represented by the general formula (4) are shown below, but these specific examples are not intended to limit the invention.

| | |
|---|---|
| 4-1 | 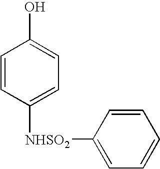 |
| 4-2 | 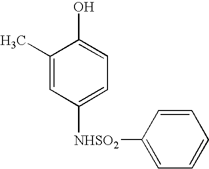 |
| 4-3 | 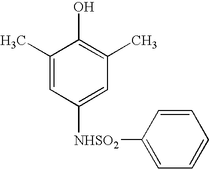 |
| 4-4 | 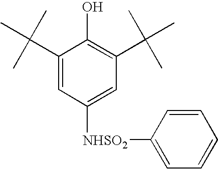 |
| 4-5 | 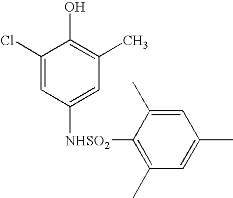 |
| 4-6 | 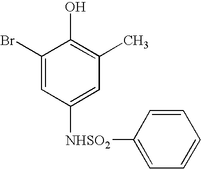 |
| 4-7 | 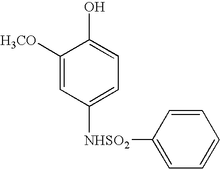 |
| 4-8 | 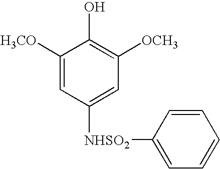 |
| 4-9 | 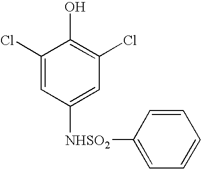 |
| 4-10 | 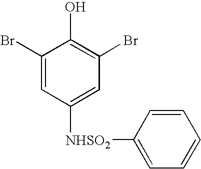 |
| 4-11 | 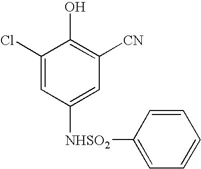 |
| 4-12 | 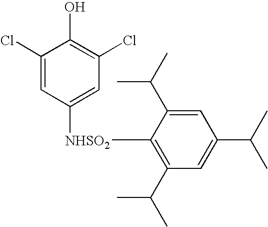 |
| 4-13 | 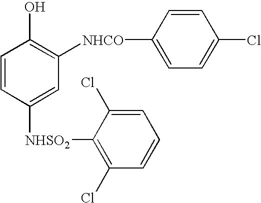 |
| 4-14 | 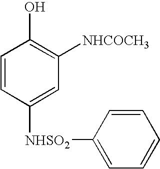 |
| 4-15 | 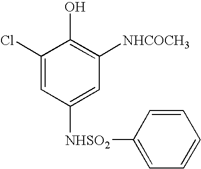 |
| 4-16 | 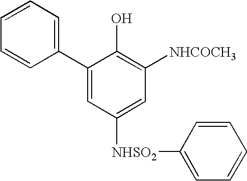 |
| 4-17 | 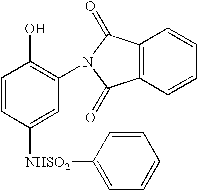 |
| 4-18 | 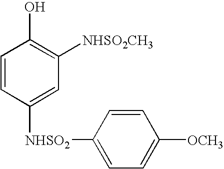 |
| 4-19 | 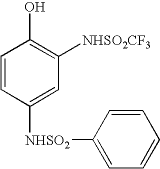 |
| 4-20 | 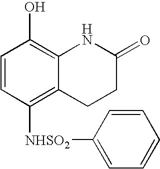 |
| 4-21 | 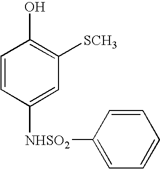 |
| 4-22 | 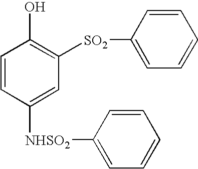 |
| 4-23 | 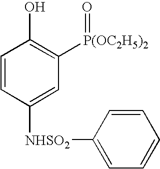 |
| 4-24 | 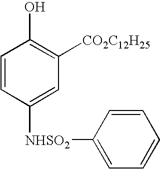 |
| 4-25 | 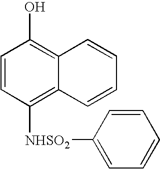 |
| 4-26 | 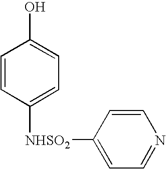 |
| 4-27 | 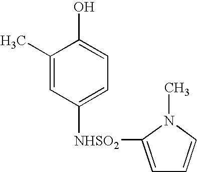 |
| 4-28 | 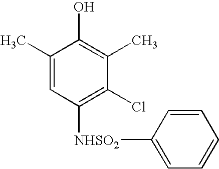 |
| 4-29 | 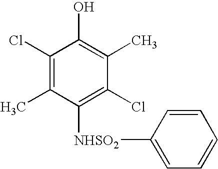 |
| 4-30 | 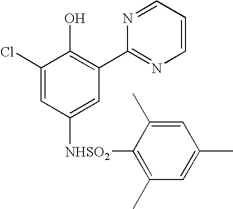 |
| 4-31 | 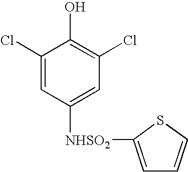 |
| 4-32 | 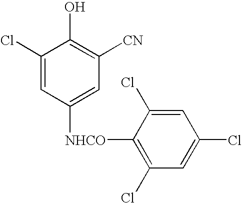 |
| 4-33 | 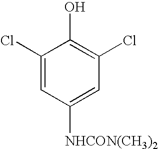 |
| 4-34 | 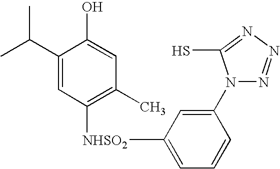 |
| 4-35 | 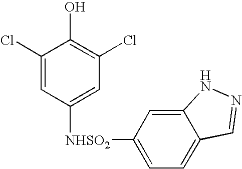 |
| 4-36 | 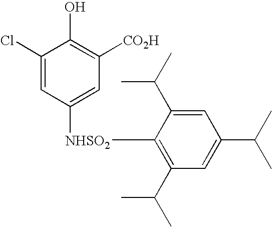 |
| 4-37 | 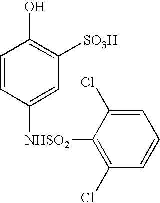 |
| 4-38 | 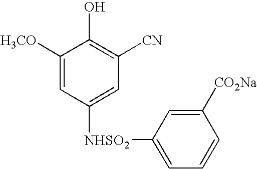 |
| 4-39 | 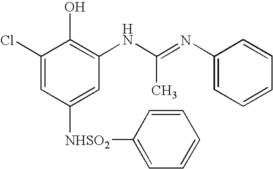 |
| 4-40 | 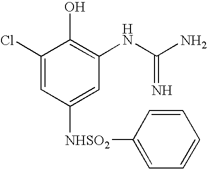 |
| 4-41 | 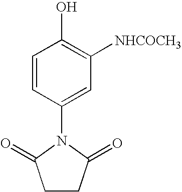 |
| 4-42 | 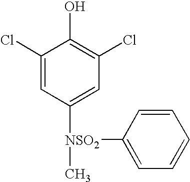 |
| 4-43 | 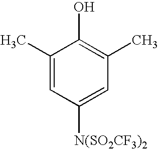 |
| 4-44 | 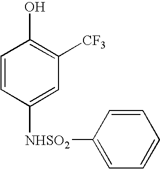 |
| 4-45 | 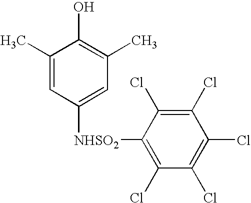 |
| 4-46 | 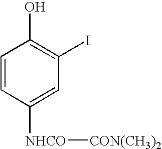 |
| 4-47 | 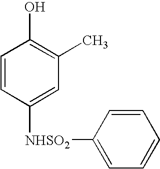 |
| 4-48 | 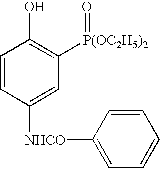 |
| 4-49 | 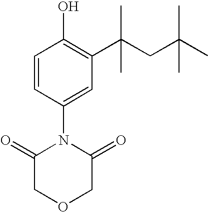 |
| 4-50 | 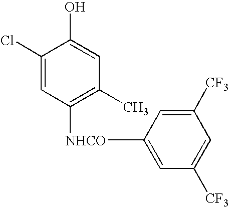 |
| 4-51 | 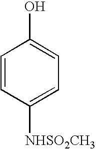 |
| 4-52 | 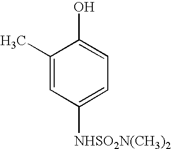 |
| 4-53 | 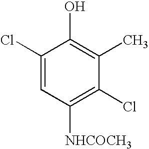 |
| 4-54 | 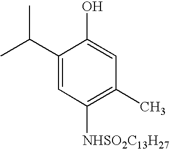 |
| 4-55 | 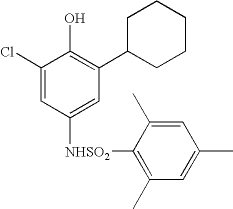 |
| 4-56 | 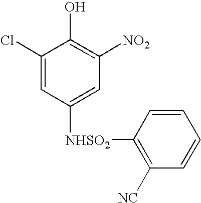 |
| 4-57 | 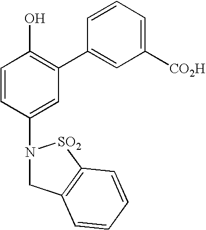 |
| 4-58 | 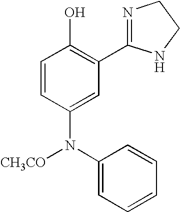 |
| 4-59 | 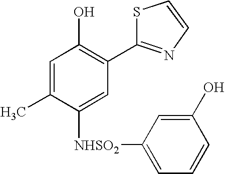 |
| 4-60 | 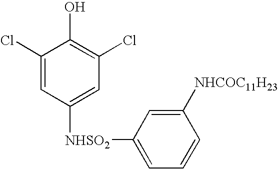 |
| 4-61 | 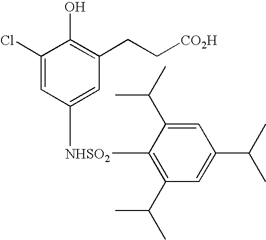 |
| 4-62 | 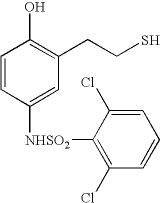 |
| 4-63 | 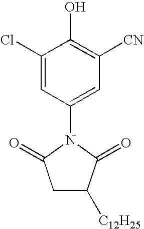 |
| 4-64 | 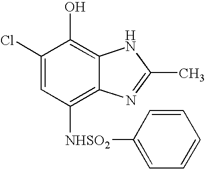 |
| 4-65 | 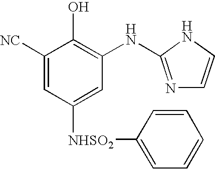 |
| 4-66 | 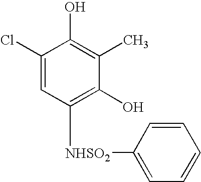 |
| 4-67 | 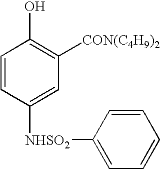 |
| 4-68 | 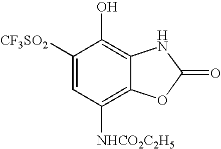 |
| 4-69 | 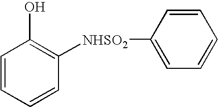 |
| 4-70 | 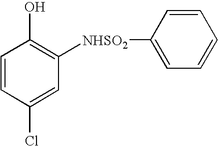 |
| 4-71 | 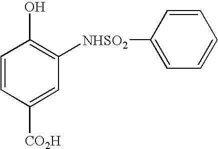 |
| 4-72 | 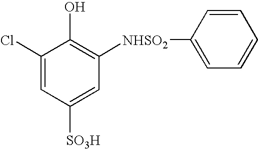 |
| 4-73 | 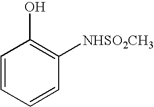 |
| 4-74 | 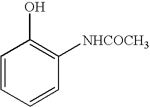 |
| 4-75 | 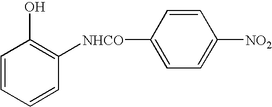 |
| 4-76 | 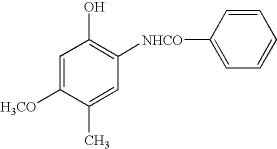 |
| 4-77 | 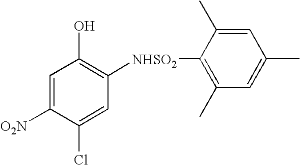 |
| 4-78 | 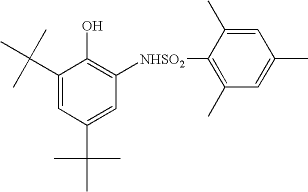 |
| 4-79 | 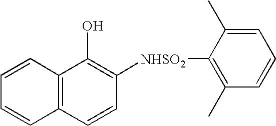 |
| 4-80 | 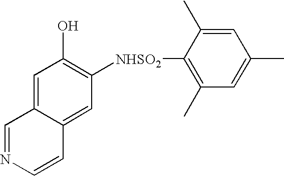 |
| 4-81 | 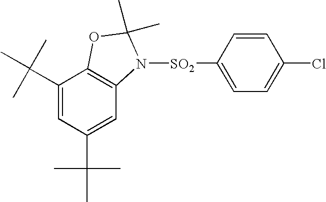 |
| 4-82 | 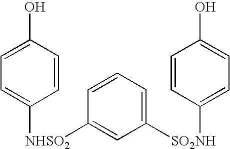 |
| 4-83 | 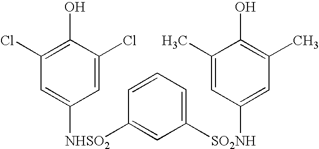 |
| 4-84 | 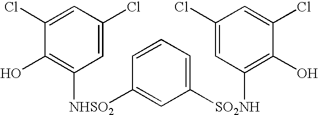 |
| 4-85 | 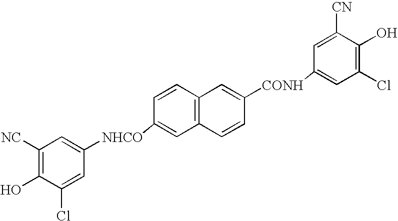 |
| 4-86 | 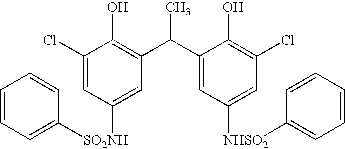 |
| 4-87 | 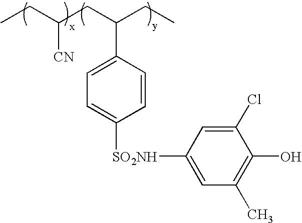 |
| 4-88 | 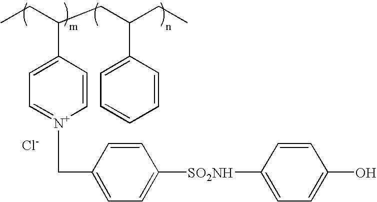 |
| 4-89 | 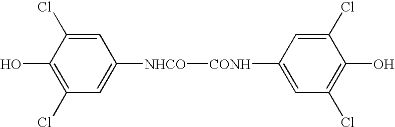 |

Now, the compounds (development accelerator) represented by the general formula (5) are described.

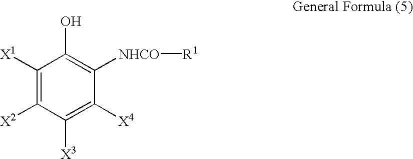

In the general formula (5), X¹ represents a substituent group which is substituted on the benzene ring and not a hydrogen atom. However, X¹ is not a hydroxyl group. Specific examples of the substituent group include a halogen atom, an alkyl group (including a cycloalkyl group and bicycloalkyl group), an alkenyl group (including a cycloalkenyl group and bicycloalkenyl group), an alkynyl group, aryl group, heterocyclic group, cyano group, nitro group, carboxyl group, alkoxy group, aryloxy group, silyloxy group, heterocyclic oxy group, acyloxy group, carbamoyloxy group, alkoxy carbonyloxy group, aryloxy carbonyloxy group, acyl amino group, amino carbonyl amino group, alkoxy carbonyl amino group, aryloxy carbonyl amino group, sulfamoyl amino group, alkyl and aryl sulfonyl amino group, mercapto group, alkyl thio group, aryl thio group, heterocyclic thio group, sulfamoyl group, sulfo group, alkyl and aryl sulfinyl group, alkyl and aryl sulfonyl group, acyl group, aryloxy carbonyl group, alkoxy carbonyl group, carbamoyl group, aryl and heterocyclic azo group, imide group, phosphino group, phosphinyl group, phosphinyloxy group, phosphinyl amino group and silyl group.

More specifically, examples of the substituent group is a halogen atom (fluorine atom, chlorine atom bromine atom or iodine atom), an alkyl group [linear, branched or cyclic substituted or unsubstituted alkyl group, which includes an alkyl group (preferably a C₁₋₃₀ alkyl group, for example a methyl group, ethyl group, n-propyl group, isopropyl group, tert-butyl group, n-octyl group, eicosyl group, 2-chloroethyl group, 2-cyanoethyl group, or 2-ethyl hexyl group), a cycloalkyl group (preferably a C₃₋₃₀ substituted or unsubstituted cycloalkyl group, for example a cyclohexyl group, cyclopentyl group, 4-n-dodecyl cyclohexyl group, etc.), a bicycloalkyl group (preferably a C₅₋₃₀ substituted or unsubstituted bicycloalkyl group, that is, a monovalent group derived from a C₅₋₃₀ bicycloalkane by removing one hydrogen atom, for example bicyclo[1,2,2] heptane-2-yl group, or bicyclo[2,2,2] octane-3-yl group), a tricyclo-structure containing more ring structures, and an alkyl group in a substituent group described later (for example an alkyl group in an alkyl thio group) also represents the alkyl group defined above], an alkenyl group [preferably a linear, branched or cyclic substituted or unsubstituted alkenyl group, such as an alkenyl group (preferably a C₂₋₃₀ substituted or unsubstituted alkenyl group, for example, a vinyl group, allyl group, prenyl group, geranyl group and oleyl group), a cycloalkenyl group (preferably a C₃₋₃₀ substituted or unsubstituted cycloalkenyl group, that is, a monovalent group derived from a C₃₋₈₀ cycloalkene by removing one hydrogen atom, for example 2-cyclopentene-1-yl group and 2-cyclohexene-1-yl group), a bicycloalkenyl group (substituted or unsubstituted bicycloalkenyl group, preferably a C₅₋₃₀ substituted or unsubstituted bicycloalkenyl group, that is, a monovalent group derived from a bicycloalkene having one double bond by removing one hydrogen atom, for example and bicyclo[2,2,1]hepto-2-ene-1-yl group, bicyclo[2,2,2]octo-2-ene-4-yl group)], an alkynyl group (preferably a C₂₋₃₀ substituted or unsubstituted alkynyl group, for example, an ethynyl group, propargyl group, and trimethyl silyl ethynyl group), an aryl group (preferably a C₆₋₃₀ substituted or unsubstituted aryl group, for example a phenyl group, p-tolyl group, naphthyl group, m-chlorophenyl group, and o-hexadecanoyl amino phenyl group), a heterocyclic group (preferably a monovalent group derived from a 5- to 6-membered substituted or unsubstituted aromatic or non-aromatic heterocyclic compound by removing one hydrogen atom, more preferably a C₃₋₃₀ 5- or 6-membered aromatic heterocyclic group, for example, a 2-furyl group, 2-thienyl group, 2-pyrimidinyl group, 2-benzothiazolyl group), a cyano group, a nitro group, a carboxyl group, an alkoxy group (preferably a C₁₋₃₀ substituted or unsubstituted alkoxy group, for example, a methoxy group, ethoxy group, isopropoxy group, tert-butoxy group, n-octyloxy group, and 2-methoxy ethoxy group), an aryloxy group (preferably a C₆₋₃₀ substituted or unsubstituted aryloxy group, for example, a phenoxy group, 2-methyl phenoxy group, 4-tert-butyl phenoxy group, 3-nitrophenoxy group, and 2-tetradecanoyl aminophenoxy group), a silyloxy group (preferably a C₃₋₂₀ silyloxy group, for example, a trimethyl silyloxy group and tert-butyl dimethyl silyloxy group), a heterocyclic oxy group (preferably a C₂₋₃₀ substituted or unsubstituted heterocyclic oxy group, 1-phenylnatorazole-5-oxy group and 2-tetrahydropyranyl oxy group), an acyloxy group (preferably a formyloxy group, a C₂₋₃₀ substituted or unsubstituted alkyl carbonyloxy group, a C₆₋₃₀ substituted or unsubstituted aryl carbonyloxy group, for example, a formyloxy group, acetyloxy group, pivaloyloxy group, stearoyloxy group, benzoyloxy group, and p-methoxyphenyl carbonyloxy group), a carbamoyloxy group (preferably a C₁₋₃₀ substituted or unsubstituted carbamoyloxy group, for example, N,N-dimethyl carbamoyloxy group, N,N-diethyl carbamoyloxy group, morpholinocarbonyloxy group, N,N-di-n-octyl aminocarbonyloxy group and N-n-octyl carbamoyloxy group), an alkoxy carbonyloxy group (preferably a C₂₋₃₀ substituted or unsubstituted alkoxy carbonyloxy group, for example a methoxy carbonyloxy group, ethoxy carbonyloxy group, tert-butoxy carbonyloxy group and n-octyl carbonyloxy group), an aryloxy carbonyloxy group (preferably a C₇₋₃₀ substituted or unsubstituted aryloxy carbonyloxy group, for example a phenoxy carbonyloxy group, p-methoxy phenoxy carbonyloxy group, p-n-hexadecyloxy and phenoxy carbonyloxy group), an acyl amino group (preferably a formyl amino group, C₁₋₃₀ substituted or unsubstituted alkyl carbonyl amino group, C₆₋₃₀ substituted or unsubstituted aryl carbonyl amino group, for example, a formyl amino group, acetyl amino group, pivaloyl amino group, lauroyl amino group, benzoyl amino group and 3,4,5-tri-n-octyloxy phenyl carbonyl amino group), an aminocarbonyl amino group (preferably a C₁₋₃₀ substituted or unsubstituted aminocarbonyl amino group, for example, a carbamoyl amino group, N,N-dimethyl aminocarbonyl amino group, N,N-diethyl aminocarbonyl amino group and morpholinocarbonyl amino group), an alkoxy carbonyl amino group (preferably a C₂₋₃₀ substituted or unsubstituted alkoxy carbonyl amino group, for example, a methoxy carbonyl amino group, ethoxy carbonyl amino group, tert-butoxy carbonyl amino group, n-octadecyloxy carbonyl amino group and N-methyl-methoxy carbonyl amino group), an aryloxy carbonyl amino group (preferably a C₇₋₃₀ substituted or unsubstituted aryloxy carbonyl amino group, for example, a phenoxy carbonyl amino group, p-chlorophenoxy carbonyl amino group and m-n-octyloxy phenoxy carbonyl amino group), a sulfamoyl amino group (preferably a C₀₋₃₀ substituted or unsubstituted sulfamoyl amino group, for example, a sulfamoyl amino group, N,N-dimethyl aminosulfonyl amino group and N-n-octyl aminosulfonyl amino group), an alkyl and aryl sulfonyl amino group (preferably a C₁₋₃₀ substituted or unsubstituted alkyl sulfonyl amino group, a C₆₋₃₀ substituted or unsubstituted aryl sulfonyl amino group, for example, a methyl sulfonyl amino group, butyl sulfonyl amino group, phenyl sulfonyl amino group, 2,3,5-trichlorophenyl sulfonyl amino group and p-methylphenyl sulfonyl amino group), a mercapto group, an alkyl thio group (preferably a C₁₋₃₀ substituted or unsubstituted alkyl thio group, for example, a methyl thio group, ethyl thio group, n-hexadecyl thio group), an aryl thio group (preferably a C₆₋₃₀ substituted or unsubstituted alkyl thio group, for example, a phenyl thio group, p-chlorophenyl thio group and m-methoxyphenyl thio group), a heterocyclic thio group (preferably a C₂₋₃₀ substituted or unsubstituted heterocyclic thio group, for example a 2-benzothiazolyl thio group and 1-phenyltetrazole-5-yl thio group), a sulfamoyl group (preferably a C₀₋₃₀ substituted or unsubstituted sulfamoyl group, for example, an N-ethyl sulfamoyl group, N-(3-dodecyloxypropyl) sulfamoyl group, N,N-dimethyl sulfamoyl group, N-acetyl sulfamoyl group, N-benzoyl sulfamoyl group and N-(N′-phenylcarbamoyl) sulfamoyl group), a sulfo group, an alkyl and aryl sulfinyl group (preferably a C₁₋₃₀ substituted or unsubstituted alkyl sulfinyl group, a C₆₋₃₀ substituted or unsubstituted aryl sulfinyl group, for example, a methyl sulfinyl group, ethyl sulfinyl group, phenyl sulfinyl group and p-methylphenyl sulfinyl group), an alkyl and aryl sulfonyl group (preferably a C₁₋₃₀ substituted or unsubstituted alkyl sulfonyl group, a C₆₋₃₀ substituted or unsubstituted aryl sulfonyl group, for example, a methyl sulfonyl group, ethyl sulfonyl group, phenyl sulfonyl group, and p-methylphenyl sulfonyl group), an acyl group (preferably a formyl group, a C₂₋₃₀ substituted or unsubstituted alkyl carbonyl group, a C₇₋₃₀ substituted or unsubstituted aryl carbonyl group, a C₄₋₃₀ substituted or unsubstituted heterocyclic carbonyl group having a carbonyl group bound via a carbon atom, for example, an acetyl group, pivaloyl group, 2-chloroacetyl group, stearoyl group, benzoyl group, p-n-octyloxy phenyl carbonyl group, 2-pyridyl carbonyl group, 2-furyl carbonyl group), an aryloxy carbonyl group (preferably a C₇₋₃₀ substituted or unsubstituted aryloxy carbonyl group, for example, a phenoxy carbonyl group, o-chlorophenoxy carbonyl group, m-nitrophenoxy carbonyl group and p-tert-butyl phenoxy carbonyl group), an alkoxy carbonyl group (preferably a C₂₋₃₀ substituted or unsubstituted alkoxy carbonyl group, for example, a methoxy carbonyl group, ethoxy carbonyl group, tert-butoxy carbonyl group and n-octadecyloxy carbonyl group), a carbamoyl group (preferably a C₁₋₃₀ substituted or unsubstituted carbamoyl group, for example, a carbamoyl group, N-methyl carbamoyl group, N,N-dimethyl carbamoyl group, N,N-di-n-octyl carbamoyl group and N-(methylsulfonyl) carbamoyl group), an aryl and heterocyclic azo group (preferably a C₆₋₃₀ substituted or unsubstituted aryl azo group, a C₃₋₃₀ substituted or unsubstituted heterocyclic azo group, for example, a phenyl azo group, p-chlorophenyl azo group, and 5-ethylthio-1,3,4-thiadiazole-2-yl azo group), an imide group (preferably a N-succinimide group and N-phthalimide group), a phosphino group (preferably a C₂₋₃₀ substituted or unsubstituted phosphino group, for example, a dimethyl phosphino group, diphenyl phosphino group and methyl phenoxy phosphino group), a phosphinyl group (preferably a C₂₋₃₀ substituted or unsubstituted phosphinyl group, for example a phosphinyl group, dioctyloxy phosphinyl group and diethoxy phosphinyl group), a phosphinyloxy group (preferably a C₂₋₃₀ substituted or unsubstituted phosphinyloxy group, for example a diphenoxy phosphinyloxy group and dioctyloxy phosphinyloxy group), a phosphinyl amino group (preferably a C₂₋₃₀ substituted or unsubstituted phosphinyl amino group, for example a dimethoxy phosphinyl amino group and dimethyl aminophosphinyl amino group), and a silyl group (preferably a C₃₋₃₀ substituted or unsubstituted silyl group, for example a trimethyl silyl group, tert-butyl dimethyl silyl group and phenyl dimethyl silyl group).

Preferable examples of the substituent group represented by X¹ in the general formula (4) include a halogen atom (fluorine atom, chlorine atom, bromine atom, iodine atom, preferably chlorine atom and bromine atom), an acyl amino group (containing preferably 1 to 20, more preferably 1 to 14 and most preferably 1 to 8 carbon atoms, for example a formyl amino group, acetyl amino group, benzoyl amino group, etc.), an alkyl group (containing preferably 1 to 20, more preferably 1 to 14 and most preferably 1 to 8 carbon atoms, for example a methyl group, ethyl group, isopropyl group, cyclohexyl group, etc.), an aryl group (containing preferably 6 to 20, more preferably 6 to 14 and most preferably 6 to 8 carbon atoms, for example a phenyl group, naphthyl group, p-methyl phenyl group, etc.), an alkoxy group (containing preferably 1 to 20, more preferably 1 to 14 and most preferably 1 to 8 carbon atoms, for example a methoxy group, ethoxy group, etc.), an aryloxy group (containing preferably 6 to 20, more preferably 6 to 14 and most preferably 6 to 8 carbon atoms, for example a phenoxy group, 2-naphthyloxy group, etc.), an acyloxy group (containing preferably 1 to 20, more preferably 1 to 14 and most preferably 1 to 8 carbon atoms, for example an acetoxy group, benzoyloxy group, etc.), a sulfonyl amino group (containing preferably 1 to 20, more preferably 1 to 14 and most preferably 1 to 8 carbon atoms, for example a methane sulfonyl amino group, benzene sulfonyl amino group, etc.), a carbamoyl group (containing preferably 1 to 20, more preferably 1 to 14 and most preferably 1 to 8 carbon atoms, for example a carbamoyl group, N,N-dimethyl carbamoyl group, N-phenyl carbamoyl group, etc.), an acyl group (containing preferably 1 to 20, more preferably 1 to 14 and most preferably 1 to 8 carbon atoms, for example a formyl group, acetyl group, benzoyl group, etc.), an alkoxy carbonyl group (containing preferably 2 to 20, more preferably 2 to 16 and most preferably 2 to 12 carbon atoms, for example a methoxy carbonyl group, ethoxy carbonyl group, butoxy carbonyl group, etc.), an aryloxy carbonyl group (containing preferably 6 to 20, more preferably 6 to 16 and most preferably 6 to 12 carbon atoms, for example a phenoxy carbonyl group, 2-naphthyloxy carbonyl group, etc.), a cyano group and a nitro group, more preferably a halogen atom, an acyl amino group and an alkyl group and most preferably a chlorine atom and bromine atom.

In the general formula (5), X³ represents a hydrogen atom or a substituent group. However, X³ is not a hydroxyl group or sulfonamide group. Specific examples of the substituent group include the substituent groups (excluding a sulfonamide group) exemplified above as X¹ in the general formula (5). Preferable examples of X³ include a hydrogen atom, a halogen atom (fluorine atom, chlorine atom, bromine atom, iodine atom, preferably chlorine atom, bromine atom), an acyl amino group (containing preferably 1 to 20, more preferably 1 to 14 and most preferably 1 to 8 carbon atoms, for example a formyl amino group, acetyl amino group, benzoyl amino group, etc.), an alkyl group (containing preferably 1 to 20, more preferably 1 to 14 and most preferably 1 to 8 carbon atoms, for example a methyl group, ethyl group, isopropyl group, cyclohexyl group, etc.), an aryl group (containing preferably 6 to 20, more preferably 6 to 14 and most preferably 6 to 8 carbon atoms, for example a phenyl group, naphthyl group, p-methyl phenyl group, etc.), an alkoxy group (containing preferably 1 to 20, more preferably 1 to 14 and most preferably 1 to 8 carbon atoms, for example a methoxy group, ethoxy group, etc.), an aryloxy group (containing preferably 6 to 20, more preferably 6 to 14 and most preferably 6 to 8 carbon atoms, for example a phenoxy group, 2-naphthyloxy group, etc.), an acyloxy group (containing preferably 1 to 20, more preferably 1 to 14 and most preferably 1 to 8 carbon atoms, for example an acetoxy group, benzoyloxy group, etc.), a carbamoyl group (containing preferably 1 to 20, more preferably 1 to 14 and most preferably 1 to 8 carbon atoms, for example a carbamoyl group, N,N-dimethyl carbamoyl group, N-phenyl carbamoyl group, etc.), an acyl group (containing preferably 1 to 20, more preferably 1 to 14 and most preferably 1 to 8 carbon atoms, for example a formyl group, acetyl group, benzoyl group, etc.), an alkoxy carbonyl group (containing preferably 2 to 20, more preferably 2 to 16 and most preferably 2 to 12 carbon atoms, for example a methoxy carbonyl group, ethoxy carbonyl group, butoxy carbonyl group, etc.), an aryloxy carbonyl group (containing preferably 6 to 20, more preferably 6 to 16 and most preferably 6 to 12 carbon atoms, for example a phenoxy carbonyl group, 2-naphthyloxy carbonyl group, etc.), a cyano group and a nitro group, particularly preferably a halogen atom, acyl amino group and alkyl group, particularly preferably a chlorine atom or bromine atom.

In the general formula (5), the substituent group represented by X¹ and/or X³ is an electron attracting group. The electron attracting group is a substituent group whose Hammett's substituent constant σρ value is positive, and specific examples of the substituent groups include a halogen atom, cyano group, nitro group, alkoxy carbonyl group, aryloxy carbonyl group, imino group, imino group substituted with an N atom, theocarbonyl group, perfluoroalkyl group, sulfonamide group, formyl group, phosphoryl group, carboxyl group, carbamoyl group, acyl group, sulfo group (or a salt thereof, alkyl sulfonyl group, aryl sulfonyl group, sulfamoyl group, acyloxy group, acyl thio group, sulfonyloxy group, heterocyclic group, or an aryl group substituted with these electron attracting groups. Both X¹ and X³ represent preferably an electron attracting group, more preferably a halogen atom, particularly preferably a chlorine atoms or bromine atom.

In the general formula (5), X² and X⁴ represent a hydrogen atom or a substituent group. However, X² and X⁴ are not a hydroxyl groups. Specific examples of the substituent group include the substituent groups exemplified above as X¹ in the general formula (5). Preferable examples of X² and X⁴ include a hydrogen atom, a halogen atom (fluorine atom, chlorine atom, bromine atom, iodine atom, preferably chlorine atom, bromine atom), an acyl amino group (containing preferably 1 to 20, more preferably 1 to 14 and most preferably 1 to 8 carbon atoms, for example a formyl amino group, acetyl amino group, benzoyl amino group, etc.), an alkyl group (containing preferably 1 to 20, more preferably 1 to 14 and most preferably 1 to 8 carbon atoms, for example a methyl group, ethyl group, isopropyl group, cyclohexyl group, etc.), an aryl group (containing preferably 6 to 20, more preferably 6 to 14 and most preferably 6 to 8 carbon atoms, for example a phenyl group, naphthyl group, p-methyl phenyl group, etc.), an alkoxy group (containing preferably 1 to 20, more preferably 1 to 14 and most preferably 1 to 8 carbon atoms, for example a methoxy group, ethoxy group, etc.), an aryloxy group (containing preferably 6 to 20, more preferably 6 to 14 and most preferably 6 to 8 carbon atoms, for example a phenoxy group, 2-naphthyloxy group, etc.), an acyloxy group (containing preferably 1 to 20, more preferably 1 to 14 and most preferably 1 to 8 carbon atoms, for example an acetoxy group, benzoyloxy group, etc.), a sulfonyl amino group (containing preferably 1 to 20, more preferably 1 to 14 and most preferably 1 to 8 carbon atoms, for example a methane sulfonyl amino group, benzene sulfonyl amino group, etc.), a carbamoyl group (containing preferably 1 to 20, more preferably 1 to 14 and most preferably 1 to 8 carbon atoms, for example a carbamoyl group, N,N-dimethyl carbamoyl group, N-phenyl carbamoyl group, etc.), an acyl group (containing preferably 1 to 20, more preferably 1 to 14 and most preferably 1 to 8 carbon atoms, for example a formyl group, acetyl group, benzoyl group, etc.), an alkoxy carbonyl group (containing preferably 2 to 20, more preferably 2 to 16 and most preferably 2 to 12 carbon atoms, for example a methoxy carbonyl group, ethoxy carbonyl group, butoxy carbonyl group, etc.), an aryloxy carbonyl group (containing preferably 6 to 20, more preferably 6 to 16 and most preferably 6 to 12 carbon atoms, for example a phenoxy carbonyl group, 2-naphthyloxy carbonyl group, etc.), a cyano group and a nitro group. The substituent group is more preferably a hydrogen atom, an alkyl group, an aryl group, a halogen atom and an acyl amino group, most preferably a hydrogen atom, a methyl group and an ethyl group.

In the general formula (5), X¹ to X⁴ may be further substituted with substituent groups, and specific examples of these substituent groups include the substituent groups exemplified as X¹ in the general formula (5). Further, X¹ to X⁴ may be bound to each other to form a ring.

In the general formula (5), R¹ represents a hydrogen atom, an alkyl group (containing preferably 1 to 20, more preferably 1 to 14 and most preferably 1 to 7 carbon atoms, for example a methyl group, ethyl group, isopropyl group, cyclohexyl group, etc.), an aryl group (containing preferably 6 to 20, more preferably 6 to 14 and most preferably 6 to 8 carbon atoms, for example a phenyl group, naphthyl group, p-methyl phenyl group, etc.), a heterocyclic group (for example a pyridyl group, imidazolyl group, pyrrolidyl group, etc.), an amino group (containing preferably 0 to 20, more preferably 0 to 14 and most preferably 0 to 8 carbon atoms, for example an amino group, methyl amino group, N,N-dimethyl amino group, N-phenyl amino group, etc.), or an alkoxy group (containing preferably 1 to 20, more preferably 1 to 14 and most preferably 1 to 8 carbon atoms, for example a methoxy group, ethoxy group, etc.). The substituent group is preferably a hydrogen atom, aryl group, heterocyclic group, amino group, alkoxy group or C₁₋₇ alkyl group, more preferably an aryl group or C₁₋₇ alkyl group, and most preferably an aryl group. R¹ may be further substituted with substituent groups, and specific examples of these substituent groups include the substituent groups exemplified as X¹ in the general formula (5).

In a preferable combination of X¹ to X⁴ and R¹ in the general formula (5), at least one of X¹ and X³ is a halogen atom, each of X² and X⁴ is a hydrogen atom or alkyl group, R¹ is an aryl group or a C₁₋₇ alkyl group. In a more preferable combination, each of X¹ and X³ is a chlorine atom or bromine atom, X² is a hydrogen atom or an alkyl group, X⁴ is a hydrogen atom, and R¹ is an aryl group.

The total molecular weight of the compound represented by the general formula (5) is preferably from 170 to 800, more preferably from 220 to 650 and most preferably from 220 to 500.

Specific examples of the compound represented by the general formula (5) are shown below, but these examples are not intended to limit the invention.

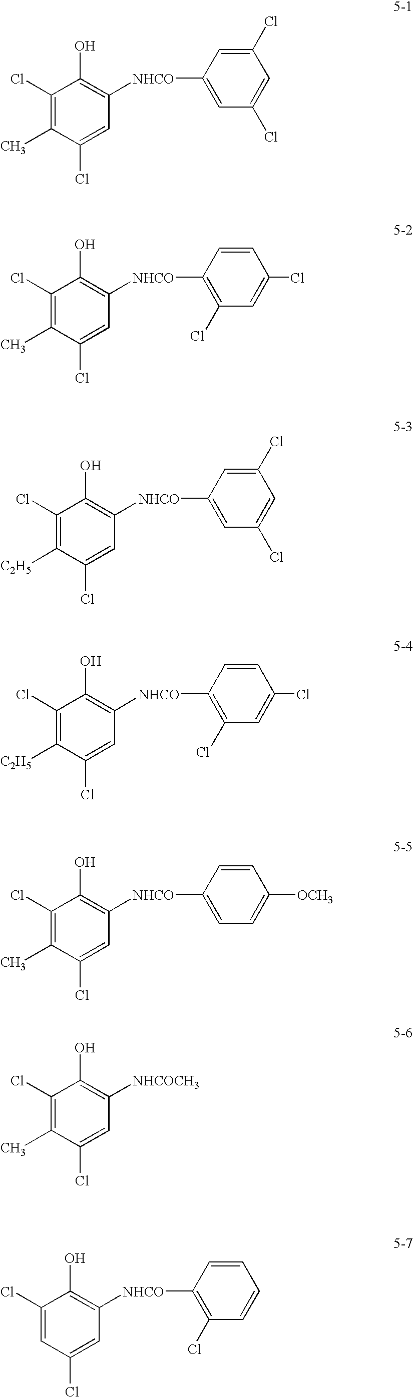

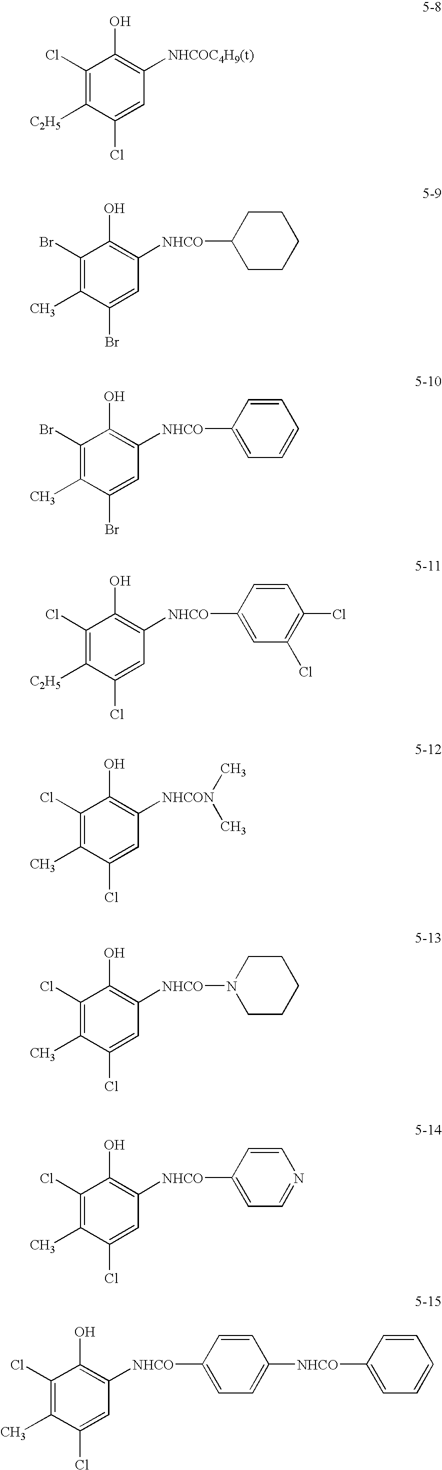

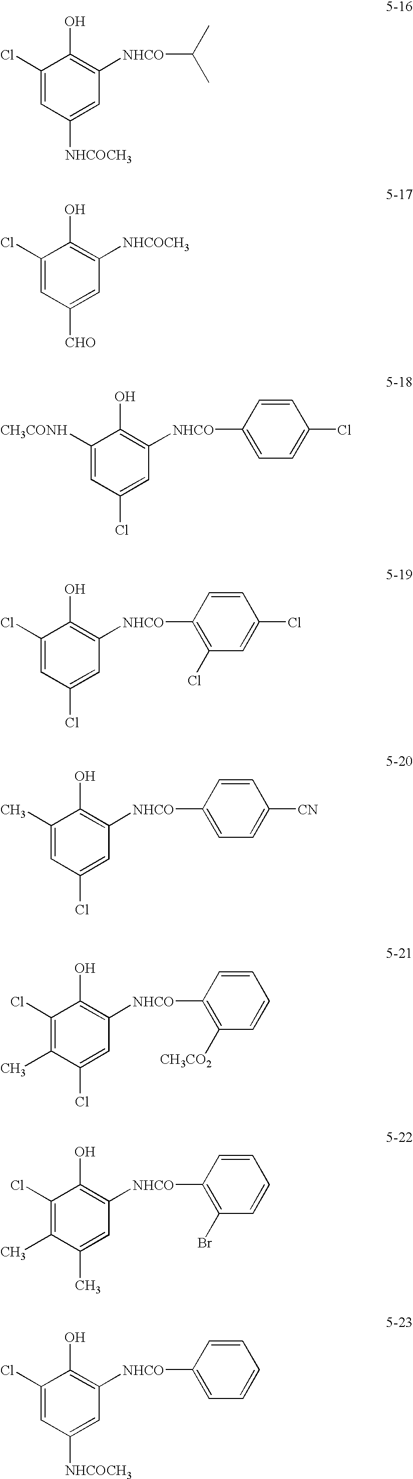

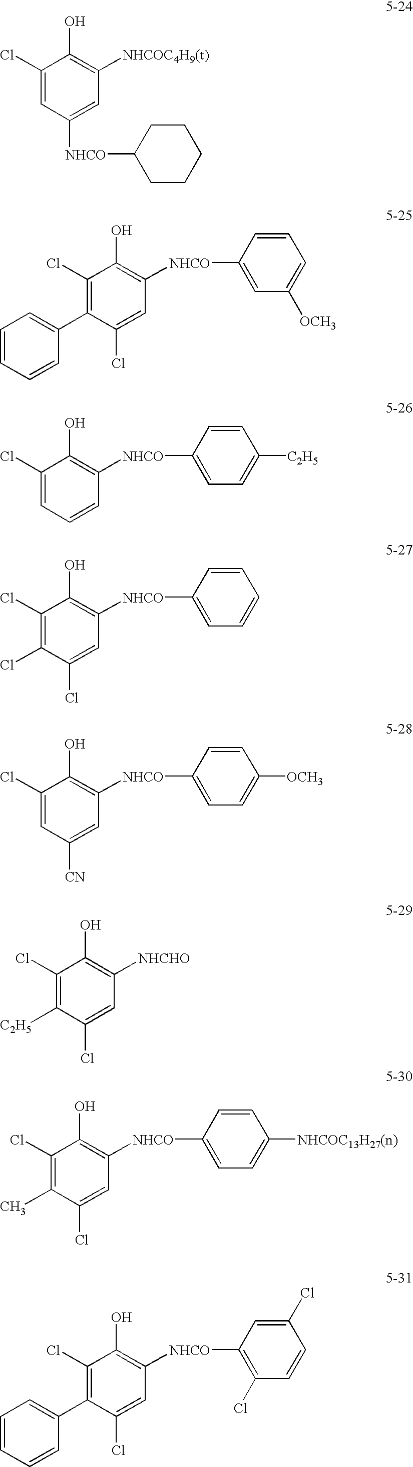

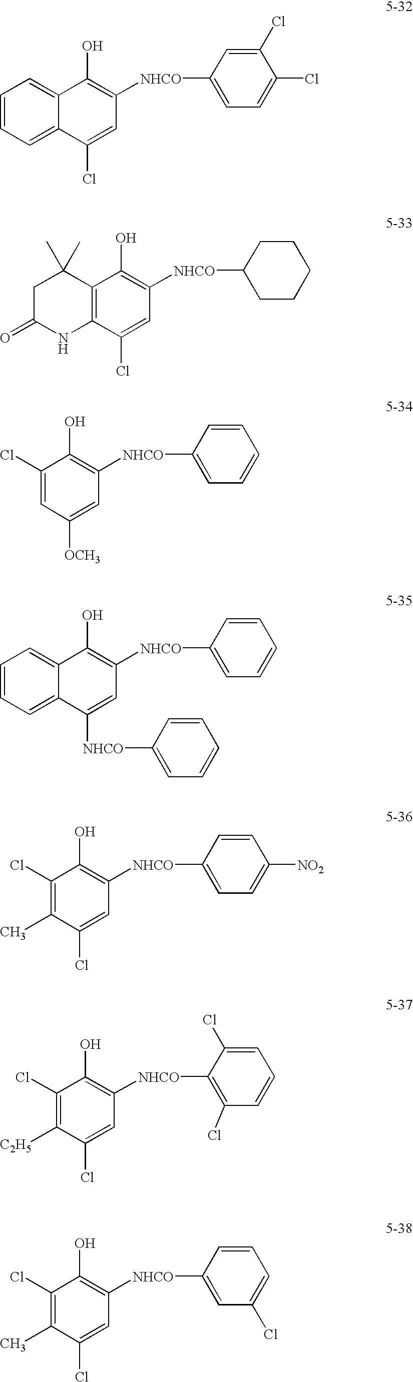

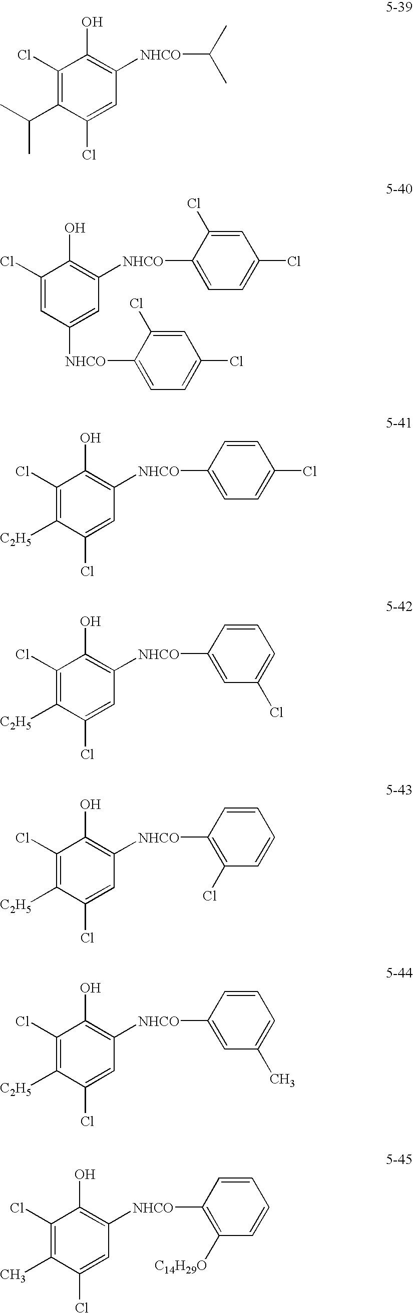

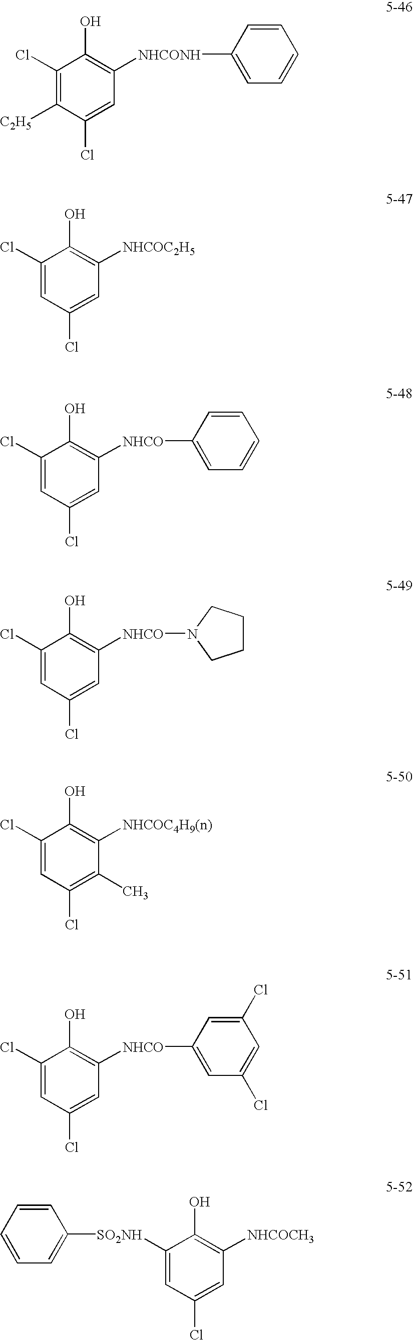

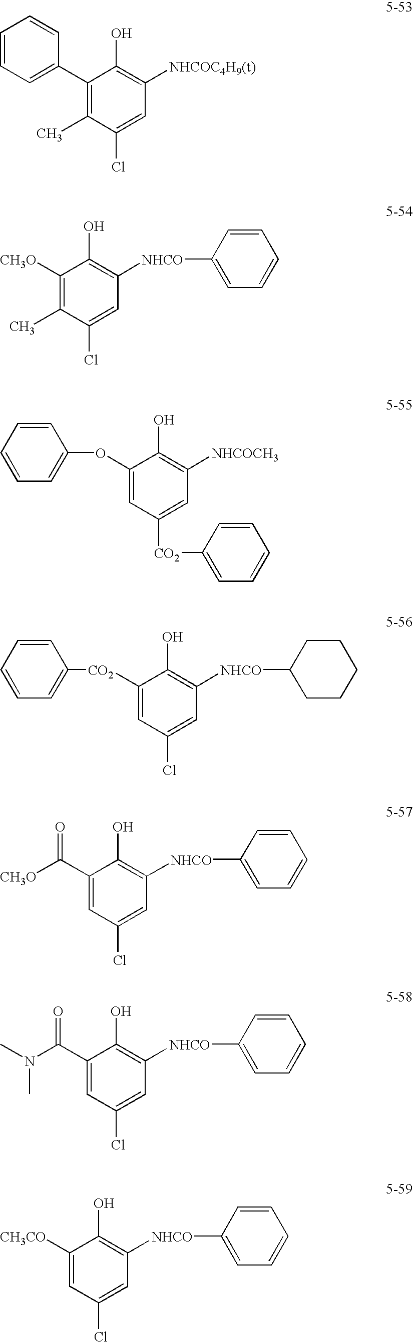

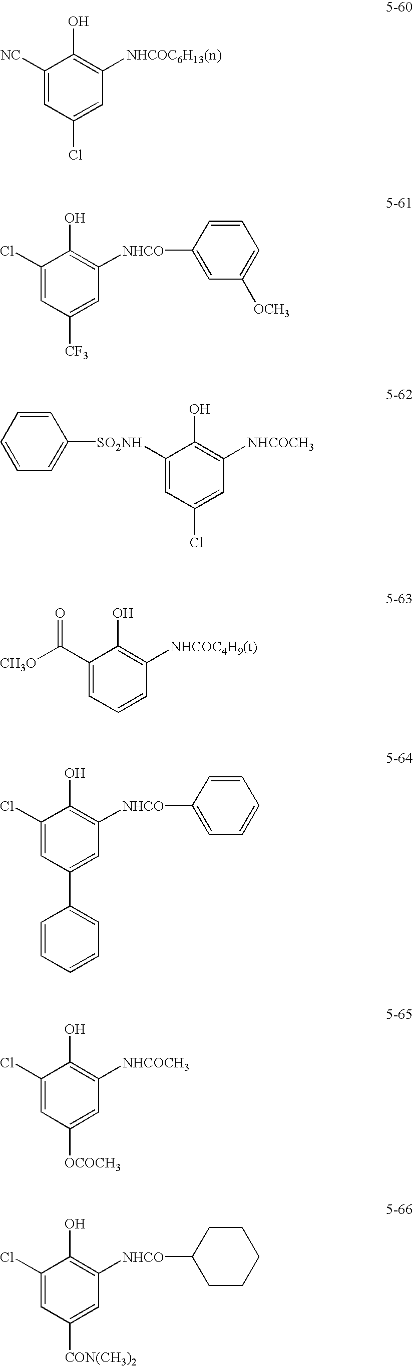

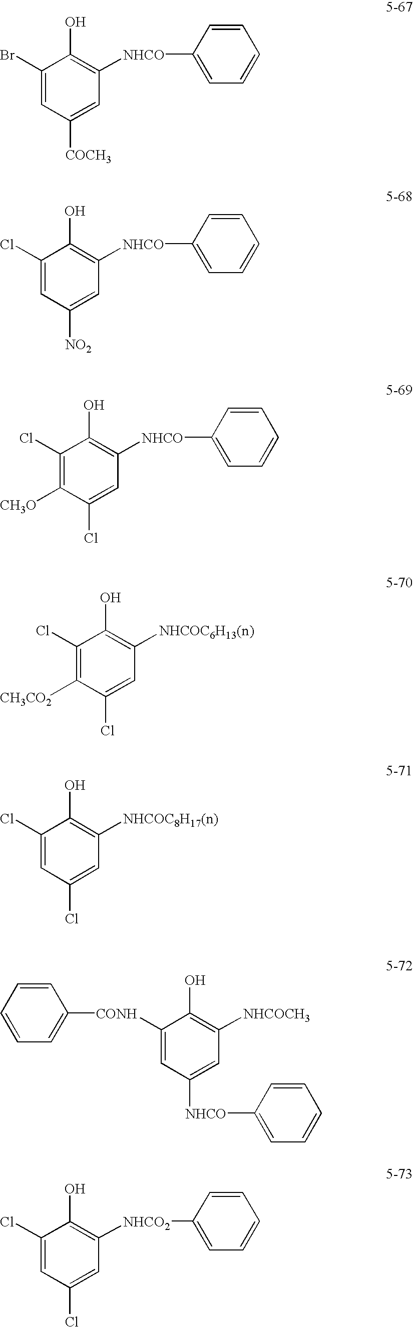

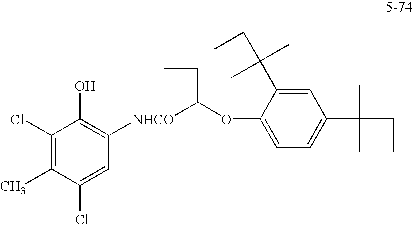

Now, the compounds represented by the general formula (6) are described.

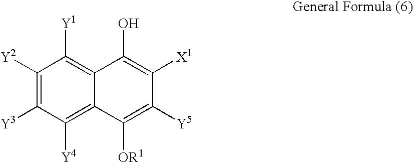

In the general formula (6), R¹ represents an alkyl group, an aryl group, an alkenyl group and an alkynyl group.

The alkyl group represented by R¹ includes a linear, branched and/or cyclic alkyl group containing preferably 1 to 30, more preferably 1 to 16 and most preferably 1 to 13 carbon atoms, for example methyl, ethyl, n-propyl, isopropyl, n-butyl, sec-butyl, t-butyl, n-hexyl, cyclohexyl, n-octyl, t-octyl, n-amyl, t-amyl, n-decyl, n-dodecyl, n-tridecyl, benzyl, phenetyl, etc.

The aryl group represented by R¹ contains preferably 6 to 30, more preferably 6 to 20 and most preferably 6 to 12 carbon atoms, and examples thereof include phenyl, 4-methyl phenyl, 2-chlorophenyl, 4-chlorophenyl, 2,4-dichlorophenyl, 3,4-dichlorophenyl, 2-methoxyphenyl, 4-methoxyphenyl, 4-hexyloxyphenyl, 2-dodecyloxyphenyl and naphthyl.

The alkenyl group represented by R¹ contains preferably 2 to 30, more preferably 2 to 20 and most preferably 2 to 12 carbon atoms, and examples thereof include a vinyl group, allyl group, isopropenyl group, butenyl group and cyclohexenyl group.

The alkynyl group represented by R¹ contains preferably 2 to 30, more preferably 2 to 20 and most preferably 2 to 12 carbon atoms, and examples thereof include an ethynyl group and a propynyl group.

In the general formula (6), R¹ may further have substituent groups, and preferable examples of such substituent groups include substituent groups represented by Y¹ to Y⁵ in the general formula (6) described later.

In the general formula (6), R¹ represents more preferably an alkyl group or aryl group, and particularly preferably an alkyl group.

In the general formula (6), X¹ represents an acyl group, an alkoxy carbonyl group, a carbamoyl group, a sulfonyl group or a sulfamoyl group.

The acyl group represented by X¹ contains preferably 2 to 20, more preferably 2 to 16 and most preferably 2 to 12 carbon atoms, and examples include acetyl, propionyl, butyryl, valeryl, hexanoyl, myristyryl, palmitoyl, stearyl, oleyl, acryloyl, cyclohexane carbonyl, benzoyl, formyl and pivaloyl.

The alkoxy carbonyl group represented by X¹ contains preferably 2 to 20, more preferably 2 to 16 and most preferably 2 to 12 carbon atoms. Examples thereof include methoxy carbonyl, ethoxy carbonyl, butoxy carbonyl and phenoxy carbonyl.

The carbamoyl group represented by X¹ contains preferably 1 to 20, more preferably 1 to 16 and most preferably 1 to 12 carbon atoms, and examples thereof include carbamoyl, N,N-diethyl carbamoyl, N-dodecyl carbamoyl, N-decyl carbamoyl, N-hexadecyl carbamoyl, N-phenyl carbamoyl, N-(2-chlorophenyl) carbamoyl, N-(4-chlorophenyl) carbamoyl, N-(2,4-dichlorophenyl) carbamoyl, N-(3,4-dichlorophenyl) carbamoyl, N-pentachlorophenyl carbamoyl, N-(2-methoxyphenyl) carbamoyl, N-(4-methoxyphenyl) carbamoyl, N-(2,4-dimethoxyphenyl) carbamoyl, N-(2-dodecyloxyphenyl) carbamoyl and N-(4-dodecyloxyphenyl) carbamoyl.

The sulfonyl group represented by X¹ contains preferably 1 to 20, more preferably 1 to 16 and most preferably 1 to 12 carbon atoms, and examples thereof include mesyl, ethane sulfonyl, cyclohexane sulfonyl, benzene sulfonyl, tosyl, and 4-chlorobenzene sulfonyl.

The sulfamoyl group represented by X¹ contains preferably 0 to 20, more preferably 0 to 16 and most preferably 0 to 12 carbon atoms, and examples thereof include sulfamoyl, methyl sulfamoyl, and dimethyl sulfamoyl.

In the general formula (6), X¹ may further have substituent groups, and preferable examples of such substituent groups include substituent groups represented by Y¹ to Y⁵ in the general formula (1) described later.

In the general formula (6), X¹ represents preferably a carbamoyl group, more preferably an alkyl carbamoyl group or aryl carbamoyl group and most preferably an aryl carbamoyl group.

In the general formula (6), Y¹ to Y⁵ independently represent a hydrogen atom or substituent group.

The substituent groups represented by Y¹ to Y⁵ may be any substituent groups not adversely affecting photographic performance. Examples of the substituent groups include a halogen atom (for example, a fluorine atom, chlorine atom, bromine atom, iodine atom), a linear, branched and/or cyclic alkyl group (containing preferably 1 to 20, more preferably 1 to 16 and most preferably 1 to 13 carbon atoms, for example methyl, ethyl, n-propyl, isopropyl, sec-butyl, t-butyl, t-octyl, n-amyl, t-amyl, n-dodecyl, n-tridecyl, cyclohexyl, etc.), an alkenyl group (containing preferably 2 to 20, more preferably 2 to 16 and most preferably 2 to 12 carbon atoms, for example vinyl, allyl, 2-butenyl, 3-pentenyl, etc.), an aryl group (containing preferably 6 to 30, more preferably 6 to 20 and most preferably 6 to 12 carbon atoms, for example phenyl, p-methyl phenyl, naphthyl, etc.), an alkoxy group (containing preferably 1 to 20, more preferably 1 to 16 and most preferably 1 to 12 carbon atoms, for example methoxy, ethoxy, propoxy, butoxy, etc.), an aryloxy group (containing preferably 6 to 30, more preferably 6 to 20 and most preferably 6 to 12 carbon atoms, for example phenyloxy, 2-naphthyloxy, etc.), an acyloxy group (containing preferably 2 to 20, more preferably 2 to 16 and most preferably 2 to 12 carbon atoms, for example acetoxy, benzoyloxy, etc.), an amino group (containing preferably 0 to 20, more preferably 1 to 16 and most preferably 1 to 12 carbon atoms, for example, a dimethyl amino group, diethyl amino group, dibutyl amino group, anilino group, etc.), an acyl amino group (containing preferably 2 to 20, more preferably 2 to 16 and most preferably 2 to 13 carbon atoms, for example acetyl amino, tridecanoyl amino, benzoyl amino, etc.), a sulfonyl amino group (containing preferably 1 to 20, more preferably 1 to 16 and most preferably 1 to 12 carbon atoms, for example methane sulfonyl amino, butane sulfonyl amino, benzene sulfonyl amino, etc.), an ureido group (containing preferably 1 to 20, more preferably 1 to 16 and most preferably 1 to 12 carbon atoms, for example ureido, methyl ureido, phenyl ureido, etc.), a carbamate group (containing preferably 2 to 20, more preferably 2 to 16 and most preferably 2 to 12 carbon atoms, for example methoxy carbonyl amino, phenyloxy carbonyl amino, etc.), a carboxyl group, a carbamoyl group (containing preferably 1 to 20, more preferably 1 to 16 and most preferably 1 to 12 carbon atoms, for example carbamoyl, N,N-diethyl carbamoyl, N-dodecyl carbamoyl, N-phenyl carbamoyl, etc.), an alkoxy carbonyl group (containing preferably 2 to 20, more preferably 2 to 16 and most preferably 2 to 12 carbon atoms, for example methoxy carbonyl, ethoxy carbonyl, butoxy carbonyl, etc.), an acyl group (containing preferably 2 to 20, more preferably 2 to 16 and most preferably 2 to 12 carbon atoms, for example acetyl, benzoyl, formyl, pivaloyl, etc.), a sulfo group, a sulfonyl group (containing preferably 1 to 20, more preferably 1 to 16 and most preferably 1 to 12 carbon atoms, for example mesyl, tosyl, etc.), a sulfamoyl group (containing preferably 0 to 20, more preferably 0 to 16 and most preferably 0 to 12 carbon atoms, for example sulfamoyl, methyl sulfamoyl, dimethyl sulfamoyl, phenyl sulfamoyl, etc.), a cyano group, a nitro group, a hydroxyl group, a mercapto group, an alkyl thio group (containing preferably 1 to 20, more preferably 1 to 16 and most preferably 1 to 12 carbon atoms, for example methyl thio, butyl thio, etc.), and a heterocyclic group (containing preferably 2 to 20, more preferably 2 to 16 and most preferably 2 to 12 carbon atoms, for example pyridyl, imidazolyl, pyrrolidyl, etc.). These substituent groups may further be substituted with other substituent groups.

Among those described above, preferable examples of the substituent groups represented by Y¹ to Y⁵ in the general formula (6) include a halogen atom, alkyl group, aryl group, alkoxy group, aryloxy group, acyloxy group, anilino group, acyl amino group, sulfonyl amino group, carboxyl group, carbamoyl group, acyl group, sulfo group, sulfonyl group, sulfamoyl group, cyano group, hydroxyl group, mercapto group, alkyl thio group, and heterocyclic group.

In a preferable combination in the general formula (6), R¹ is an alkyl group, X¹ is a carbamoyl group, and each of Y¹ to Y⁵ is a hydrogen atom.

Now, specific examples of the compounds represented by the general formula (6) are shown, but these examples are not intended to limit the invention.

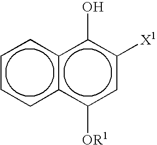

| Compound | X¹ | R¹ |
|---|---|---|
| 6-1 | —CONHC₆H₅ | —CH₃ |
| 6-2 | —CONHC₆H₅ | —C₂H₅ |
| 6-3 | —CONHC₆H₅ | —C₃H₇ |
| 6-4 | —CONHC₆H₅ | —i-C₃H₇ |
| 6-5 | —CONNC₆H₅ | —C₄H₉ |
| 6-6 | —CONHC₆H₅ | —C₅H₁₁ |
| 6-7 | —CONHC₆H₅ | —C₆H₁₃ |
| 6-8 | —CONHC₆H₅ | —C—C₆H₁₁ |
| 6-9 | —CONHC₆H₅ | —C₁₀H₂₁ |
| 6-10 | —CONHC₆H₅ | —C₁₂H₂₅ |
| 6-11 | —CONHC₆H₅ | —C₁₆H₃₃ |
| 6-12 | —CONHC₆H₅ | —CH₂C₆H₅ |
| 6-13 | —CONHC₆H₅ | —(CH₂)₂C₆H₅ |
| 6-14 | —CONHC₆H₅ | —(CH₂)₂NHSO₂CH₃ |
| 6-15 | —CONHC₆H₅ | —(CH₂)₂OCH₂CH₃ |
| 6-16 | —CONHC₆H₅ | —(CH₂)₂O(CH₂)₂OH |
| 6-17 | —CONHC₆H₅ | —(CH₂)₂OCH₂CO₂H |
| 6-18 | —CONHC₆H₅ | —C₈H₁₇ |
| 6-19 | —CONHC₆H₅ | —(CH₂)₂SO₂CH₃ |
| 6-20 | —CONHC₆H₅ | —(CH₂)₂SO₂CH₂CH₃ |
| 6-21 | —CONHC₆H₅ | —(CH₂)₂O(CH₂)₂OCH₂CH₃ |
| 6-22 | —CONHC₆H₅ | 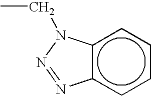 |
| 6-23 | —CONHC₆H₅ | 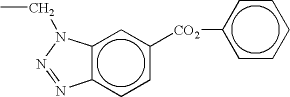 |
| 6-24 | —CONHC₆H₅ | —C₆H₅ |
| 6-25 | —CONHC₆H₅ | —p-CH₂—C₆H₄ |
| 6-26 | —CONHC₆H₅ | —p-Cl—C₆H₄ |
| 6-27 | —CONHC₆H₅ | 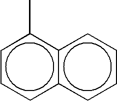 |
| 6-28 | —CONHC₆H₅ | 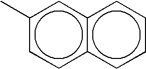 |
| 6-29 | —CONH-2-Cl—C₆H₄ | —CH₃ |
| 6-30 | —CONH-2-Cl—C₆H₄ | —C₄H₉ |
| 6-31 | —CONH-2-Cl—C₆H₄ | —C₆H₁₃ |
| 6-32 | —CONH-2-Cl—C₆H₄ | —(CH₂)₂C₆H₅ |
| 6-33 | —CONH-2-Cl—C₆H₄ | —C₁₂H₂₅ |
| 6-34 | —CONH-4-Cl—C₆H₄ | —C₄H₉ |
| 6-35 | —CONH-4-Cl—C₆H₄ | —C₆H₁₃ |
| 6-36 | —CONH-4-Cl—C₆H₄ | —C₈H₁₇ |
| 6-37 | —CONH-4-Cl—C₆H₄ | —(CH₂)₂C₆H₅ |
| 6-38 | —CONH-4-Cl—C₆H₄ | —C₁₀H₂₅ |
| 6-39 | 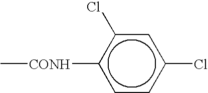 | —CH₃ |
| 6-40 | 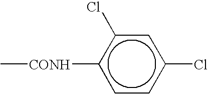 | —C₄H₉ |
| 6-41 | 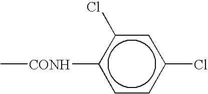 | —C₆H₁₃ |
| 6-42 | 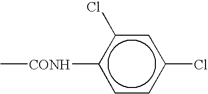 | —C₈H₁₇ |
| 6-43 | 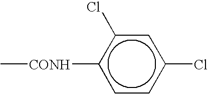 | —(CH₂)₂C₆H₅ |
| 6-44 | 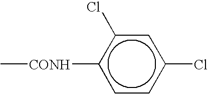 | —C₁₀H₂₁ |
| 6-45 | 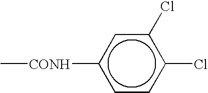 | —CH═CHCH₃ |
| 6-46 | 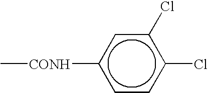 | —C₄H₉ |
| 6-47 | 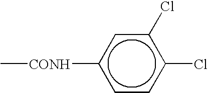 | —C₆H₁₃ |
| 6-48 | 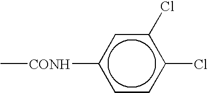 | —C≡CH |
| 6-49 | 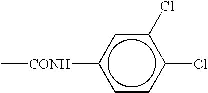 | —C₈H₁₇ |
| 6-50 | 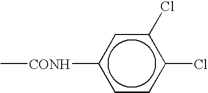 | —(CH₂)₂C₆H₅ |
| 6-51 | 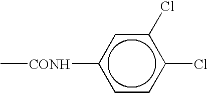 | —CH₂C₆H₅ |
| 6-52 | 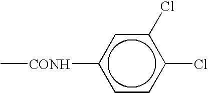 | —C₆H₅ |
| 6-53 | 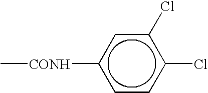 | —(CH₂)₂SO₂CH₃ |
| 6-54 | 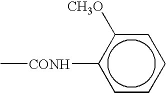 | —C₆H₁₃ |
| 6-55 | 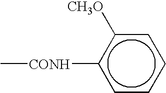 | —(CH₂)₂C₆H₅ |
| 6-56 | 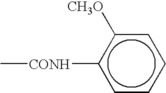 | —C₄H₉ |
| 6-57 | —CONHCH₃ | —C₆H₁₃ |
| 6-58 | —CONHC₄H₉ | —C₆H₁₃ |
| 6-59 | —CONHC₆H₁₃ | —C₆H₁₃ |
| 6-60 | —CONHC₁₀H₂₁ | —C₆H₁₃ |
| 6-61 | —CONHC₁₂H₂₅ | —C₆H₁₃ |
| 6-62 | —CONHC₁₆H₃₃ | —C₆H₁₃ |
| 6-63 | 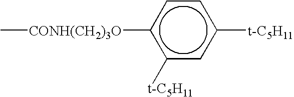 | —C₆H₁₃ |
| 6-64 | —CONH(CH₂)₃OC₁₂H₂₅ | —C₆H₁₃ |
| 6-65 | 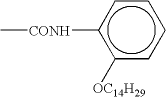 | —C₆H₁₃ |
| 6-66 | —CONHCH₂C₆H₅ | —C₆H₁₃ |
| 6-67 | 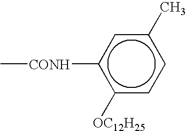 | —C₆H₁₃ |
| 6-68 | 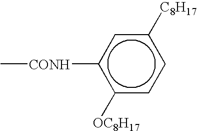 | —C₆H₁₃ |
| 6-69 | —CONH-t-C₄H₉ | —C₆H₁₃ |
| 6-70 | —CONH-t-C₈H₁₇ | —C₆H₁₃ |
| 6-71 | —CON(C₂H₅)₂ | —C₆H₁₃ |
| 6-72 | 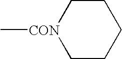 | —C₆H₁₃ |
| 6-73 | 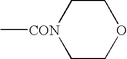 | —C₆H₁₃ |
| 6-74 | 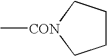 | —C₆H₁₃ |
| 6-75 | —CONHC₄H₉ | —(CH₂)₂C₆H₅ |
| 6-76 | —CONHC₁₀H₂₁ | —(CH₂)₂C₆H₅ |
| 6-77 | —CONHC₁₂H₂₅ | —(CH₂)₂C₆H₅ |
| 6-78 | —CONH-t-C₄H₉ | —(CH₂)₂C₆H₅ |
| 6-79 | —CONH-t-C₈H₁₇ | —(CH₂)₂C₆H₅ |
| 6-80 | —CONHCH₃ | —(CH₂)₂C₆H₅ |
| 6-81 | 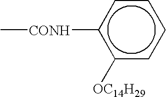 | —(CH₂)₂C₆H₅ |
| 6-82 | —CON(C₂H₅)₂ | —(CH₂)₂C₆H₅ |
| 6-83 | 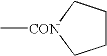 | —(CH₂)₂C₆H₅ |
| 6-84 | —CONHCH₂C₆H₅ | —(CH₂)₂C₆H₅ |
| 6-85 | 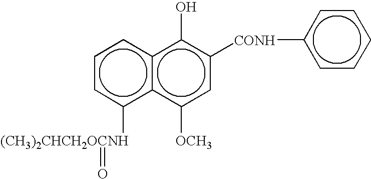 | |
| 6-86 | 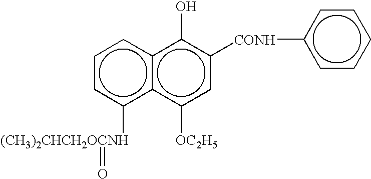 | |
| 6-87 | 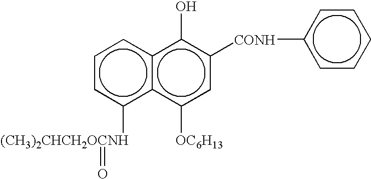 | |
| 6-88 | 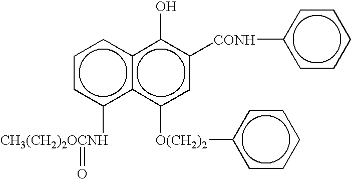 | |
| 6-89 | —COCH₃ | —C₆H₁₃ |
| 6-90 | —COC₂H₅ | —C₆H₁₃ |
| 6-91 | —COC₇H₁₅ | —C₆H₁₃ |
| 6-92 | —COC₁₁H₂₃ | —C₆H₁₃ |
| 6-93 | —COCH₃ | —(CH₂)₂C₆H₅ |
| 6-94 | —COC₂H₅ | —(CH₂)₂C₆H₅ |
| 6-95 | —COC₇H₁₅ | —(CH₂)₂C₆H₅ |
| 6-96 | —COC₁₁H₂₃ | —(CH₂)₂C₆H₅ |
| 6-97 | —COCH₃ | —CH₃ |
| 6-96 | —COCH₃ | —C₄H₉ |
| 6-99 | —COCH₃ | —C₆H₅ |
| 6-100 | —COCH₃ | —CH₂C₆H₅ |
| 6-101 | —COCH₃ | —C₁₀H₂₁ |
| 6-102 | —COCH₃ | —C₁₂H₂₅ |
| 6-103 | —COCH₃ | —C₁₆H₃₃ |
| 6-104 | —CO₂C₆H₅ | —C₆H₅ |
| 6-105 | —CO₂C₆H₅ | —CH₃ |
| 6-106 | —CO₂C₆H₅ | —C₂H₅ |
| 6-107 | —CO₂C₆H₅ | —C₄H₉ |
| 6-108 | —CO₂C₆H₅ | —C₆H₁₃ |
| 6-109 | —CO₂C₆H₅ | —C₁₀H₂₁ |
| 6-110 | —CO₂C₆H₅ | —CH₂C₆H₅ |
| 6-111 | —CO₂C₆H₅ | —(CH₂)₂C₆H₅ |
| 6-112 | —CO₂C₆H₅ | —C₁₂H₂₅ |
| 6-113 | —CO₂C₆H₅ | —C₁₆H₃₃ |
| 6-114 | —CO₂C₆H₅ | —(CH₂)₂SO₂CH₃ |
| 6-115 | —CO₂C₆H₅ | —(CH₂)₂SO₂NHCH₃ |
| 6-116 | —CO₂C₆H₅ | —(CH₂)₂NHSO₂C₂H₅ |
| 6-117 | —CO₂CH₃ | —CH₃ |
| 6-118 | —CO₂CH₃ | —C₄H₉ |
| 6-119 | —CO₂C₂H₅ | —C₆H₁₃ |
| 6-120 | —CO₂C₂H₅ | —(CH₂)₂C₆H₅ |
| 6-121 | —CO₂C₂H₅ | —C₁₂H₂₅ |
| 6-122 | —CO₂C₁₂H₂₅ | —CH₃ |
| 6-123 | —CO₂C₁₂H₂₅ | —C₄H₉ |
| 6-124 | —CO₂C₁₂H₂₅ | —C₆H₁₃ |
| 6-125 | —CO₂C₁₂H₂₅ | —(CH₂)₂C₆H₅ |
| 6-126 | —CO₂C₁₂H₂₅ | —(CH₂)₂SO₂CH₃ |
| 6-127 | —CO₂C₁₂H₂₅ | —CH═CHCH₃ |
| 6-128 | —CO₂C₁₂H₂₅ | —CH₂CH═CH₂ |
| 6-129 | —CO₂C₁₂H₂₅ | —C≡CCH₃ |
| 6-130 | —CO₂C₁₂H₂₅ | —C—C₆H₁₁ |
| 6-131 | —CO₂C₁₂H₂₅ | —C₆H₅ |
| 6-132 | —SO₂CH₃ | —C₄H₉ |
| 6-133 | —SO₂CH₃ | —C₆H₁₃ |
| 6-134 | —SO₂CH₃ | —C₆H₅ |
| 6-135 | —SO₂CH₃ | —CH₃ |
| 6-136 | —SO₂CH₃ | —(CH₂)₂C₆H₅ |
| 6-137 | —SO₂CH₃ | —CH₂C₆H₅ |
| 6-138 | —SO₂C₆H₅ | —C₄H₉ |
| 6-139 | —SO₂C₆H₅ | —C₆H₁₃ |
| 6-140 | —SO₂C₆H₅ | —CH₃ |
| 6-141 | —SO₂C₆H₅ | —(CH₂)₂C₆H₅ |
| 6-142 | —SO₂C₆H₅ | —C₁₂H₂₅ |
| 6-143 | —SO₂NHC₆H₅ | —C₆H₅ |
| 6-144 | —SO₂NHCH₃ | —C₆H₅ |
| 6-145 | —SO₂NHC₂H₅ | —C₆H₅ |
| 6-146 | —SO₂NHC₆H₁₃ | —C₆H₅ |
| 6-147 | —SO₂NHC₄H₉ | —C₆H₅ |
| 6-148 | —SO₂NH-t-C₄H₉ | —C₆H₅ |
| 6-149 | —SO₂NH-t-C₈H₁₇ | —C₆H₅ |
| 6-150 | —SO₂NHC₆H₅ | —C₆H₁₃ |
| 6-151 | —SO₂NHCH₃ | —C₆H₁₃ |
| 6-152 | —SO₂NHC₂H₅ | —C₆H₁₃ |
| 6-153 | —SO₂NHC₄H₉ | —C₆H₁₃ |
| 6-154 | —SO₂NH-t-C₄H₉ | —C₆H₁₃ |
| 6-155 | —SO₂NH-t-C₈H₁₇ | —C₆H₁₃ |
| 6-156 | —SO₂NHC₆H₁₃ | —(CH₂)₂C₆H₅ |
| 6-157 | —SO₂NHC₆H₅ | —(CH₂)₂C₆H₅ |
| 6-158 | —SO₂NHCH₃ | —(CH₂)₂C₆H₅ |
| 6-159 | —SO₂NH-t-C₈H₁₇ | —(CH₂)₂C₆H₅ |

The compounds represented by the general formulae (3) to (6) (including (P) and (Q)) can be easily synthesized by a method known in photographic industry. Specifically, synthesis of e.g. the compounds (reducing compounds) represented by the general formula (3) can be carried out by methods described in JP-A Nos. 9-152702, 8-286340, 9-152700, 9-152701, 9-152703 and 9-152704. Further, the compounds represented by the general formula (5) can be easily synthesized by a method of synthesizing phenol couplers known in photographic industry, for example by reacting o-aminophenols with acid halides.

The development accelerator (compounds represented by the general formulae (3) to (6) (including (P) and (Q)) can be used by dissolving it in, for example, alcohols (methanol, ethanol, propanol, and fluorinated alcohols), ketones (acetone and methyl ethyl ketone), dimethylformamide, dimethyl sulfoxide or methyl cellosolve. Alternatively, the development accelerator can be used by dissolving it in oil such as dibutyl phthalate, tricresyl phosphate, glyceryl triacetate and diethyl phthalate or in a co-solvent such as ethyl acetate and cyclohexanone by a well-known emulsification dispersion method to prepare an emulsified dispersion mechanically. Alternatively, the development accelerator can also be used by dispersing the powders of the compound in water by a ball mill, colloid mill, sand grinder mill, Manton gohlin [phonetic], micro-fluidizer or sonication.

The development accelerator (compounds represented by the general formulae (3) to (6) (including (P) and (Q)) may be added to any layers at the side of the layer containing a photosensitive silver halide and a reducible silver salt on the support, preferably to the layer containing a silver halide or its adjacent layers.

The amount of the development accelerator added (compounds represented by the general formulae (3) to (6) (including (P) and (Q)) is preferably 0.2 to 200 mmol, more preferably 0.3 to 100 mmol and most preferably 0.5 to 30 mmol per mol of silver. The compounds represented by the general formulae (3) to (6) (including (P) and (Q)) may be used singly or in combination thereof.

Hereinafter, the non-photosensitive organic silver salt (also referred to hereinafter as organic silver salt) will be described.

The organic silver salt is a silver salt that is relatively stable to light and forms a silver image upon heating at 80° C. or more in the presence of a light-exposed photocatalyst (latent image of a photosensitive silver halide) and a reducing agent. The organic silver salt is any organic substance containing a source capable of reducing silver ions, and contains preferably 40 mol % or more, more preferably 50 mol % or more and most preferably 50 to 95 mol % silver behenate. Other silver salts of organic acids are particularly preferably silver salts of C₁₀₋₃₀, preferably C₁₅₋₂₈, long-chain aliphatic carboxylic acids. Complexes of organic or inorganic silver salts a ligand of which has a complex stability constant ranging from 4.0 to 10.0 are also preferable. Such non-photosensitive organic silver salts are described in columns 0048 to 0049 in JP-A No. 10-62899, page 18, line 24 to page 19, to line 37 in European Patent Publication No. 0808764A1, European Patent Publication No. 0962812A1, JP-A Nos. 11-349591, 2000-7683 and 2000-72711. Preferable examples of the organic silver salts include silver salts of organic compounds having a carboxyl group. These examples include, but are not limited to, silver salts of aliphatic carboxylic acids and silver salts of aromatic carboxylic acids. Preferable examples of the silver salts of aliphatic carboxylic acids include not only the above-described silver behenate, but also silver stearate, silver oleate, silver laurate, silver caproate, silver myristate, silver palmitate, silver maleate, silver fumarate, silver tartrate, silver linoleate, silver butyrate, and camphoric acid tablets, as well as mixtures thereof. The organic silver salt as a source of silver can constitute about 5 to 30% by weight of the image forming layer.

The shape of the organic silver salt is not particularly limited, but needle crystals having minor and major axes are preferable. In the field of silver halide photographic photosensitive material it is well known that the size of silver salt crystal particles is in inversely proportional to the covering power thereof. This relationship also applies to the heat developing photosensitive material of the invention; that is, when the organic silver salt particles as the image forming part of the heat developing photosensitive material are large, the covering power is low, thus lowering image density. Accordingly, the size of the organic silver salt is preferably smaller. In the invention, preferably the minor axis is 0.01 to 0.20 μm and the major axis is 0.10 to 5.0 μm, and more preferably the minor axis is 0.01 to 0.15 μm and the major axis is 0.10 to 4.0 μm. The distribution of particle sizes of the organic silver salt is preferably monodisperse. In monodispersion, the percentage obtained by dividing the standard deviation of the length of the minor or major axis by the minor or major axis is preferably 100% or less, more preferably 80% or less and most preferably 50% or less. The shape of the organic silver salt can be determined from an image of a dispersion of the organic silver salt under a transmission electron microscope. As an alternative method of measuring monodispersibility, there is a method of determining the standard deviation of the volume load average diameter of the organic silver salt, and the percentage (coefficient of variation) obtained by dividing the standard deviation by the volume load average diameter is preferably 100% or less, more preferably 80% or less and most preferably 50% or less. For this measurement, the organic silver salt dispersed in liquid is irradiated with a laser light, whereby the self-correlation coefficient of the scattered light with time is determined, and from the result, the particle size (volume load average diameter) can be determined to evaluate its monodispersibility.

The organic silver salt is prepared by forming particles thereof in a water solvent, then drying the particles, and dispersing them in a solvent such as MEK (Methyl ethyl ketone). Drying is conducted preferably at an oxygen partial pressure of from 0.01 to 15 vol %, and more preferably from 0.01 to 10 vol %, in a stream-type flash jet dryer.

The organic silver salt can be used in a desired amount, but the amount of silver applied is preferably 0.1 to 5 g/m², and more preferably 1 to 3 g/m².

Hereinafter, the photosensitive silver halide (also referred to hereinafter as silver halide) is described.

The method of forming the photosensitive silver halide is well known in the art, and for example a method described in Research Disclosure No. 17029 (June 1978) and U.S. Pat. No. 3,700,458 can be used. The specific method that can be used in the method includes a method of adding a halogen-containing compound to a prepared organic silver salt thereby converting a part of silver in the organic silver salt into a photosensitive silver halide and a method of adding a silver-donating compound and a halogen-donating compound to gelatin or to a solution of another polymer, thereby preparing a photosensitive silver halide particles which are then mixed with an organic silver salt. In the invention, the latter method can be preferably used. The particle size of the photosensitive silver halide is preferably smaller for the purpose of suppressing cloudiness after formation of images, and specifically the particle size is preferably 0.0001 to 15 μm, and more preferably 0.02 to 0.10 μm. If the particle size of the silver halide is too small, the sensitivity is insufficient, while if the particle size is too large, there can be a problem that the haze of the photosensitive material is increased. As used herein, the “particle size” refers to the length of the edge of the halide silver particle when the particle is a normal crystal such as cubic or octahedral crystal. When the silver halide particle is a plate crystal, the particle size thereof refers to the diameter of a circular image having the same area as in a projected area of the major surface thereof. When the particle is for example a spherical or bar particle other than normal crystal, the particle size thereof refers to the diameter of a sphere having the same volume as that of the silver halide particle.

The shape of the photosensitive silver halide particles includes cubic, octahedral, plate, spherical, bar, and potato shapes (potato shaped particles herein refers to particles having a roughly spherical shape and an uneven surface), among which cubic particles and plate particles are particularly preferable in the invention. When the plate silver halide particles are used, the average aspect ratio is preferably from 100:1 to 2:1, and more preferably from 50:1 to 3:1. Further, silver halide particles having round corners can also be preferably used. The surface index (mirror index) of the outer surface of the photographic silver halide particle is not particularly limited, but the ratio of the [100] surface having high spectral sensitization efficiency upon adsorption of a spectral sensitizing dye is preferably high. The ratio thereof is preferably 50% or more, more preferably 65% or more, and most preferably 80% or more. The ratio of the mirror index [100] surface can be determined by a method described by T. Tani in J. Imaging Sci., 29, 165 (1985) by utilizing the dependence of adsorption of a sensitizing dye between the [111] surface and [100] surface. The halogen composition of the photosensitive silver halide is not particularly limited, and the silver halide may be silver chloride, silver chlobromide, silver bromide, silver iodobromide, silver iodochlobromide, and silver iodide, among which silver bromide or silver iodobromide can be used preferably in the invention. The silver halide is particularly preferably silver iodobromide, and the content of silver iodide is preferably 0.1 to 40 mol %, more preferably 0.1 to 20 mol %. The distribution of the halogen in the particles may be uniform, or the halogen therein may be varied stepwise or continuously, and in a preferable example, silver iodobromide having a high content of silver iodide in the particles can be used. Silver halide particles having a core/shell structure can be preferably used. Core/shell particles having preferably a 2- to 5-layered structure, and more preferably a 2 to 4-layered structure can be used.

The photosensitive silver halide particles preferably contain at least one complex of a metal selected from rhodium, rhenium, ruthenium, osmium, iridium, cobalt, mercury and iron. These metal complexes may be used singly, or two or more complexes of the same metal or different metals may be used in combination. The content is preferably in the range of from 1 nmol to 10 mmol, more preferably in the range of from 10 nmol to 100 μmol, per mol of silver. Specifically, a metal complex having a structure described in JP-A No. 7-225449 can be preferably used. As a cobalt or iron compound, a hexacyanometal complex can be preferably used. Specific examples thereof include, but are not limited to, ferricyanate ions, ferrocyanate ions and hexacyanocobalt acid ions. A metal complex-containing phase in silver halide may be uniform or contained at high concentration in the core or in the shell.

The photosensitive silver halide particles can be desalted by washing with water by a method known in the art, such as a noodle method, a flocculation method, etc., but desalting may not be conducted in the invention.

The photosensitive silver halide particles have been preferably chemically sensitized. As the chemical sensitizing method, a sulfur-sensitizing method, a selenium-sensitizing method or a tellurium-sensitizing method can be used as is well known in the art. Further, a method of sensitization with noble metals such as gold compound, platinum, palladium or iridium compound or a reducing sensitization method can be used. The compounds used preferably in the sulfur-sensitizing method, selenium-sensitizing method and tellurium-sensitizing method may be compounds known in the art, particularly compounds described in JP-A No. 7-128768.

The photosensitive silver halide is used in an amount of preferably 0.01 to 0.5 mol, more preferably 0.02 to 0.3 mol and most preferably 0.03 to 0.25 mol, per mol of the organic silver salt. With respect to the method and conditions for mixing the photosensitive silver halide with the organic silver salt, both of which were separately prepared, there is a method in which the silver halide particles and the organic silver salt, which were separately prepared, are mixed by a high-speed stirrer, a ball mill, a sand mill, a colloid mill, a vibration mill or a homogenizer or a method of mixing the previously prepared photosensitive silver halide with the organic silver salt which is being prepared, but there is no particular limitation insofar as the effect of the invention is sufficiently achieved.

A preferable method of preparing the photosensitive silver halide includes the so-called “halidation” method of halogenating a part of silver in an organic silver salt with an organic or inorganic halide. The organic halide used herein may be any organic halides which react with an organic silver salt to form silver halide, and examples thereof include N-halogenoimides (N-bromosuccinimide, etc.), halogenated quaternary nitrogen compounds (tetrabutyl ammonium bromide, etc.), aggregates of a halogenated quaternary nitrogen salt with a halogen molecule (pyridinium perbromide bromide), etc. The inorganic halide may be any inorganic halides which react, with an organic silver salt to form silver halide, and examples thereof include a halogenated alkali metal or ammonium (sodium chloride, lithium bromide, potassium bromide, ammonium bromide, etc.), a halogenated alkaline earth metal (calcium bromide, magnesium chloride, etc.), a halogenated transition metal (ferric chloride, cupric bromide, etc.), a metal complex having a halogen ligand (sodium bromoiridate, ammonium chlororhodiumate, etc.) and a halogen atom (bromine, chlorine, iodine). Further, desired organic or inorganic halides may also be used in combination. The amount of the halide added for halidation is preferably 1 to 500 mmol, more preferably 10 to 250 mmol in terms of halogen atom per mol of the organic silver salt.

The sensitizing dye, which can be applied to the photosensitive silver halide, is the one which upon adsorption of silver halide particles, can spectrally sensitize the silver halide particles in a desired wavelength range, and the sensitizing dye which can be advantageously selected is the one having spectral sensitivity suitable for the spectral characteristics of a light source for light exposure. The sensitizing dye and the method of adding the same are described in columns 0103 to 0109 in JP-A No. 11-65021, Moreover, compounds represented by the general formula (II) in JP-A No. 10-186572, dyes represented by the general formula (I) and in column 0106 in JP-A No. 11-119374, dyes described in U.S. Pat. No. 5,510,236, U.S. Pat. No. 5,541,054 and in Example 5 in U.S. Pat. No. 3,871,887, dyes disclosed in JP-A Nos. 2-96131 and 59-48753, and those described on page 19, line 38 to page 20, line 35 in European Patent Publication No. 0803764A1, and Japanese Patent Application Nos. 2000-86865 and 2000-102560 may also be used. These sensitizing dyes may be used solely or in combination thereof. The sensitizing dye added in the invention can be added in an amount desired depending on sensitivity and fogging, but the amount thereof is preferably 10⁻⁶ to 1 mol, more preferably 10⁻⁴ to 10⁻¹ mol, per mol of silver halide in the photosensitive layer. A combination of photosensitive dyes is sometimes used particularly for the purpose of stronger color and higher sensitization. Along with the sensitizing dye, a dye not having a spectral sensitizing action or a substance exhibiting stronger color and higher sensitization but not substantially absorbing visible rays may be contained in the emulsion. Useful sensitizing dyes, a combination of dyes for exhibiting stronger color and higher sensitization, and substances exhibiting stronger color and higher sensitization are described in Item J in IV on page 23 in Research Disclosure, Vol. 176, 17643 (published in December 1978), or JP-B Nos. 49-25500, 43-4933, JP-A Nos. 59-19032 and 59-192242.

Now, the binder will be described.

The binder used may be an arbitrary natural or synthetic resin selected from for example gelatin, polyvinyl butyrate, polyvinyl acetal, polyvinyl chloride, polyvinyl acetate, cellulose acetate, polyolefin, polyester, polystyrene, polyacrylonitrile, polycarbonate, polyvinyl butyral, butyl ethyl cellulose, methacrylate copolymer, anhydrous maleate copolymer, polystyrene and butadiene-styrene copolymer. Preferably, polyvinyl butyral is used as the binder in an amount of at least 50% by weight of the entire binder composition. As a matter of course, copolymers and terpolymers are contained in the binder. The total weight of polyvinyl butyral as the binder is preferably 50 to 100% by weight, more preferably 70 to 100% by weight. The Tg of the binder is preferably in the range of 40 to 90° C., more preferably 50 to 80° C. “Tg” refers to a glass transition temperature.

The binder is used in an amount sufficient to maintain, for example, a component in the photosensitive layer in its layer. That is, the binder is used in such a range as to function effectively. The effective range can be suitably determined by those skilled in the art. For maintaining at least the organic silver salt, the binder:organic silver salt ratio by weight is in the range of 15:1 to 1:3, particularly preferably 8:1 to 1:2.

Now, the support will be described.

Examples of the support include polyester film, primed polyester film, poly(ethylene terephthalate) film, polyethylene naphthalate film, nitrate cellulose film, cellulose ester film, poly(vinyl acetal) film, polycarbonate film and related or resinous material, as well as glass, paper, and metal. Flexible support, particularly partially acetylated or baryta and/or α-olefin polymer, particularly polyethylene, polypropylene, as well as paper support coated with a C₂₋₁₀ α-olefin polymer such as ethylene-butene copolymer can also be used. The support may be transparent or opaque, and is preferably transparent.

Now, other preferable additives, the layer structure of the photosensitive material, etc. will be described.

The heat developing photosensitive material of the invention can contain a hydrogen-bonding compound. Like the reducing agent, the hydrogen-binding compound can be contained in the photosensitive material by containing it in a coating solution in a form such as a solution, an emulsified dispersion or a dispersion of fine particles. The hydrogen-bonding compound forms a hydrogen-bonding complex with a compound having a phenolic hydroxyl group or amino group in the form of a solution, so the hydrogen-bonding compound can be isolated as a complex in a crystalline state, depending on a combination with the reducing agent. The complex crystal powder thus isolated is used preferably as a dispersion of solid fine particles, in order to achieve stable performance. Further, it is also preferable to employ a method in which the reducing agent is mixed with the hydrogen-bonding compound in a powdery form and dispersed with a suitable dispersant in e.g. a sand grinder mill to form a complex.

The hydrogen-bonding compound is used in an amount of preferably 1 to 200 mol %, more preferably 10 to 150 mol % and most preferably 30 to 100 mol % relative to the reducing agent.

The hydrogen-bonding compound is preferably a compound represented by the following general formula (7).

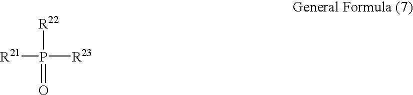

In the general formula (7), each of R²¹, R²² and R²³ independently represents an alkyl group, an aryl group, an alkoxy group, an aryloxy group, an amino group or a heterocyclic group, and these groups may or may not be substituted, and arbitrary two of R²¹, R²² and R²³ may form a ring.

When R²¹, R²² and R²³ are substituted with substituent groups, examples of the substituent groups include a halogen atom, alkyl group, aryl group, alkoxy group, amino group, acyl group, acyl amino group, alkyl thio group, aryl thio group, sulfonamide group, acyloxy group, oxycarbonyl group, carbamoyl group, sulfamoyl group, sulfonyl group and phosphoryl group, preferably an alkyl group and aryl group which are specifically a methyl group, ethyl group, isopropyl group, t-butyl group, t-octyl group, phenyl group, 4-alkoxyphenyl group and 4-acyloxyphenyl group.

Examples of the groups represented by R²¹, R²² and R²³ in the general formula (7) include substituted or unsubstituted alkyl groups such as a methyl group, ethyl group, butyl group, octyl group, dodecyl group, isopropyl group, t-butyl group, t-amyl group, t-octyl group, cyclohexyl group, 1-methyl cyclohexyl group, benzyl group, phenetyl group and 2-phenoxy propyl group; substituted or unsubstituted aryl groups such as a phenyl group, cresyl group, xylyl group naphthyl group, 4-t-butyl phenyl group, 4-t-octyl phenyl group, 4-anisidyl group and 3,5-dichlorophenyl group; substituted or unsubstituted alkoxyl groups such as a methoxy group, ethoxy group, butoxy group, octyloxy group, 2-ethylhexyloxy group, 3,5,5-trimethylhexyloxy group, dodecyloxy group, cyclohexyloxy group, 4-methylcylohexyloxy group and benzyloxy group; substituted or unsubstituted aryloxy groups such as phenoxy group, cresyloxy group, isopropyl phenoxy group, 4-t-butyl phenoxy group, naphthoxy group and biphenyloxy group; substituted or unsubstituted amino groups such as an amino group, dimethyl amino group, diethyl amino group, dibutyl amino group, dioctyl amino group, N-methyl-N-hexyl amino group, dicyclohexyl amino group, diphenyl amino group, N-methyl-N-phenyl amino group; and heterocyclic groups such as a 2-pyridyl group, 4-pyridyl group, 2-furanyl group, 4-piperidinyl group, 8-quinolyl group and 5-quinolyl group.

In the general formula (7), each of R²¹, R²² and R²³ is preferably an alkyl group, an aryl group, an alkoxy group or an aryloxy group. In respect of the effect of the invention, at least one of R²¹, R²² and R²³ is more preferably an alkyl group or an aryl group. For obtaining the desired compound easily and inexpensively, R²¹, R²² and R²³ are preferably the same kind of group.

The heat developing photosensitive material of the invention preferably contains a coloring agent. The coloring agent is described in columns 0054 to 0055 in JP-A No. 10-62899, on page 1, lines 23 to 48 in European Patent Publication No. 0803764A1, and in Japanese Patent Application No. 10-213487, and particularly preferable examples include phthalazinones, phthalazine, phthalazinone derivatives or metal salts; more preferable examples include 4-(1-naphthyl phthalazinone, 6-chlorophthalazinone 5,7-dimethoxyphthalazinone and 2,3-dihydro-1,4-phthalazine dion); a combination of phthaladinones, phthalic acid and analogues thereof (for example, phthalic acid, 4-methyl phthalic acid, 4-nitro-phthalic acid and tetrachlorophthalic anhydride); phthalazines (phthalazine, phthalazine derivative or metal salts; for example 4-(1-naphthyl) phthalazine, 6-isopropyl phthalazine, 6-t-butyl phthalazine, 6-chlorophthalazine, 5,7-dimethoxy phthalazine and 2,3-dihydrophthalazine); a combination of phthalazines, phthalic acid and analogues thereof; and particularly preferable examples include a combination of phthalazines, phthalic acid and analogues thereof. The coloring agent is contained in an amount of preferably 0.1 to 50 mol %, more preferably 0.5 to 20 mol %, per mol of silver in the surface having the image forming layer.

In the heat developing photosensitive material of the invention, the silver halide emulsion and/or the organic silver salt can further be protected against additional fogging by an anti-fogging agent, a stabilizer and a stabilizer precursor, thus achieving stabilization against a reduction in sensitivity during storage. A suitable anti-fogging agent, a stabilizer and a stabilizer precursor which can be used singly or in combination include thiazonium salts described in U.S. Pat. Nos. 2,131,038 and 2,694,716, azaindene described in U.S. Pat. Nos. 2,886,487 and 2,444,605, compounds described in JP-A No. 9-329865 and U.S. Pat. No. 6,083,681, mercury salts described in U.S. Pat. No. 2,728,663, urazol described in U.S. Pat. No. 3,287,135, sulfocatechol described in U.S. Pat. No. 3,235,652, oxime, nitron and nitroingzole described in GB Patent No. 623,448, polyvalent metal salts described in U.S. Pat. No. 2,839,405, thiuronium salts described in U.S. Pat. No. 3,220,839, palladium, platinum and gold salt described in U.S. Pat. Nos. 2,566,263 and 2,597,915, halogen-substituted organic compounds described in U.S. Pat. Nos. 4,108,665 and 4,442,202, triazine described in U.S. Pat. Nos. 4,128,557, 4,137,079, 4,138,365 and 4,459,350, and phosphorus compounds described in U.S. Pat. No. 4,411,985.

The anti-fogging agent is preferably an organic halide, particularly a polyhalomethyl compound, and more preferably a trihalomethyl sulfone compound. The organic halide includes compounds described in JP-A Nos. 50-119624, 50-120328, 51-121332, 54-58022, 56-70543, 56-99335, 59-90842, 61-129642, 62-129845, 6-208191, 7-5621, 7-2781, 8-15809, 9-160167, 9-244177, 9-244178, 9-258367, 9-265150, 9-319022, 10-171063, 11-212211, 11-231460, 11-242304, U.S. Pat. No. 5,340,712, U.S. Pat. No. 5,369,000, and U.S. Pat. No. 5,464,737, and specific examples include 2-(tribromomethyl sulfone) quinoline, 2-(tribromomethyl sulfone) pyridine, tribromomethyl phenyl sulfone and tribromomethyl naphthyl sulfone.

In the heat developing photosensitive material of the invention, addition of mercury (II) salt as an anti-fogging agent to the photosensitive layer may be often advantageous. The mercury (II) salts preferable for this purpose are mercury acetates and mercury bromides. The amount of mercury used in the invention is in the range of preferably 1 nmol to 1 mmol, more preferably 10 nmol to 100 μmol, per 1 mol of silver applied.

The heat developing photosensitive material of the invention may contain benzoic acids for the purpose of higher sensitization and prevention of fogging. The benzoic acids used may be any benzoic acid derivatives, and those having a preferable structure include e.g. compounds described in U.S. Pat. No. 4,784,939, U.S. Pat. No. 4,152,160, JP-A Nos. 9-281687, 9-329864 and 9-329865. The benzoic acids used in the invention may be added to any site of the photosensitive material, but are added preferably to the layer having the photosensitive layer, more preferably to the organic silver salt-containing layer. The benzoic acids may be added at any stages of preparing the coating solution, and when the benzoic acids are added to the organic silver salt-containing layer, they may be added at any stage from preparation of the organic silver salt to preparation of the coating solution, but are added preferably at a stage after preparation of the organic silver salt and just before application of the coating solution. The benzoic acids may be added in any form such as powder, a solution and a dispersion of fine particles. Further, the benzoic acids may be added as a solution of a mixture with other additives such as a sensitizing dye, a reducing agent and a coloring agent. The amount of the benzoic acids added is not particularly limited, but is preferably from 1 μmol to 2 mol, more preferably from 1 mmol to 0.5 mol, per mol of silver.

The heat developing photosensitive material of the invention can contain a mercapto compound, disulfide compound and thion compound in order to regulate development by inhibiting or accelerating development, to improve spectral sensitization efficiency and to improve shelf stability before and after development. The mercapto compound may have any structure, but preferably used are mercapto compounds represented by Ar—SM or Ar—S—S—Ar in which M is a hydrogen atom or an alkali metal atom, Ar is an aromatic ring or a condensed aromatic ring having at least one nitrogen, sulfur, oxygen, selenium or tellurium atom. The heteroaromatic ring is preferably a benzimidazole, a naphthimidazole, a benzothiazole, a naphthothiazole, a benzoxazole, a naphthoxazole, a benzoselenazole, a benzotetrazole, an imidazole, an oxazole, a pyrazol, a triazole, a thiadiazole, a tetrazole, a triazine, a pyrimidine, a pyridazine, a pyrazine, a pyridine, a purine, a quinoline or a qunazolinone. This heteroaromatic ring may have a substituent group selected from the group consisting of e.g. a halogen (for example, Br and Cl), hydroxy, amino, carboxy, alkyl (containing e.g. one or more carbon atoms, preferably 1 to 4 carbon atoms) and alkoxy (containing e.g. one or more carbon atoms, and preferably from 1 to 4 carbon atoms). In the invention, examples of the mercapto-substituted heteroaromatic compound include, but are not limited to, 2-mercaptobenzimidazole, 2-mercaptobenzoxazole, 2-mercaptobenzothiazole, 2-mercapto-5-methyl benzimidazole, 6-ethoxy-2-mercaptobenzothiazole, 2,2′-dithiobis-(benzothiazole, 3-mercapto-1,2,4-triazole, 4,5-diphenyl-2-imidazole thiol, 2-mercaptoimidazole, 1-ethyl-2-mercaptobenzimidazole, 2-mercaptoquinoline, 8-mercaptopurine, 2-mercapto-4(3H)-quinazolinone, 7-trifluoromethyl-4-quinoline thiol, 2,3,5,6-tetrachloro-4-pyridine thiol, 4-amino-6-hydroxy-2-mercaptopyrimidine monohydrate, 2-amino-5-mercapto-1,3,4-thiadiazole, 3-amino-5-mercapto-1,2,4-triazole, 4-hydroxy-2-mercaptopyrimidine, 2-mercaptopyrimidine, 4,6-diamino-2-mercaptopyrimidine, 2-mercapto-4-methyl pyrimidine hydrochloride, 3-mercapto-5-phenyl-1,2,4-triazole and 2-mercapto-4-phenyl oxazole. The amount of these mercapto compounds added is in the range of preferably from 0.001 to 1.0 mol and more preferably from 0.01 to 0.3 mol per mol of silver.

The heat developing photosensitive material of the invention can contain a plasticizer and lubricant, and the plasticizer and lubricant which can be used in the photosensitive layer include those described in column 0117 in JP-A No. 11-65021; an agent for making formed images ultra-contrasty, a method of adding the same and the amount thereof include those described in column 0118 in JP-A No. 11-65021 and in columns 0136 to 0193 in JP-A No. 11-223898, the compounds of general formula (H), general formulae (1) to (3) and general formulae (A) and (B) in Japanese Patent Application No. 11-87297 and the compounds of the general formulae (III) to (V) (specificly Compounds 21 to 24) described in Japanese Patent Application No. 11-91652; and an accelerator for making images ultra-contrasty is described in column 0102 in JP-A No. 11-65021 and in columns 0194 to 0195 in JP-A No. 11-223898.

In the heat developing photosensitive material of the invention, the layer containing photosensitive silver halide particles, at the wavelength of exposure light, has an absorption of preferably from 0.1 to 0.6, and more preferably from 0.2 to 0.5. When the absorption is high, Dmin is increased to make distinction of images difficult, while the absorption is low, sharpness is deteriorated. For increasing the absorption of the photosensitive silver halide layer in the invention, any methods can be used, but use of dyes is preferable. The dyes may be any dyes satisfying the absorption requirement described above, and examples of such dyes include pyrazoloazole dyes, anthraquinone dyes, azo dyes, azomethine dyes, oxonol dyes, carbocyanine dyes, styryl dyes, triphenyl methane dyes, indoaniline dyes, indophenol dyes and squarylium dyes. Preferable dyes used in the invention include anthraquinone dyes (for example Compounds 1 to 9 described in JP-A No. 5-341441, Compounds 3-6 to 18 and 8-23 to 38 described in JP-A No. 5-165147), azomethine dyes (Compounds 17 to 47 described in JP-A No. 5-341441), indoaniline dyes (for example Compounds 11 to 19 described in JP-A No. 5-289227, Compound 47 described in JP-A No. 5-341441, Compounds 2-10 to 11 described in JP-A No. 5-165147, etc.), azo dyes (Compounds 10 to 16 described in JP-A No. 5-341441) and squarylium dyes (Compounds 1 to 20 described in JP-A No. 10-104779 and Compounds 1a to 3d described in U.S. Pat. No. 5,380,635). These dyes may be added in any forms such as a solution, an emulsion and a dispersion of solid fine particles or in a state mordanted with a high-molecular mordant. The amount of these compounds used is determined depending on the intended absorption, but generally their amount is preferably in the range of from 1 μg/m² to 1 g/m².

In the heat developing photosensitive material of the invention, a portion excluding the layer containing photosensitive silver halide particles, at the wavelength of exposure light, has an absorption of preferably from 0.1 to 3.0, more preferably from 0.3 to 2.0 in respect of prevention of halation. The portion having this absorption at the wavelength of exposure light is preferably one side (i.e. a back layer, a primed back layer, an undercoated layer or a protective layer for the back layer) of the support having the layer containing photosensitive silver halide particles at the other side, or a portion (i.e. a primed or undercoated layer) between the layer containing photosensitive silver halide particles and the support.

When the photosensitive silver halide particles are spectrally sensitized in the infrared region, the portion other than the layer containing photosensitive silver halide particles may be allowed to have the absorption by any methods, and the absorption maximum in the visible range is made preferably 0.3 or less. The dye used for coloration may be a dye usable for increasing the absorption of the photosensitive silver halide layer, and may be identical with, or different from, the dye used in the photosensitive silver halide layer.

When the photosensitive silver halide particles are spectrally sensitized in the visible region, the portion other than the layer containing photosensitive silver halide particles may be allowed to have the absorption by any methods, but a dye discoloring upon heat treatment or a combination of a compound and a dye, both of which discolor upon heat treatment, is preferably used. Examples of the colored layer to be discolored in the invention include, but are not limited to, those described in JP-A Nos. 52-139136, 53-132334, 56-501480, 57-16060, 57-68831, 57-101835, 59-182436, 7-36145, 7-199409, JP-B Nos. 48-38692, 50-16648, 2-41734, U.S. Pat. No. 4,088,497, U.S. Pat. No. 4,283,487, U.S. Pat. No. 4,548,896 and U.S. Pat. No. 5,187,049. The amount of these compounds is determined depending on the intended absorption, but usually they are used preferably in the range of from 1 μg/m² to 1 g/m².

In the heat developing photosensitive material of the invention, a surface protective layer can be arranged for the purpose of preventing adhesion of the photosensitive layer (image forming layer). As the binder for the surface protective layer, any polymers can be used. Examples of the binder include polyester, gelatin, polyvinyl alcohol and cellulose derivatives and preferably cellulose derivatives. Examples of the cellulose derivatives include, but are not limited to, cellulose acetate, cellulose acetate butyrate, cellulose propionate, hydroxypropyl cellulose, hydroxypropyl methyl cellulose, methyl cellulose, hydroxyethyl cellulose, carboxymethyl cellulose and a mixture thereof.

The thickness of the surface protective layer is preferably from 0.1 to 10 μm, particularly preferably from 1 to 5 μm.

In the surface protective layer, any anti-adhesion materials may be used. Examples of such anti-adhesion materials include wax, liquid paraffin, silica particles, styrene-containing elastomer block copolymers (for example, styrene-butadiene-styrene, styrene-isoprene-styrene), cellulose acetate, cellulose acetate butyrate, cellulose propionate or a mixture thereof.

In the heat developing photosensitive material of the invention, the photosensitive layer or the protective layer for the photosensitive layer can make use of photographic elements containing light-absorbing materials and filter dyes described in U.S. Pat. Nos. 3,253,921, 2,274,782, 2,527,583, and 2,956,879. Further, the dyes can be mordanted as described in U.S. Pat. No. 3,282,699. The filter dye is used in an amount to achieve an absorbance of preferably 0.1 to 3, particularly preferably 0.2 to 1.5 at the wavelength of exposure light.

In the invention, the photosensitive layer or the protective layer for the photosensitive layer can also contain a matting agent, for example starch, titanium dioxide, zinc oxide and silica, as well as polymer beads containing beads described in U.S. Pat. Nos. 2,992,101 and 2,701,245. The degree of matting of the emulsion surface, though not particularly limited unless stardust trouble occurs, is preferably from 200 to 10000 seconds, particularly preferably from 300 to 10000 seconds in terms of beck [phonetic] smoothness.

In the heat developing photosensitive material of the invention, the photosensitive layer is composed of one or more layers on the support. The one layer is constituted so as to contain the organic silver salt, the silver halide, the reducing agent, the binder, and other desired additional materials such as the additives described above. In the constitution of the two layers, the first photosensitive layer (which is usually next to the support) contains the organic silver salt and silver halide, and the second layer or the two layers can contain some of the other components. A two-layer structure containing a single photosensitive layer containing all the components and a protective topcoat can also be used. The multicolor photosensitive heat developing photographic material may be constituted so as to contain a combination of these 2 layers for each color, or to contain all components in a single layer as described in U.S. Pat. No. 4,708,928. In the case of the muti-dye multicolor photosensitive heat developing photographic material, the respective photosensitive layers are separated from one another with a functional or non-functional barrier layer as described in U.S. Pat. No. 4,460,681.

The heat developing photosensitive material of the invention is preferably the so-called single-sided photosensitive material having at least one photosensitive layer containing a silver halide emulsion at one side of the support and a back layer at the other side.

A matting agent may be added to the heat developing photosensitive material of the invention in order to improve transportability. The matting agent is fine particles of an organic or inorganic compound that is generally insoluble in water. Any matting agent can be used, and for example, use can be made of matting agents well-known in the art, such as organic matting agents described in U.S. Pat. Nos. 1,939,213, 2,701,245, 2,322,037, 3,262,782, 3,539,344 and 3,767,448 and inorganic matting agents described in U.S. Pat. Nos. 1,260,772, 2,192,241, 3,257,206, 3,370,951, 3,523,022 and 3,769,020. For example, organic compounds which can be used preferably as the matting agent include water-dispersible vinyl polymers such as polymethyl acrylate, polymethyl methacrylate, polyacrylonitrile, acrylonitrile-α-methyl styrene copolymers, polystyrene, styrene-divinyl benzene copolymers, polyvinyl acetate, polyethylene carbonate and polytetrafluoroethylene, cellulose derivatives such as methyl cellulose, cellulose acetate and cellulose acetate propionate, starch derivatives such as carboxy starch, carboxynitrophenyl starch, urea-formaldehyde-starch reaction products, and hardened gelatin formed into fine capsule hollow particles by hardening thereof with a known hardener or by hardening thereof through coacervation. Examples of the inorganic compounds which can be preferably used include silicon dioxide, titanium dioxide, magnesium dioxide, aluminum oxide, barium sulfate, calcium carbonate, silver chloride or silver bromide desensitized by a known method, glass, diatom earth, etc. The matting agent may be mixed if necessary with a substance of different type. The size and shape of the matting agent are not particularly limited, and the matting agent having an arbitrary particle diameter can be used. To carry out the invention, the matting agent having a particle diameter of 1 to 30 μm is preferably used. The distribution of particle diameters of the matting agent may be narrow or broad. However, because the matting agent significantly influences the haze and surface luster of the photosensitive material, it is preferable to adapt the particle size, shape and particle diameter distribution as necessary during production of the matting agent or by mixing a plurality of matting agents.

The layer which can contain the matting agent includes the outermost layer of the photosensitive layer face and the back face (or the photosensitive layer and the back layer) or the protective layer and the primed layer, preferably the outermost surface layer or a layer functioning as the outermost surface layer, or a layer closer to the outer surface, or preferably a layer functioning as the protective layer. The matting degree of the back face is preferably 10 to 250 seconds, more preferably 50 to 180 seconds in terms of beck [phonetic] smoothness.

The preferable binder for the back layer is transparent or semitransparent and generally colorless, including natural polymer synthetic resin or polymer and copolymer, and other film-forming media, for example gelatin, arabic gum, poly(vinyl alcohol), hydroxyethyl cellulose, cellulose acetate, cellulose acetate butyrate, poly(vinyl pyrrolidone), casein, starch, poly(acrylic acid), poly(methyl methacrylic acid), poly(vinyl chloride), poly(methacrylic acid), copoly(styrene-maleic anhydride), copoly(styrene-acrylonitrile), copoly(styrene-butadiene), poly(vinyl acetal) (for example, poly(vinyl formal) and poly(vinyl butyral)), poly(ester), poly(urethane), phenoxy resin, poly(vinylidene chloride), poly(epoxide), poly(carbonate), poly(vinyl acetate), cellulose esters and poly(amide). The binder may be applied in the form of a solution, an emulsion in water or an organic solvent.

Also, the heat developing photosensitive material of the invention can make use of a backside resistive heating layer as shown in U.S. Pat. Nos. 4,460,681 and 4,374,921.

In the heat developing photosensitive material of the invention, the respective layers such as the photosensitive layer, protective layer and back layer may also make use of a hardener. Examples of such hardeners include polyisocyanates described in U.S. Pat. No. 4,281,060 and JP-A 6-208193, epoxy compounds described in U.S. Pat. No. 4,791,042, and vinyl sulfone type compounds described in JP-A No. 62-89048.

The heat developing photosensitive material of the invention can use a surfactant to improve coating properties and antistatic properties. Examples of such surfactants include nonionic, anionic, cationic and fluorine types. Specific examples include fluorine type polymeric surfactants described in JP-A No. 62-170950 and U.S. Pat. No. 5,380,644, fluorine surfactants described in JP-A No. 60-244945 and JP-A No. 63-188135, polysiloxy acid type surfactants described in U.S. Pat. No. 3,885,965 and polyalkylene oxide and anionic surfactants described in JP-A No. 6-301140.

In the invention, the solvent includes, but is not limited to, solvents described “Shinban Yozai Pocket Book” (New Solvent Pocket Book) Ohm, 1994. The boiling point of the solvent used in the invention is preferably from 40 to 180° C.

Examples of these solvents include hexane, cyclohexane, toluene, methanol, ethanol, isopropanol, acetone, methyl ethyl ketone, ethyl acetate, 1,1,1-trichloroethane, tetrahydrofuran, triethylamine, thiophene, trifluoroethanol, perfluoropentane, xylene, n-butanol, phenol, methyl isobutyl ketone, cyclohexanone, butyl acetate, diethyl carbonate, chlorobenzene, dibutyl ether, anisole, ethylene glycol diethyl ether, N,N-dimethylformamide, morpholine, propane sultone [phonetic], perfluorotributyl amine, and water.

The heat developing photosensitive material of the invention may have an antistatic or electroconductive layer, for example a layer containing soluble salts (e.g. chlorides, nitrates), a vapor-deposited metallic layer, a layer containing ionic polymers as described in U.S. Pat. Nos. 2,861,056 and 3,206,312 or insoluble salts as described in U.S. Pat. No. 3,428,451.

The method of obtaining color images by using the heat developing photosensitive material of the invention includes a method described on page 10, left column, line 48 to page 11, left column, line 40 in JP-A No. 7-13295. As stabilizers for color dye images, those exemplified in BG Patent No. 1,326,889, U.S. Pat. Nos. 3,432,300, 3,698,909, 3,574,627, 3,573,050, 3,764,337 and 4,042,394 can be used.

The heat developing photosensitive material of the invention can be coated with the heat developing photographic emulsion by various coating procedures including dipping coating, air knife coating or flow coating, or extrusion coating by means of the hopper described in U.S. Pat. No. 2,381,294. If necessary, the heat developing photosensitive material can be coated simultaneously with two or more layers by a method described in U.S. Pat. No. 2,761,791 and GB Patent No. 837,095.

The heat developing photosensitive material of the invention can contain additional layers such as a dye-receiving layer for receiving a transfer dye image, a cloudy layer in case reflective printing is desired, a protective topcoat layer, and a primer layer known in optical thermal photographic technology. Preferably the heat developing photosensitive material of the invention can form images by itself, and preferably the functional layer (e.g. the image-receiving layer) necessary for formation of images is not another photosensitive material.

The heat developing photosensitive material of the invention may be developed by any methods, but usually the photosensitive material is heated and developed after being subjected to image-wise exposure to light. The development temperature is preferably from 80 to 250° C., more preferably from 100 to 140° C. The development time is preferably from 1 to 180 seconds, and more preferably from 10 to 90 seconds. In a preferable development method, development using a heat drum is conducted.

The photosensitive material of the invention may be exposed to light by any methods, but a laser light is used preferably as the light source for light exposure. The laser light in the invention is preferably a gas laser, a dye laser or a semiconductor laser. Further, a semiconductor laser or YAG laser and a secondary high frequency wave-generating element can also be used.

### EXAMPLES

Hereinafter, the present invention is described in more detail. The materials, samples, proportions, procedures, etc. shown in the Examples below can be changed as necessary without departure from the sprit of the invention. Accordingly, the scope of the invention is not limited to the Examples shown below.

### Example 1

### Preparation of a Photosensitive Silver Halide Emulsion

88.3 g of phenyl carbamoyl gelatin, 10 ml of aqueous methanol solution containing 10% PAO compound [[HO(CH₂CH₂O)ₙ—(CH(CH₃)CH₂O)₁₇—(CH₂CH₂O)ₘ—H; m+n=5 to 7] and 0.32 g of potassium bromide were added to and dissolved in 5429 ml of water and then kept at 45° C., and a mixed solution of 659 ml of 0.67 mol/L aqueous silver nitrate and 0.703 mol/L of KBr and 0.013 mol/L of KI was added to this mixture over 4 minutes and 45 seconds by a simultaneously mixing method while regulating the pAg at 8.09 by a mixing stirrer shown in JP-B Nos. 58-58288 and 58-58289, to form cores. After 1 minute, 20 ml of 0.63 N aqueous potassium hydroxide was added. After 6 minutes, a solution consisting of 1976 ml of 0.67 mol/L aqueous silver nitrate, 0.657 mol/L KBr, 0.013 mol/L potassium iodine, and 30 μmol of dipotassium iridate hexachloride was added thereto over 14 minutes and 15 seconds by a simultaneously mixing method while maintaining the temperature at 45° C. and the pAg at 8.09. The mixture was stirred for 5 minutes and cooled to 40° C.

18 ml of 56% aqueous acetic acid was added thereto to precipitate the silver halide emulsion. The supernatant was removed except for 2 L of the precipitates, then 10 L water was added to the precipitate which was then stirred to precipitate the silver halide emulsion again. Further, the supernatant was removed except for 1.5 L of the precipitate, 10 L was added to the precipitate which was then stirred to precipitate the silver halide emulsion. The supernatant was removed except for 1.5 L of the precipitate, and a solution prepared by dissolving 1.72 g sodium carbonate anhydride in 151 ml water was added to the precipitate which was then heated to 60° C. The dispersion was stirred for 120 minutes. The dispersion was adjusted finally to pH 5.0, and water was added in an amount of 1161 g per mol of silver.

This emulsion comprised monodisperse cubic silver iodobromide particles having an average particle size of 0.058 μm in which the coefficient of variation of the particle size was 12% and the [100] face ratio was 92%.

### Preparation of a Powdered Organic Silver Salt

50 mol % behenic acid, 30 mol % arachidic acid and 20 mol % stearic acid were added in a total amount of 0.7552 mol to 4720 ml pure water, the mixture was dissolved at 80° C., 540.2 ml of 1.5 N aqueous sodium hydroxide was added, 6.9 ml conc. nitric acid was added thereto, and the mixture was cooled to 55° C. to give an organic sodium salt solution. 45.3 g of the above silver halide emulsion and 450 ml pure water were added to the organic sodium salt solution kept at a temperature of 55° C., and the mixture was stirred at 13200 rpm at 21.1 KHz for 5 minutes by a homogenizer (ULTRA-TU RRAXT-25) produced by IKA JAPAN. Then, 702.6 ml of 1 mol/L silver nitrate was added thereto over 2 minutes and stirred for 10 minutes to give an organic silver salt dispersion. Then, the resultant organic silver salt dispersion was transferred to a water-washing vessel, and deionized water was added thereto, stirred and left, whereby the organic silver salt dispersion was floated and separated, while the lower water-soluble salt was removed. Thereafter, the organic silver salt was washed with deionized water until the electrical conductance of the wash was reduced to 2 μS/cm, and then centrifuged and dried at 40° C. in hot air at 10 vol % oxygen partial pressure in a circulating dryer until its weight became constant, whereby a powdered organic silver salt was obtained.

### Preparation of a Photosensitive Emulsion Dispersion

14.57 g polyvinyl butyral powder (Butvar B-79, Monsant Company) was dissolved in 1457 g methyl ethyl ketone (MEK), and 500 g of the powdered organic silver salt was gradually added thereto and sufficiently mixed under stirring with a dissolver DISPERMAT CA-40M (VMA-GETZMANN Ltd.), to form slurry. The slurry was dispersed by passing it twice through a pressuring homogenizer GH-2 (SMT Co., Ltd.), to prepare a photosensitive emulsion dispersion. The treatment pressure during first passage was 280 kg/cm², and the treatment pressure during second passage was 560 kg/cm².

### Preparation of Photosensitive Layer Coating Solutions 1 to 26

15.1 g MEK was added to the photosensitive emulsion dispersion (50 g) and then kept at 21° C. while stirring at 1000 rpm with a dissolver type homogenizer, 390 μl of 10% by weight aggregate of 2 molecules of N,N-dimethyl acetamide/1 molecule of bromic acid/1 molecule of bromine in methanol was added thereto, and the mixture was stirred for 1 hour. 494 μl methanol solution containing 10% by weight calcium bromide was added thereto and stirred for 20 minutes. Then, 167 mg methanol solution containing 15.9% by weight dibenzo-18-crown-6 and 4.9% by weight potassium acetate was added thereto and stirred for 10 minutes, and then 2.6 g MEK solution containing 0.24% by weight dye stuff A, 18.3% by weight 2-chlorobenzoic acid, 34.2% by weight salicylic acid-p-toluene sulfonate and 4.5% by weight 5-methyl-2-mercaptobenzimidazole was added thereto and stirred for 1 hour. Thereafter, the mixture was heated to 13° C. and further stirred for 30 minutes. While the mixture was kept at 18° C., 13.31 g polyvinyl butyral (Butvar B-79, from Monsant Company) was added thereto and the mixture was stirred for 30 minutes, and 1.08 g of 9.4% by weight tetrachlorophthalic acid solution was added thereto and stirred for 15 minutes.

According to Table 1, the reducing agent, the aromatic carboxylic acid compound and the development accelerator were then added thereto while stirring. When 10.0 g of 20% by weight example compound (1-6) was added, the amount of the reducing agent was expressed as 100 mol %. The amount of the aromatic carboxylic acid compound used is expressed as relative mol % based on the amount (=100 mol %) of the exemplified compound (1-6). The amount of the development accelerator used is expressed in terms of the number of mols per mol of silver.

Then, 12.4 g of a solution containing hydrogen-bonding compound A shown below and the reducing agent in an equimolar amount was added thereto, 1.5 g of 10 weight % Desmodur N3300 (aliphatic isocyanate, from Mobey Ltd.) was added thereto, and 4.27 g of MEK solution containing 7.4 weight % tribromomethyl-2-azaphenyl sulfone and 7.2 weight % phthalazine was added to give photosensitive coating solutions 1 to 26 respectively.

### Preparation of a Surface Protective Layer Coating Layer

96 g of cellulose acetate butyrate (CAB171-15, from Eastman Chemical Company), 4.5 g of polymethyl methacrylic acid (Palaroid A-21, from Rohm and Haas Co.), 1.5 g of 1,3-di(vinyl sulfonyl)-2-propanol, 1.0 g of benzotriazole and 1.0 g of fluorine type surfactant (Surflon HK40, from Asahi Glass Company) were added thereto and dissolved, and 30 g dispersion prepared by dispersing 13.6 weight % cellulose acetate butyrate (CAB 171-15, from Eastman Chemical Company) and 9 weight % calcium carbonate (Super-Pflex 200, from Speciality Minerals, Inc.) in MEK at 8000 rpm for 80 minutes by a dissolver type homogenizer was added thereto and stirred to prepare a surface protective layer coating solution.

### Preparation of a Support

Both sides of PET film of 175 μm in thickness were colored blue at a density of 0.170 (measured by a densitometer TD-904, from Macbeth) and subjected to corona discharge treatment at 8 W/m²·min.

### Preparation of a Undercoating Solution for Backsides

84.2 g cellulose acetate butyrate (CAB381-20, from Eastman Chemical Company) and 4.5 g polyester resin (Vitel PE2200B, from Bostic Ltd.) were added to, and dissolved in, 830 g of MEK while stirring. To this solution were added 0.30 g of dye B and a solution of 4.5 g of a fluorine type surfactant (Surflon HK40, from Asahi Glass Company) and 2.3 g of another fluorine type surfactant (Megafag F120K, from Dainippon Ink and Chemicals, Incorporated) in 43.2 g of methanol, and the mixture was sufficiently stirred to form a solution. Finally, 75 g silica (Siloide 64X6000, from W. R. Grace & Co.) dispersed at a density of 1% by weight in methyl ethyl ketone with a dissolver type homogenizer was added thereto and stirred to prepare a undercoating solution for backsides.

### Preparation of a Primed Support

The undercoating solution for backsides was applied by an extrusion coater onto the backsides of the support and dried to give a coating of 3.5 μm in thickness thereon. The coating was dried for 5 minutes at a drying temperature of 100° C. in a dry and at a temperature of 10° C. in the open air. The primed support was thus prepared.

### Preparation of Photosensitive Materials

The photosensitive layer coating solutions 1 to 26 and the surface protective layer coating solution were simultaneously applied and layered on the primed support by an extrusion coater, to prepare photosensitive materials 1 to 26, respectively. The photosensitive layer was formed in an amount of 1.9 g/m² of silver, while the surface protective layer was formed to have 2.5 μm thickness after drying. Thereafter, the photosensitive materials were dried for 10 minutes at a drying temperature of 75° C. in a dried air and at a temperature of 10° C. in the open air.

The total content of MET and methanol in each photosensitive material thus obtained was regarded as the solvent content. The specimen was cut into 46.3 cm² pieces which were then arranged at 5 mm intervals and accommodated in a special vial, and the vial was then sealed with a septum and an aluminum cap and set in a head space sampler HP7694 in a gas chromatographic (GC) unit 5971 produced by Hewlett-Packard. The GC detector used was a hydrogen flame ionization detector (FID), and the column used was DB-624 produced by J & W Ltd. Major measurement conditions were that the head spacer sample was heated at 120° C. for 20 minutes, and the CG injection temperature was 150° C., and the column temperature was 45° C. for 3 minutes and then increased at 8° C./min. to 100° C. The calibration curve was prepared by accommodating a predetermined amount of each of the solvents diluted with butanol and determining a peak area in a chromatogram obtained by the same measurement as above. The solvent content of the photosensitive material was 40 mg/m².

100 cm² area of the photosensitive material was cut off, and its photosensitive layer was removed in an MEK. This specimen was decomposed with nitrous acid in a Micro Digest A300 type microwave wet-decomposition unit produced by Prolabo Ltd. and analyzed in a calibration curve method by PQ-Ω type ICP-MS (induction coupling plasma mass spectrometric unit) produced by VG Elemental Ltd., indicating that the content of Zr in the photosensitive material was 10 μg or less per mg of Ag.

The compounds used in Example 1 are shown below.

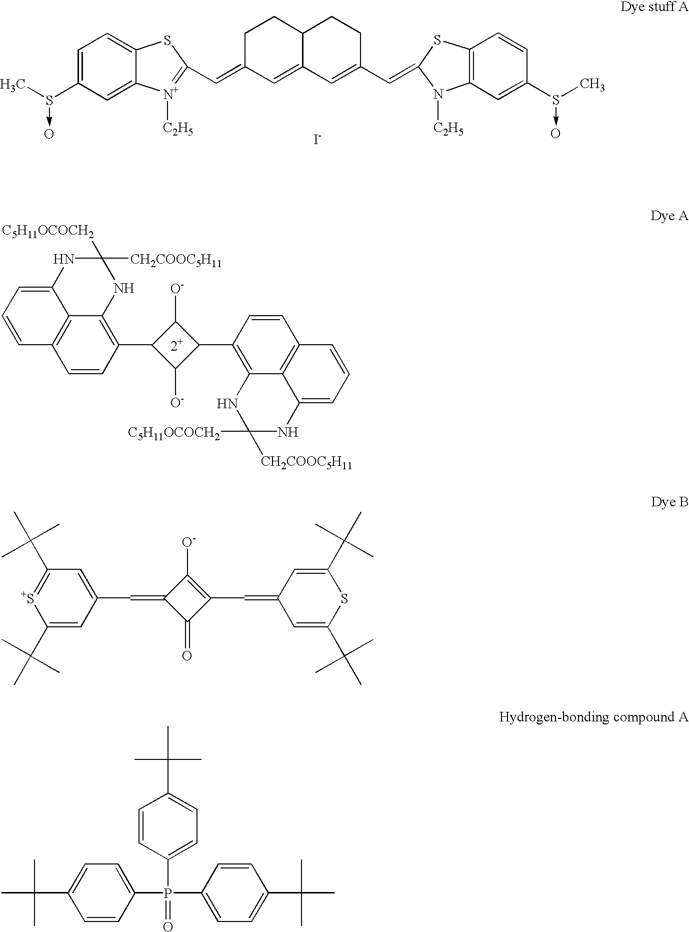

(Light Exposure and Development Treatment)

A light-exposing machine whose light source was a lengthwise multi-mode semiconductor laser at a wavelength of 800 to 820 nm was constructed, and the emulsion side of the photosensitive material prepared above was exposed to light by laser scanning with this light-exposing machine. The angle of the incident light (scanning laser light) to the light-exposed surface of the photosensitive material was 75° in recording an image. Using an automatic developing machine having a heat drum, the photosensitive material was developed at 124° C. for 15 seconds by contacting its protective layer with the surface of the drum, and the resultant image was evaluated with a densitometer. The room where light exposure and development were conducted was under the conditions of 23° C. and 50% RH. The resultant image, as compared with an image obtained by recording where the angle of the incident light (scanning laser light) to the light-exposed surface of the photosensitive material was 90°, was unexpectedly excellent in sharpness and contrast with less image deterioration attributable to interference unevenness.

(Evaluation of Photographic Performance)

After the photographic material (specimen) obtained above was exposed to laser light and then heat developing by the method described above, for sensitivity, image density (Dmax) and minimum density (Dmin) of each photosensitive material was measured. The sensitivity was expressed as a relative value based on the reciprocal (=100%) of the light exposure giving a density of 1.0 plus the minimum density of the photosensitive material No. 1. The results are shown in Table 2.

TABLE 1

| | | | Aromatic carboxylic | | | | |
|---|---|---|---|---|---|---|---|
| | Reducing agent | | acid compound | | Development accelerator | | |
| Photosensitive | Exemplified | Amount | Exemplified | Amount | Exemplified | Amount | |
| material No. | compound | (mol %) | compound | (mol %) | compound | (mol/mol of silver) | Remark |
| 1 | 1-6 | 100 | — | — | — | — | Comparative Example |
| 2 | 1-6 | 100 | 2-16 | 10 | — | — | Comparative Example |
| 3 | 1-6 | 100 | 2-16 | 10 | 3-68 | 1.0 × 10⁻² | The Invention |
| 4 | 1-6 | 100 | 2-16 | 10 | 4-60 | 1.0 × 10⁻² | The Invention |
| 5 | 1-6 | 100 | 2-16 | 10 | 5-41 | 1.0 × 10⁻² | The Invention |
| 6 | 1-6 | 100 | 2-16 | 10 | 6-7 | 1.0 × 10⁻² | The Invention |
| 7 | 1-6 | 100 | 2-16 | 10 | 6-41 | 1.0 × 10⁻² | The Invention |
| 8 | 1-6 | 100 | 2-8 | 15 | — | — | Comparative Example |
| 9 | 1-6 | 100 | 2-8 | 15 | 3-68 | 1.0 × 10⁻² | The Invention |
| 10 | 1-6 | 100 | 2-8 | 15 | 4-60 | 1.0 × 10⁻² | The Invention |
| 11 | 1-6 | 100 | 2-8 | 15 | 5-41 | 1.0 × 10⁻² | The Invention |
| 12 | 1-6 | 100 | 2-8 | 15 | 6-7 | 1.0 × 10⁻² | The Invention |
| 13 | 1-6 | 100 | 2-8 | 15 | 6-41 | 1.0 × 10⁻² | The Invention |
| 14 | 1-4 | 70 | — | — | — | — | Comparative Example |
| 15 | 1-4 | 70 | 2-16 | 10 | — | — | Comparative Example |
| 16 | 1-4 | 70 | 2-16 | 10 | 3-68 | 1.2 × 10⁻² | The Invention |
| 17 | 1-4 | 70 | 2-16 | 10 | 4-60 | 1.2 × 10⁻² | The Invention |
| 18 | 1-4 | 70 | 2-16 | 10 | 5-41 | 1.2 × 10⁻² | The Invention |
| 19 | 1-4 | 70 | 2-16 | 10 | 6-7 | 1.2 × 10⁻² | The Invention |
| 20 | 1-4 | 70 | 2-16 | 10 | 6-41 | 1.2 × 10⁻² | The Invention |
| 21 | 1-14 | 60 | 2-8 | 15 | — | — | Comparative Example |
| 22 | 1-14 | 60 | 2-8 | 15 | 3-68 | 1.2 × 10⁻² | The Invention |
| 23 | 1-14 | 60 | 2-8 | 15 | 4-60 | 1.2 × 10⁻² | The Invention |
| 24 | 1-14 | 60 | 2-8 | 15 | 5-41 | 1.2 × 10⁻² | The Invention |
| 25 | 1-14 | 60 | 2-8 | 15 | 6-7 | 1.2 × 10⁻² | The Invention |
| 26 | 1-14 | 60 | 2-8 | 15 | 6-41 | 1.2 × 10⁻² | The Invention |

TABLE 2

| Photo- | | Image | Minimum | |
|---|---|---|---|---|
| sensitive | Relative | density | dendity | |
| material No. | sensitivity | (Dmax) | (fog) | Remark |
| 1 | 100 | 3.40 | 0.22 | Comparative Example |
| 2 | 96 | 3.80 | 0.20 | Comparative Example |
| 3 | 145 | 3.86 | 0.20 | The Invention |
| 4 | 135 | 3.82 | 0.20 | The Invention |
| 5 | 140 | 3.84 | 0.20 | The Invention |
| 6 | 140 | 3.84 | 0.20 | The Invention |
| 7 | 140 | 3.84 | 0.20 | The Invention |
| 8 | 97 | 3.65 | 0.20 | Comparative Example |
| 9 | 143 | 3.71 | 0.20 | The Invention |
| 10 | 133 | 3.67 | 0.20 | The Invention |
| 11 | 138 | 3.69 | 0.20 | The Invention |
| 12 | 138 | 3.69 | 0.20 | The Invention |
| 13 | 138 | 3.69 | 0.20 | The Invention |
| 14 | 100 | 3.40 | 0.23 | Comparative Example |
| 15 | 94 | 4.05 | 0.21 | Comparative Example |
| 16 | 155 | 4.11 | 0.21 | The Invention |
| 17 | 145 | 4.07 | 0.21 | The Invention |
| 18 | 150 | 4.09 | 0.21 | The Invention |
| 19 | 150 | 4.09 | 0.21 | The Invention |
| 20 | 150 | 4.09 | 0.21 | The Invention |
| 21 | 95 | 3.70 | 0.21 | Comparative Example |
| 22 | 160 | 3.81 | 0.21 | The Invention |
| 23 | 150 | 3.77 | 0.21 | The Invention |
| 24 | 155 | 3.79 | 0.21 | The Invention |
| 25 | 155 | 3.79 | 0.21 | The Invention |
| 26 | 155 | 3.79 | 0.21 | The Invention |

As is evident from the results in Table 2, each of the heat developing photosensitive materials of the invention containing the compound of the general formula (1) as a reducing agent, the aromatic carboxylic acid compound of the general formula (2) as in the same face of the photosensitive silver halide, and the development accelerator can achieve higher sensitivity and image density (Dmax) without an increase in the minimum density (Dmin). The heat developing photosensitive material of the invention is also revealed to have a high thermal development activity to enable rapid development.

According to the invention, there can be provided a heat developing photosensitive material capable of rapid development with higher thermal development activity and higher image density and sensitivity with less fogging in the non-image region.

What is claimed is:

1. A heat developing photosensitive material comprising, on one side of a support, a photosensitive silver halide, a non-photosensitive organic silver salt, a reducing agent for a silver ion, and a binder; and further comprising an aromatic carboxylic acid compound represented by a general formula (2), which is on the same side as the photosensitive silver halide, and a development promoter;
which reducing agent includes a compound represented by a general formula (1) below 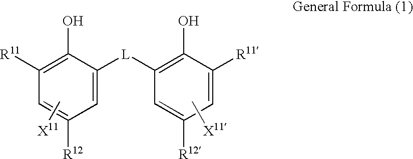
wherein each of R¹¹ and R^{11′} independently represents an alkyl group, each of R¹² and R^{12′} independently represents any one of a hydrogen atom and a group can substitute a benzene ring, each of X¹¹ and X^{11′} independently represents any one of a hydrogen atom and a group which can substitute the benzene ring, and at least one of R¹¹ and X¹¹, R^{11′} and X^{11′}, R¹² and X¹¹, and R^{12′} and X^{11′} may be bound to each other to form a ring, L represents a —S— group or —CHR¹³— group, and R¹³ represents any one of a hydrogen atom and an alkyl group, 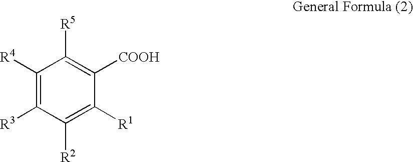
wherein each of R¹, R², R³, R⁴ and R⁵ independently represents any one of a hydrogen atom and a group can substitute a benzene ring, and at least one of R¹, R², R³, R⁴ and R⁵ represents a non-dissociable substituent group bound to the benzene ring via one of a carbon atom, a nitrogen atom, an oxygen atom, a sulfur atom and a phosphorus atom.

2. The heat developing photosensitive material according to claim 1, wherein an amount of the compound, which is the reducing agent represented by the general formula (1), is in a range of from 0.01 to 5.0 g/m².

3. The heat developing photosensitive material according to claim 1, wherein an amount of the aromatic carboxylic acid compound, which is represented by the general formula (2), is in a range of from 0.1 to 100 mol % relative to the reducing agent.

4. The heat developing photosensitive material according to claim 1, wherein the development promoter comprises at least one selected from a phenol derivative and a hydrazine derivative.

5. The heat developing photosensitive material according to claim 4, wherein the hydrazine derivative is a compound represented by a general formula (3):
Q¹—NHNH—R¹ General Formula (3)
wherein Q¹ represents a 5- to 7-membered unsaturated ring bound to NHNH—R¹, and R¹ represents any one of a carbamoyl group, an acyl group, an alkoxy carbonyl group, an aryloxy carbonyl group, a sulfonyl group and a sulfamoyl group.

6. The heat developing photosensitive material according to claim 4, wherein the phenol derivative is a compound represented by at least one of a general formula (P) and a general formula (Q): 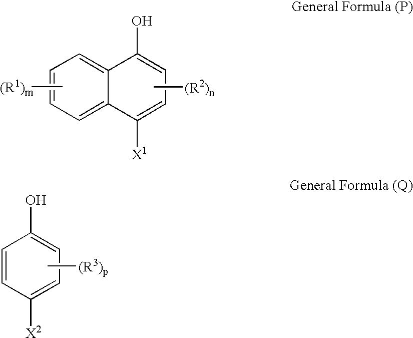
wherein each of X¹ and X² independently represents any one of a hydrogen atom and a substituent group, each of R¹ to R³ independently represents any one of a hydrogen atom and a substituent group, each of m and p independently represents an integer of from 0 to 4, and n represents an integer of from 0 to 2.

7. The heat developing photosensitive material according to claim 6, wherein the compound represented by general formula (P) or (Q) is at least one of the compounds represented by general formulae (4) to (6): 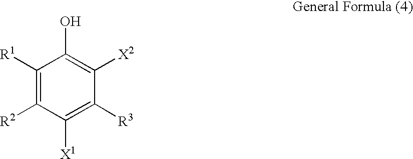
wherein each of R¹, R², R³, X¹ and X² independently represents any one of a hydrogen atom; a halogen atom; and a substituent group bound to the benzene ring via at least one of a carbon atom, an oxygen atom, a nitrogen atom, a sulfur atom and a phosphorus atom, provided that at least one of X¹ and X² is a group represented by —NR⁴R⁵; each of R⁴ and R⁵ independently represents any one of a hydrogen atom, an alkyl group, an alkenyl group, an alkynyl group, an aryl group, a heterocyclic group and —C(═O)—R, —C(═O)—C(═O)—R, —SO₂—R, —SO—R, —P(═O)(R)₂, and —C(═NR′)—R; each of R and R′ is a group independently selected from a hydrogen atom, an alkyl group, an aryl group, a heterocyclic group, an amino group, an alkoxy group and an aryloxy group, and these substituent groups may bound to their adjacent group to form a ring, 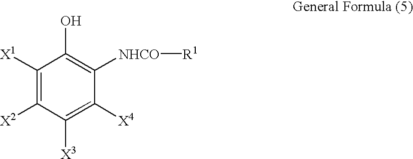
wherein X¹ represents a substituent group, each of X² to X⁴ independently represents any one of a hydrogen atom and a substituent group, provided that each of X¹ to X⁴ is not a hydroxyl group, and X³ is not a sulfonamide group; substituent groups represented by X¹ to X⁴ may be bound to each other to form a ring; and R¹ represents any one of a hydrogen atom, an alkyl group, an aryl group, a heterocyclic group, an amino group and an alkoxy group, 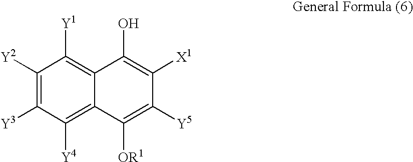
wherein R¹ represents any one of an alkyl group, an aryl group, an alkenyl group and an alkynyl group, X¹ represents an acyl group, an alkoxy carbonyl group, a carbamoyl group, a sulfonyl group and a sulfamoyl group, and each of Y¹ to Y⁵ independently represents any one of a hydrogen atom and a substituent group.

8. The heat developing photosensitive material according to claim 1, wherein an amount of the development accelerator is from 0.2 to 200 mmol per mol of silver.

9. The heat developing photosensitive material according to claim 1, wherein the non-photosensitive organic silver salt comprises at least one selected from the group consisting of silver behenate, silver stearate, silver oleate, silver laurate, silver caproate, silver myristate, silver palmitate, silver maleate, silver fumarate, silver tartrate, silver linoleate, silver butyrate and camphoric acid tablets.

10. The heat developing photosensitive material according to claim 1, wherein the non-photosensitive organic silver salt comprises at least 40 mol % of silver behenate.

11. The heat developing photosensitive material according to claim 1, wherein an amount of the non-photosensitive organic silver salt applied is from 0.1 to 5 g/m².

12. The heat developing photosensitive material according to claim 1, wherein the photosensitive silver halide is any one of cubic fine particles and plate particles.

13. The heat developing photosensitive material according to claim 1, wherein a particle size of the photosensitive silver halide is from 0.0001 to 0.15 μm.

14. The heat developing photosensitive material according to claim 1, wherein the photosensitive silver halide comprises at least one selected from the group consisting of silver chloride, silver chlobromide, silver bromide, silver iodobromide, silver iodochlobromide, and silver iodide.

15. The heat developing photosensitive material according to claim 1, wherein the photosensitive silver halide comprises from 0.1 to 40 mol % silver iodide.

16. The heat developing photosensitive material according to claim 1, wherein an amount of the photosensitive silver halide added is from 0.01 to 0.5 mol per mol of the non-photosensitive organic silver salt.

17. The heat developing photosensitive material according to claim 1, wherein the binder comprises from 50 to 100% by weight polyvinyl butyral relative to all of the components of the binder.

18. The heat developing photosensitive material according to claim 1, wherein a Tg of the binder is from 40 to 90° C.

19. The heat developing photosensitive material according to claim 1, further comprising a hydrogen-bonding compound, wherein the hydrogen-bonding compound is a compound represented by a general formula (7): 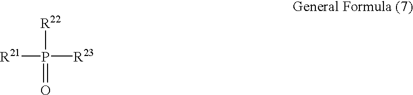
wherein each of R²¹, R²² and R²³ independently represents any one of an alkyl group, an aryl group, an alkoxy group, an aryloxy group, an amino group and a heterocyclic group, and these groups may be substituted or may not, and a desired pair of R²¹, R²² and R²³ may form a ring.

20. The heat developing photosensitive material according to claim 17, wherein an amount of the hydrogen-bonding compound is from 1 to 200 mol % relative to the reducing agent.
